(19) United States
(12) Patent Application Publication
(10) Pub. No.: US 2004/0041913 A1
(43) Pub. Date: Mar. 4, 2004

(54) Image-printing system, digital camera and printer

(76) Inventors: Shinya Takasumi, Tokyo (JP); Azuma Miyazawa, Tokyo (JP); Shigeru Iwase, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 10/420,518

(22) Filed: Apr. 22, 2003

(30) Foreign Application Priority Data
Apr. 26, 2002 (JP) 2002-126725
Jun. 7, 2002 (JP) 2002-167546
Jun. 13, 2002 (JP) 2002-173321

(51) Int. Cl. H04N 5/225

(52) U.S. Cl. 348/207.2

(57) ABSTRACT

An image printing system includes a digital camera, which is an electronic camera, including a first connecting unit for connecting to an image printer, a recording medium for recording image data, a decompressing unit for decompressing data recorded in the recording medium to data for printing, a data transfer unit for transferring an output of the decompressing unit to the printer, and a secondary battery for supplying power source, and a printer including a second connecting unit for connecting to the first connecting unit, a printing engine to print in accordance with printing data, a power supply unit for feeding power to the digital camera and for charging to the secondary battery, and a print start switch for generating a start instruction signal for a print operation. When the print start switch is turned on because the first and second connecting units are connected, the data for printing is transferred to the printer side. In response to this, the print engine starts the print operation and controls to start an operation for charging to the secondary battery after the print operation. According to this system, an image printing system with better and simpler operation and usability can be provided.

This application claims benefit of Japanese Application No. 2002-126725 filed in Japan on Apr. 26, 2002, No. 2002-167546 filed in Japan on Jun. 7, 2002 and No. 2002-173321 filed in Japan on Jun. 13, 2002, the contents of which are incorporated by this reference.

### BACKGROUND OF THE INVENTION

1. Field of the Invention

The present invention relates to an image printing system (or, simply, printing system) and, in particular, to an image printing system including a digital camera, which is an electronic camera for obtaining electronic image data and for recording the image data in an applicable recording medium, and an image printer for printing an image corresponding to the image data obtained by the digital camera.

2. Related Art Statement

An image printing system has been already practically used which includes a digital camera for obtaining electronic image data by optoelectronically transducing an optical image and for recording the obtained image data on a predetermined medium as digital data and an image printer for printing an image corresponding to the image data obtained by the digital camera on print paper.

With the conventional image printing system, the image corresponding to the image data obtained by the digital camera can be printed by the image printer generally by following steps mentioned below.

First of all, a user of the digital camera uses the digital camera performs shooting operation on a desired object. By the shooting operation, predetermined image data representing the desired object can be obtained, and the image data is recorded on a recording medium such as a memory card, which is removably attached to the digital camera.

Next, the user transfers the image data corresponding to the image to be printed of image data having been recorded on the recording medium to an external equipment such as an image processing apparatus comprising a small-sized computer. The data transferring unit may be a unit for taking out the recording medium storing image data, installing the recording medium in a part or apparatus including a predetermined recording medium interface and transferring the image data to an image processing apparatus through the part or apparatus. Alternatively, the data transferring unit may be a unit for performing data transfer by electrically connecting between the digital camera and the image processing apparatus by using a predetermined connection cable.

Therefore, conventionally, both of the digital camera and the image processing apparatus must have parts to which the same recording medium can be attached and have writing and reading functions in the attached recording medium. Alternatively, specific, independent external equipment is required which has a function for reading image data recorded in a recording medium and/or a function for writing predetermined image data in a recording medium.

Alternatively, both of the digital camera and the image processing apparatus must have respective predetermined connection terminals for connecting a predetermined connection cable and respective predetermined communication units for implementing data communication between the digital camera and the image processing apparatus.

This kind of data transfer unit is used to transfer predetermined image data from the digital camera to the image processing apparatus.

In response to this, the image processing apparatus performs predetermined signal processing on the received image data, such as processing for creating image data best suited to printing. Then, the image data is printed by using an image printer connected to the image processing apparatus.

Since, in the conventional image printing system, the use of an external equipment such as an image processing apparatus is assumed, various operations and works required for outputting an image are complicated. Therefore, it is difficult for a general user who is not familiar with operations of an image processing apparatus and the like to use the image processing apparatus easily. This is a problem.

Conventionally, a system has been proposed and been practically used in general, which does not have an image processing apparatus or the like in the image printing system. That is, with the system, the digital camera and the image printer are electrically connected by a connection cable and simple operations are performed in the digital camera or in the image printer to print an image.

However, when the image printing system is used to print an image, the digital camera and the image printer must be connected by a connection cable. Therefore, the operation may be complicated to some users.

On the other hand, conventionally, a digital camera having a small-sized printer has been proposed and been practically used for printing an image corresponding to the image data obtained by the digital camera. However, because of the integral construction, the size of the digital camera having an image printer is naturally increased, and the increase in production cost cannot be avoided. This is another problem.

Accordingly, an image printing system including a digital camera and an image printer separately has been conventionally proposed for electrically connecting the digital camera and the image printer without an external equipment such as a small-sized computer and a connection cable and for printing an image based on the image data having been obtained by the digital camera.

For example, an image printing system disclosed in Japanese Patent No. 2606340, Japanese Unexamined Patent Application Publication No. 11-008792 or No. 11-155120 can perform data transfer and printing by using a digital camera and an image printer directly connected without using a connection cable. Furthermore, in the image printing system, a chargeable battery in the digital camera can be charged.

Japanese Unexamined Patent Application Publication No. 2002-191000 proposed by the applicant also discloses an image printing system having the similar form.

In an image printing system disclosed in Japanese Unexamined Patent Application Publication No. 11-254764, a digital camera and an image printer can be connected through a connection cable, and a recording medium installing portion is provided. Thus, image data can be read from a digital camera connected thereto through the connection cable or a recording medium installed in the recording medium installing portion to print the image. In this case, when image data is read from a recording medium installed in the recording medium installing portion to print the image, predetermined printer control information (such as printing correcting information) is written in the recording medium afterwards.

Further, an image printing system disclosed in Japanese Patent Application Publication No. 2000-143006 includes a recording medium installing portion in which the same recording medium as the recording medium used in a digital camera can be installed. The recording medium is taken out from the digital camera and is installed in the recording medium installing portion, and image data is read from the recording medium. Then, an image based on the image data can be printed. In this system, when a select button in a cartridge for storing print paper is manipulated, a control circuit refers image information relating to image data recorded in the recording medium, and an image corresponding to the manipulation, that is, an image of full-image data (entire frames) recorded in the recording medium, image data having not-yet-printed information (remaining frames) or image data (latest shot frame) having the latest date information can be selectively printed.

However, all of the image printing systems disclosed in Japanese Patent No. 2606340, Japanese Unexamined Patent Application Publication No. 11-008792 and No. 11-155120, and Japanese Unexamined Patent Application Publication no 2002-191000 filed by the applicant aim for the simplification of the system configurations. For example, details of printing and charging operations to be performed when a digital camera and an image printer are connected, especially, a detail of timing for the charging operation are not disclosed or proposed.

Furthermore, the conventional image printing systems disclosed in Japanese Patent No. 2606340, Japanese Unexamined Patent Application Publication No. 11-008792, No. 11-155120, and No. 11-254764 are adjusted to print an image by simple operations. However, a user must set in shot electronic data in advance information on whether the data is to be printed or not after the shooting by using a digital camera. Then, an image to be printed is selected and is printed based on the information.

Therefore, the number of operations to be performed by a user is increased in this case, and the load on the user is increased when images of all of shot image data are desired to print, for example.

In other words, the various operations for printing an image based on the image data shot by a digital camera may be complicated for a user, such as taking out a recording medium from a digital camera and installing the recording medium in an image printer through a connector cable, connecting a digital camera and image printer, selecting desired image data to be printed after a shooting operation by using a digital camera and adding information on whether to be printed or not by a predetermined operation.

The image printing system disclosed in Japanese Unexamined Patent Application Publication No. 2000-143006 requires the operation for removing a recording medium from the digital camera and installing the recording medium in the image printer. Furthermore, the printing control itself of the image printer is performed independently, which is difficult to use. Additionally, since the image printer is provided as an independent apparatus, further improvements may be required for reducing the production cost.

On the other hand, Japanese unexamined Patent Application Publication No. 10-108005 discloses a system for performing various forms of printing by connecting a digital camera and a printer without using a personal computer. The publication also discloses a following technology, for example. That is, data for operating the printer is stored in a memory in a printer, and the stored data is sent to the digital camera. Then, images for operating the printer including multiple format selection images are displayed by a display unit of the digital camera. Then, a select unit selects one format from multiple formats (forms of image display) by referring to the operation images and selects a photo image by the digital camera. The photo image is printed in the format based on the selected format image.

Japanese Unexamined Patent Application Publication No. 10-200850 filed by the applicant before proposes a system including a digital camera and a printer for printing an image shot by the digital camera. In this proposition, an image selected to print is displayed on a display portion of the digital camera so that the image can be checked. Then, the data representing the checked image is sent to the printer. With this construction, the selection and check of the image to be printed and the printing of an intended image can be performed easily and securely.

However, the image printing systems in Japanese Unexamined Patent Application Publication No. 10-108005 and No. 10-200850 do not propose the optimum allotment, between the digital camera and the printer, of operational steps relating to the selection of an image to be printed and the selection of a print layout in order to improve the usability of the entire system.

### SUMMARY OF THE INVENTION

The present invention was made in view of these matters. It is an object of the invention to provide an image printing system for performing printing and charging operations when a digital camera and an image printer are connected for achieving better operability and excellent usability or to provide a digital camera and/or printer to be applied to the system.

It is another object of the invention to provide an image printing system having better operability and achieving the reduction of the production costs by simplifying operations to be performed by a user and allowing printing of a desired image easily and fast based on desired image data shot by a digital camera or to provide a digital camera and/or printer to be applied to the system.

It is another object of the invention to provide an image printing system in which a digital camera and a printer are operatively connected, and in which the division of the responsibility for processing relating to operation functions of steps for selecting an image to be printed, for selecting a print layout and so on is optimized between the digital camera side and the printer side or to provide a digital camera and/or printer to be applied to the system.

In order to achieve these objects, a first image printing system according to the invention includes a digital camera applying a secondary battery as a power source and an image printer, which can be operatively connected to the digital camera. In this case, the digital camera includes a camera controller for entirely controlling functions of the digital camera, a first connecting unit removably connectable to the image printer without using a connection cable, a decompressing unit for decompressing image data recorded in an applied recording medium to an image data for printing compliant with the image data, and a data transfer unit for transferring an output of the decompressing unit to the outside through the first connecting unit. The image printer includes a printer controller for entirely controlling functions of the image printer, a second connecting unit suitable for data exchanges by connecting to the first connecting unit in the digital camera side, a power supply unit for feeding power to the digital camera and for charging the secondary battery, and a print start switch for generating an instruction signal for instructing the start of a printing operation. The print start switch is turned on in the image printer side when the first connecting unit and the second connecting unit are connected to each other so that the camera controller and the printer controller in connection with each other can transfer the image data for printing from the data transfer unit in the digital camera side to the image printer side through the first connecting unit and the second connecting unit, cause the image printer side to perform the printing operation on the transferred image data, and cause the power supply unit in the image printer side to start a charging operation for charging the secondary battery in the digital camera side after the completion of the printing operation.

A second image printing system according to the present invention includes an image printer having a first connecting unit which can detachably mount a digital camera without using any connecting cable, a print engine outputting an image print based on data transferred from the digital camera and a print start switch for generating a signal which indicates the start of the printing operation, an image memory provided for storing compressed shot image data and printing history information relating to a fact that image printing processing was performed in the past as attribute information of the image data, a second connecting unit which can be detachably connected to the first connecting unit, a transfer unit for transferring image data recorded in the image memory to the image printer through the second connecting unit and an update unit for updating the printing history information, when the first connecting unit and the second connecting unit are operatively connected, and when a printing operation is started in the image printer, the camera controller and the printer controller in connection with each other cause to sequentially print image data having been not printed until the start and to update the corresponding printing history information when the printing of the image data completes.

A third image printing system (or, simply, printing system) according to the invention in which a digital camera and printer including a control unit for controlling operations are operatively connected includes the digital camera including a selecting operation function portion for receiving, under the control of the control unit, operations including a layout selecting operation for selecting a desired print layout and an image selecting operation for selecting an image to be printed from images stored in an applied information recording carrier, and a print control data storing function portion for storing print control data corresponding to the operation received by the selecting operation function portion in the information recording carrier under the control of the control unit and the printer including a setting operation function portion for, under the control of the control unit, receiving operations including a number-of-sheets-to-be-printed setting operation for setting a desired number of sheets to be printed and a recognition function portion for recognizing the number of sheets to be printed set by the setting operation function portion and print control data created by the digital camera side and for printing an image based on the recognition under the control of the control unit.

In this construction, the digital camera and the printer may be “operatively connected” by means of radio, wire line or mutual transferring of a recording medium, or other appropriate manner. The radio manner may be infrared ray communication or Bluetooth. The mutual transfer of a recording medium (such as a Smart Media (R) and a Compact Flash (R)) refers to a case where a recording medium is removed from the digital camera side and is inserted to the printer side.

An example of the selecting operation function portion in the digital camera is a print setting indication and an input key or the like corresponding to the indication on a liquid crystal display portion on the back of the digital camera. The term, “receiving” means that the control unit recognizes an operation performed on the operating portion by a user. The same is true in the inventions mentioned below.

The information recording carrier in the digital camera refers to an internal memory and/or applied recording medium in the digital camera.

The print control data storing function portion in the digital camera refers to a function portion for sending an input through an operation key to the internal memory and/or recording medium as data indicating control information under the control of the control unit (system controller). More specifically, the print control data storing function portion may be a circuit such as a drive controller, a driver (such as a card slot) and a wire (bus) also having other functions.

An example of the setting operation function portion in the printer may be print setting indications (such as indications for a number of sheets to be printed, a paper size, a paper type and a layout form) and the input key indications corresponding to these indications in accordance with the input keys in the operating portion and the type of the touch panel.

According to the third image printing system, the digital camera and the printer are operatively coupled, and the selection of an image to be selected and the setting of the print layout can be performed in the digital camera side while the setting of the number of sheets to be printed is performed in the printer side. That is, the settings are divided between the digital camera side and the printer side.

In this way, the processing relating to the operation functions can be divided between the digital camera side and the printer side. Thus, after images of various scenes are shot by a digital camera during travels, the shot images to be printed and the print layout can be determined and be registered by manipulating the digital camera in a car on the return trip, for example. Then, at home, the digital camera is connected to the printer, and the number of sheets to be printed for the registered print layout images is determined. Then, the print button is simply pressed. In this way, multiple shot images can be categorized and be organized (laid out) through the operation on the digital camera, and a highly useful printing system can be provided.

A digital camera compliant with the third image printing system according to the invention includes a selecting operation function portion for, under the control of the control unit, receiving operations including a layout selecting operation for selecting a desired print layout and an image selecting operation for selecting an image to be printed from images stored in an applied information recording carrier, and a print control data storing function portion for, under the control of the control unit, storing print control data corresponding to the operation received by the selecting operation function portion in a predetermined information recording carrier in a form identifiable in a printer side compliant with the digital camera.

The selecting operation function portion may include a display portion for displaying the layout selecting operation and an operation key for performing a layout selecting operation corresponding to the display on the display portion. For example, the display portion is a liquid crystal display portion on the back surface, and the display portion displays print layouts and other indications for setting. The operation key may be an input key corresponding to the indications. The “operation key” herein includes an input accouterment such as a touch panel mounted on the front surface of the liquid crystal display portion.

The print control data storing function portion may store the print control data in a memory portion as an information recording carrier built in the digital camera.

Alternatively, the print control data storing function portion may store the print control data in a recording medium as an information recording carrier removably applied to the digital camera.

A printer compliant with the third image printing system according to the invention includes a setting operation function portion for receiving, under the control thereof, operations including a number-of-sheet-to-be-printed setting operation for setting a desired number of sheets to be printed, and a recognition function portion for recognizing print control data corresponding to the operation when operations including a layout selecting operation for selecting a desired print layout in a digital camera compliant therewith, and an image selecting operation for selecting an image to be printed from images stored in an applied information recording carrier are received by a selecting operation function portion of the digital camera and a number of sheets to be printed set from the setting operation function portion and for printing an image based on the recognition under the control of the control unit.

In this construction, an example of the setting operation function portion in the printer may be print setting indications (such as indications for a number of sheets to be printed, a paper size, a paper type and a layout form) and the input key indications corresponding to these indications in accordance with the input keys in the operating portion and the type of the touch panel.

A fourth image printing system according to the invention is an image printing system in which a digital camera and printer having respective control unit for controlling operations are operatively connected. The digital camera includes a selecting operation function portion for receiving, under the control of the control unit, operations including a layout selecting operation for selecting desired print layout and an image selecting operation for selecting an image to be printed from images stored in an applied information recording carrier, and a print control data storing function portion for storing print control data corresponding to the operation received by the selecting operation function portion in the information recording carrier under the control of the control unit, the selecting operation function portion including a display portion for providing a display for the layout selection operation and an operation key to be used for a layout selecting operation corresponding to the display by the display portion. When the setting by a layout selecting operation and image selecting operation by the selecting operation function portion completes, the control unit controls to store the already set information in an information recording carrier by the print control data storing function portion, and the display portion displays, under the control of the control unit, one indication, which is sequentially selected from prepared multiple kinds of guidance indication every time a required setting completes, as an indication typically representing the current set information within the display screen. The printer includes a setting operation function portion for receiving, under the control of the control unit, operations including an operation for selecting one of multiple settings stored in an information recording carrier as print control data corresponding to a guidance indication typically representing a setting set in the digital camera side and a number-of-sheet-to-be-printed setting operation for setting a desired number of sheets to be printed and a recognition function portion for recognizing a number of sheets to be printed set by an operation by the setting operation function portion and one setting and for printing an image based on the recognition under the control of the control unit.

In this construction, similarly to the third image printing system the digital camera and the printer may be “operatively connected” in a radio or wired manner, by mutually transferring a recording medium or the like.

The selecting operation function portion, information recording carrier and print control data storing function portion in the digital camera may be the same as those in the third image printing system.

For example, the display portion may be a liquid crystal display portion on the back surface, and the display portion displays print layouts and other indications for setting. The operation key may be an input key corresponding to the indications.

The sequentially selected one indication to be rendered as an indication typically representing the current setting refers to a registration number such as “Print 1”, “Print 2” and “Print 3” according to one embodiment (see FIGS. 26 and 27).

The setting operation function portion in the printer may be print setting indications (such as indications for a number of sheets to be printed, a paper size, a paper type and a layout form) and the input key indications corresponding to these indications in accordance with the input keys in the operating portion and the type of the touch panel.

In the fourth image printing system (or, simply, printing system) according to the first invention in which the digital camera and the printer are operatively connected, the setting operations are divided such that the selection of an image to be printed and the setting of a print layout can be performed in the camera side while the setting of the number of sheets to be printed can be performed in the printer side. On the other hand, in the fourth image printing system according to the fourth invention in which the digital camera and the printer are operatively connected, multiple combinations of images to be printed and layouts can be set in the camera side while the combination to be used and the number of sheets to be printed can be selected in the printer side.

According to the fourth image printing system, a printing system having higher usability can be established.

A digital camera compliant with the fourth image printing system of the invention includes a selection operation function portion for receiving, under the control of the control unit, operations including a layout selection operation for selecting a desired print layout in order to print an image by a printer compliant therewith and an image selecting operation for selecting an image to be printed from images stored in an applied information recording carrier, and a print control data storing function portion for storing, under the control of the control unit, print control data corresponding to the operation, which is received by the selecting operation function portion, in an information recording carrier. Furthermore, the selecting operation function portion includes a display portion for providing a display for the print layout selecting operation and an operation key used for performing a layout selecting operation corresponding to the display on the display portion. When the setting required by the layout selecting operation and image selecting operation in the selecting operation function portion completes, the control unit controls the print control data storing function portion to store the already set information in an information recording carrier. Furthermore, the display portion displays, under the control of the control unit, one indication, which is sequentially and automatically selected every time the setting completes among prepared multiple kinds of guidance indication, on the display screen as an indication typically indicating the set information.

In this construction, the selecting operation function portion, information recording carrier and print control data storing function portion are the same as those of the third image printing system.

The description, “the setting required by the layout selecting operation and image selecting operation in the selecting operation function portion” refers to one layout and a series of settings (see FIGS. 26 and 27) for determining an image to be displayed in the layout.

A printer compliant with the fourth image printing system of the invention includes a setting operation function portion for receiving, under the control of the control unit, operations including an operation for selecting data relating to one setting of data, which is set in the digital camera compliant therewith as print control data indicating multiple kinds of setting data relating to combinations between print layouts and corresponding images to be printed and be stored in an information recording carrier, and an operation for setting a desired number of sheets to be printed, and a recognition function portion for recognizing the setting selected by an operation by the setting operation function portion and the set number of sheets to be printed and for printing an image based on the recognition under the control of the control unit thereof.

In this construction, any method can be adopted for supplying data set and stored in the digital camera side to the printer side. Therefore, data may be transferred offline by changing the removable recording medium. Alternatively, the digital camera and the printer may be docked at an electric contact so as to transfer data online.

An example of the setting operation function portion in the printer may be print setting indications (such as indications for a number of sheets to be printed, a paper size, a paper type and a layout form) and the input key indications corresponding to these indications in accordance with the input keys in the operating portion and the type of the touch panel.

Other features and advantages of the present invention will be apparent from the description below.

### BRIEF OF DESCRIPTION OF THE DRAWINGS

FIG. 1 is an entire perspective showing an overview of an image printing system according to a first embodiment of the invention;

FIG. 2 is a schematic block construction diagram showing a digital camera (electronic camera) in the image printing system in FIG. 1;

FIG. 3 is a schematic block construction diagram showing an image printer in the image printing system in FIG. 1;

FIG. 4 is a flowchart schematically showing a flow of a main operation of the digital camera in the image printing system in FIG. 1;

FIG. 5 is a flowchart schematically showing a flow of an operation relating to printing processing of the operation of the digital camera in FIG. 2;

FIG. 6 is a flowchart schematically showing a flow of an operation relating to charging processing of the operation of the digital camera in FIG. 2;

FIG. 7 is a flowchart schematically showing a flow of a main operation of the image printer in the image printing system in FIG. 1;

FIG. 8 is a flowchart schematically showing a flow of an operation relating to printing processing of the operation of the image printer in FIG. 3;

FIG. 9 is a flowchart schematically showing a flow of an operation relating to charging processing of the operation of the image printer in FIG. 3;

FIG. 10 is an entire perspective diagram showing an overview of an image printing system according to a second embodiment of the invention;

FIG. 11 is a schematic block construction diagram showing a digital camera in the image printing system in FIG. 10;

FIG. 12 is a schematic block construction diagram showing an image printer in the image printing system in FIG. 10;

FIG. 13 is a flowchart schematically showing a flow of a main operation of the digital camera in the image printing system in FIG. 10;

FIG. 14 is a flowchart schematically showing a flow of an operation relating to printing processing of the operation of the digital camera in FIG. 11;

FIG. 15 is a flowchart schematically showing a flow of a main operation of the image printer in the image printing system in FIG. 10;

FIG. 16 is a flowchart schematically showing a flow of an operation relating to printing processing of the operation of the image printer in FIG. 12;

FIG. 17 is a conceptual diagram showing a detail of a data file including image data to be recorded in a recording medium used in the image printing system in FIG. 10;

FIG. 18 is a conceptual diagram showing a detail of another example of a data file including image data to be recorded in a recording medium used in the image printing system in FIG. 10;

FIG. 19 is a diagram showing an example of a display form to be displayed on a display portion of a display apparatus of the digital camera in the process for implementing image printing processing by the image printing system in FIG. 10;

FIG. 20 is a diagram showing another example of a display form to be displayed on a display portion of a display apparatus of the digital camera in the process for implementing image printing processing by the image printing system in FIG. 10;

FIG. 21 is a diagram showing another example of a display form to be displayed on a display portion of a display apparatus of the digital camera in the process for implementing image printing processing by the image printing system in FIG. 10;

FIG. 22 is a diagram showing another example of a display form to be displayed on a display portion of a display apparatus of the digital camera in the process for implementing image printing processing by the image printing system in FIG. 10;

FIG. 23 is a block diagram of a digital camera in a printing system according to a third embodiment of the invention;

FIG. 24 is a block diagram of a printer in the printing system according to the third embodiment;

FIG. 25 is a back view of the digital camera in FIG. 23;

FIG. 26 is a flowchart showing an operation function in a print setting mode based on a manipulation on an operating portion shown in FIG. 25;

FIG. 27 is a flowchart showing an operation function in the print setting mode based on a manipulation on the operating portion shown in FIG. 25; and

FIG. 28 is a plan view showing an operation surface of the operating portion of the printer in FIG. 24.

### DETAIL DESCRIPTION OF THE PREFERRED EMBODIMENT

The invention will be described below with reference to shown embodiments.

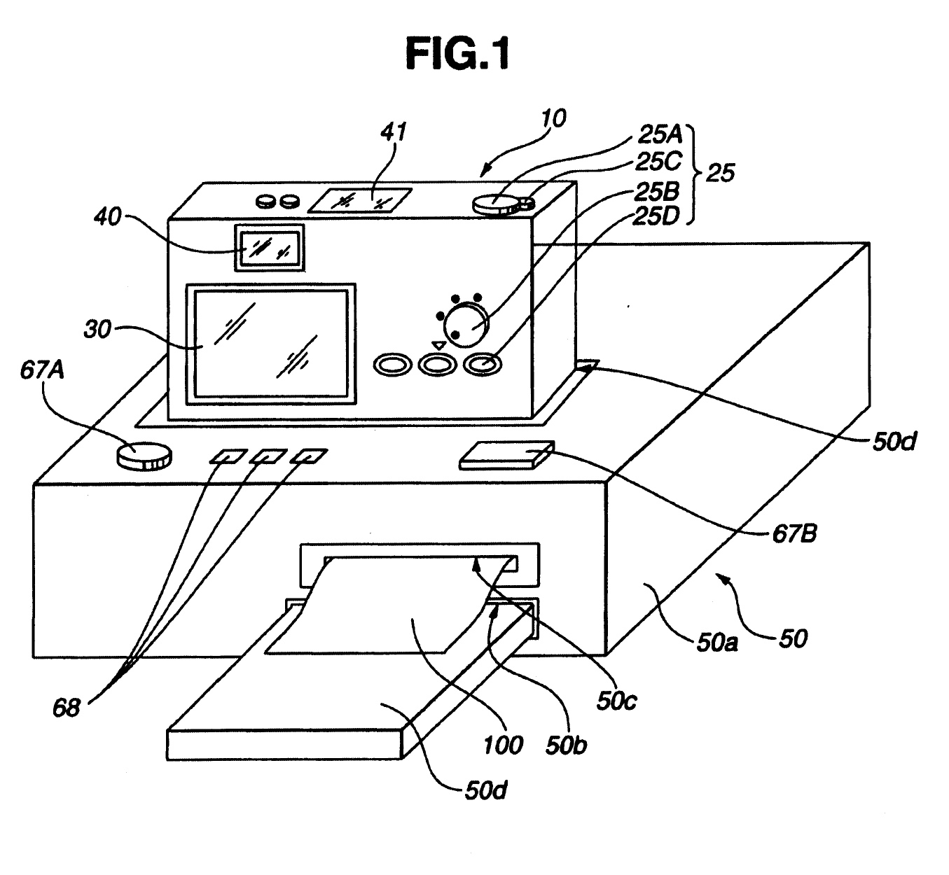

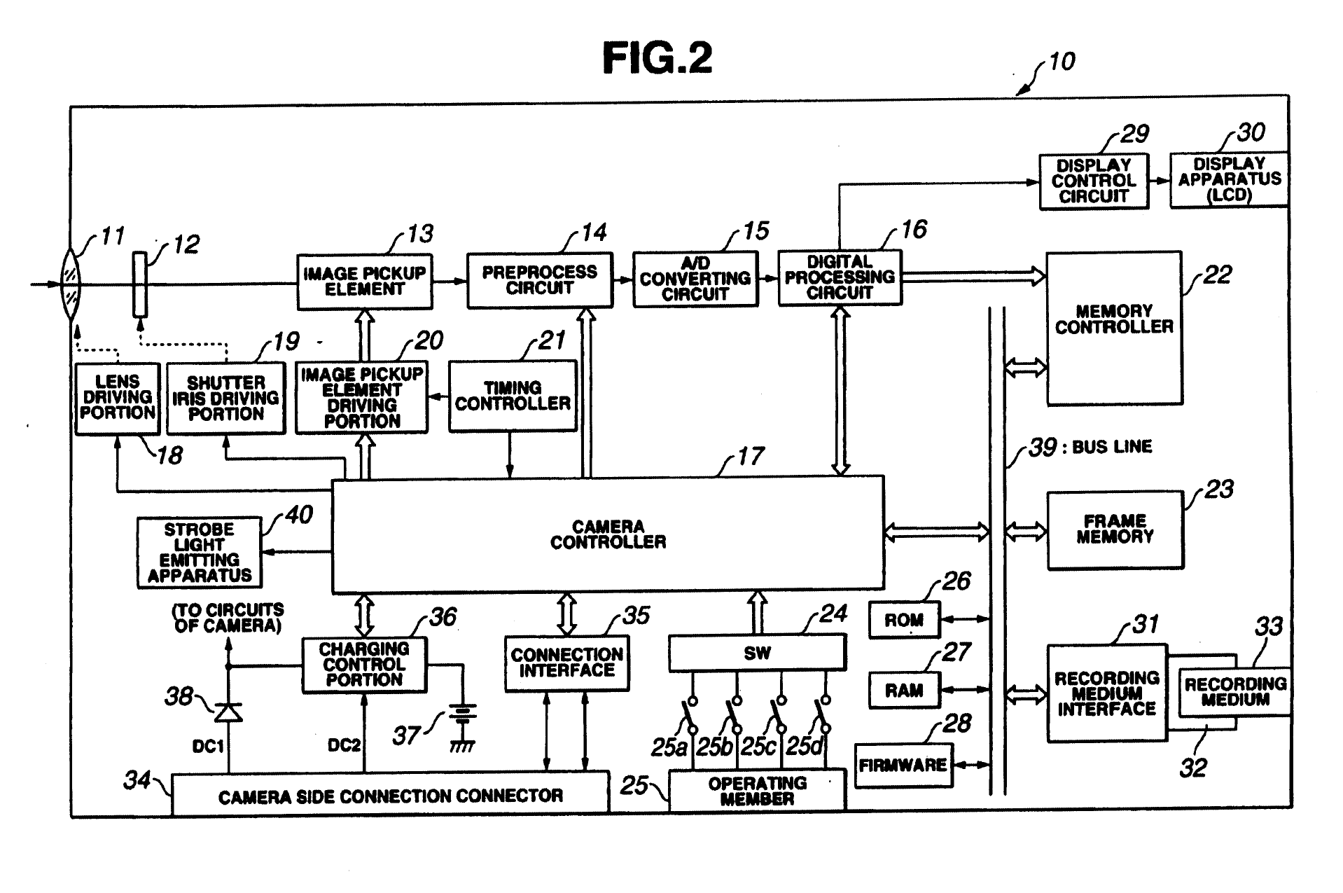

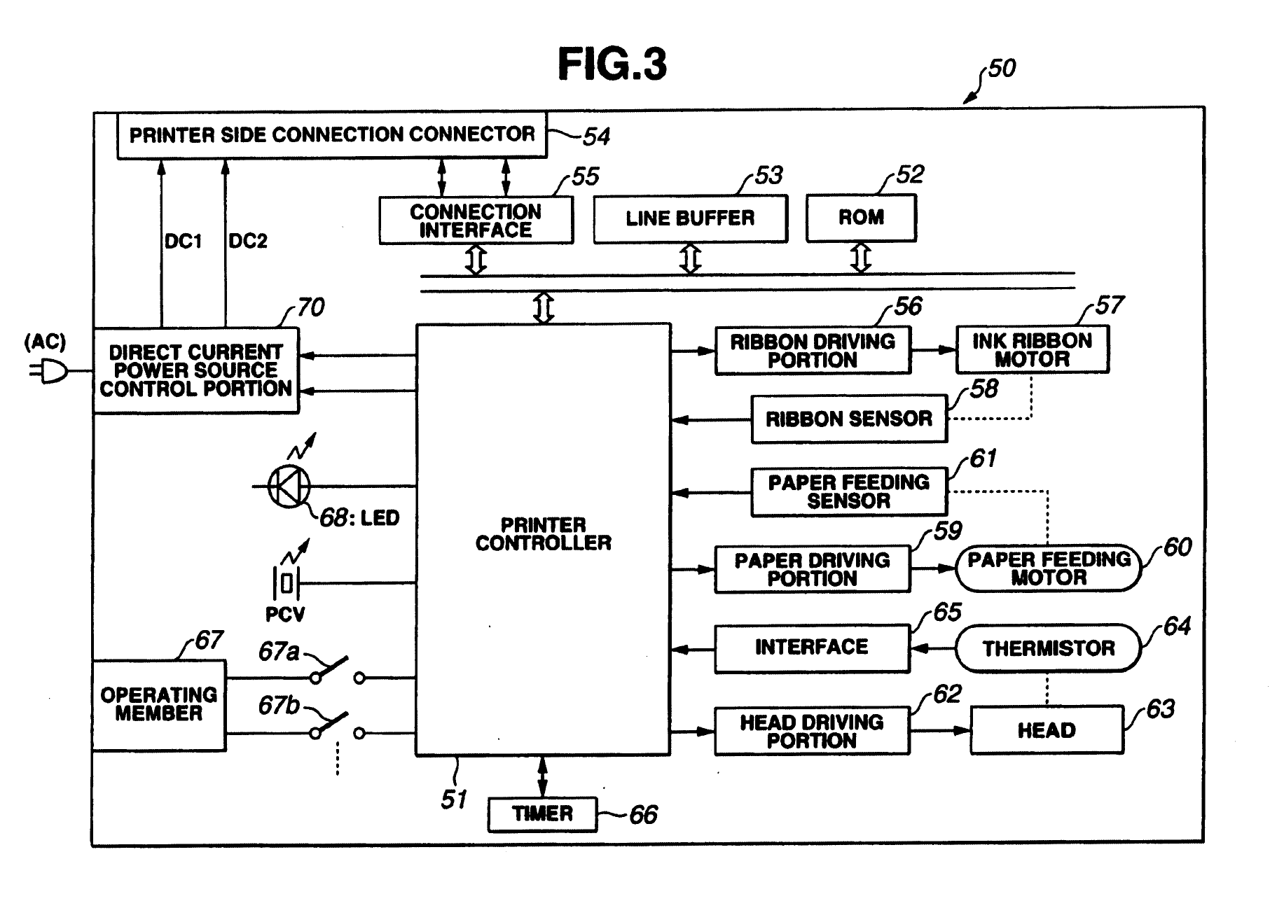

FIG. 1 is an entire perspective showing an overview of an image printing system according to a first embodiment of the invention. FIG. 2 is a schematic block construction diagram showing a digital camera (electronic camera) in the image printing system. FIG. 3 is a schematic block construction diagram showing an image printer in the image printing system.

As shown in FIG. 1, the image printing system according to this embodiment includes a digital camera (that is, electronic camera) 10, and an image printer 50. The digital camera 10 can obtain a desired object image as electric image signals and can record the image signals as image data in a predetermined form. The image printer 50 can print an image based on the image data obtained and recorded by the digital camera 10.

A mount portion 50d for the digital camera 10 is provided on the top surface of the image printer 50. The mount portion 50d has a printer side connection connector 54 (that is, a second connection unit, not shown in FIG. 1, but see FIG. 3) removably connecting the image printer 50 to the digital camera 10. Correspondingly, the digital camera 10 has on the bottom surface a camera side connection connector 34 (not shown in FIG. 1 but see FIG. 2) that is a first connection unit for removably connecting the digital camera 10 to the image printer 50. The first and the second connections operatively connect the electronic camera 10 and the image printer 50. The electronic camera 10 and the image printer 50 can exchange control signals, images and other data with each other and can control each other, as described in detail later.

The camera side connection connector 34 (first connection unit) and the printer side connection connector 54 (second connection unit) also allow the supply of electric power from the image printer 50 side to the digital camera 10 side.

Thus, only by mounting the digital camera 10 on the mount portion 50d of the image printer 50, both of the apparatus can be electrically connected, which establish an image printing system of this embodiment. Under this condition, the digital camera 10 and the image printer 50 are controlled by control units, that is, a camera controller 17 and printer controller 51 (which will be described later in detail with reference to FIGS. 2 and 3). The camera controller 17 and the printer controller 51 are provided within the digital camera 10 and the image printer 50, respectively, and can control respective function portions entirely, such as controls over a data transfer operation between the digital camera 10 and the image printer 50, a printing operation by the image printer 50 and a charging operation onto the digital camera 10.

Here, main components of the digital camera 10 will be described below with reference to FIGS. 1 and 2.

Multiple operating members 25 (see FIGS. 1 and 2) are provided at predetermined positions on the top surface and back surface of the exterior of the digital camera 10 in the image printing system of this embodiment. Each of the operating members 25 is manipulated by a user of the digital camera 10 for implementing a desired operation. The operating members 25 are used to generate instruction signals for instructing various settings and operations in the digital camera 10 in accordance with the manipulation by an operator. As shown in FIG. 1, for example, the operating members 25 include a release button 25A for instructing the start of a shooting operation, a mode dial 25B for selecting and switching an operation form of the digital camera 10, a zoom lever 25C for varying a scale of a shooting optical system and a camera power source operating member 25D for switching ON and OFF of the power source. When one of the operating members 25 is manipulated, a predetermined instruction signal is generated from one of the switches 25a, 25b, 25c and 25d (not shown in FIG. 1 but see FIG. 2) linking to the manipulated operating member 25. The instruction signal is transferred to the camera controller 17 through a switch controller (SW) 24. In response to this, the camera controller 17 implements a predetermined control.

A display apparatus 30, that is a display unit, is provided at a predetermined position on the back surface of the digital camera 10. The display surface of the display portion of the display apparatus 30 is exposed to the outside. The display apparatus 30 is a display unit for displaying an image corresponding to the image signals obtained by the digital camera 10 and includes a liquid crystal display (LCD), for example.

A finder portion 40 is provided near the display apparatus 30. The finder portion 40 is used to observe an object to be shot and assists the setting of the composition for shooting. The finder portion 40 is a general finder including multiple optical lenses, for example.

An information display portion 41 is provided on the top surface of the exterior of the digital camera 10. The information display portion 41 displays setting items in the digital camera 10 in a visually identifiable form. The information display portion 41 includes a small-sized LCD, for example.

FIG. 2 shows the internal construction of the digital camera 10. That is, the digital camera 10 includes the camera controller 17, a shooting optical system 11, a lens driving portion 18, a shutter iris portion 12, a shutter iris driving portion 19, an image pickup element 13, an image pickup element driving portion 20, a timing controller 21, a preprocess circuit 14, an A/D converting circuit 15, a digital processing circuit 16, a memory controller 22, a frame memory 23, a display control circuit 29, a display apparatus 30, a recording medium interface 31, a recording medium 33, a recording medium installing portion 32, firmware 28, a read only memory (RON) 26, a random access memory (RAM) 27, a camera side connection connector 34, a connection interface 35, a chargeable battery 37, a charging control portion 36, a camera side power source circuit 38, and a strobe light emitting apparatus 40. The camera controller 17 is a control unit for entirely controlling operations of the digital camera 10 and comprises a central processing unit (CPU) having a system large scale integration (LSI), for example. The shooting optical system 11 comprises multiple optical elements and gathers pencils of light from an object to form an optical object image. The lens driving portion 18 mechanically drives the shooting optical system 11 under the control of the camera controller 17. The shutter iris portion 12 is provided on a light axis of a pencil of light passing through the shooting optical system 11 and adjusts an amount of light to be irradiated to a photoreceptive surface of the image pickup element 13, which will be described later. The shutter iris driving portion 19 mechanically drives the shutter iris portion 12 under the control of the camera controller 17. The image pickup element 13 comprises an optoelectronic transducer, such as a charge-coupled device (CCD) sensor. The image pickup element driving portion 20 drives the image pickup element 13. The timing controller 21 sends a synchronous signal to the image pickup element driving portion 20 to control driving timing of the image pickup element 13. The preprocess circuit 14 performs predetermined signal processing in response to the electric signal corresponding to the object image obtained by the image pickup element 13. The A/D converting circuit 15 converts an output (analog signal) received from the preprocess circuit 14 to a digital signal. The digital processing circuit 16 performs predetermined digital signal processing on the output (digital signal) received from the A/D converting circuit 15. The memory controller 22 is a temporary recording unit for temporarily storing image data and various kinds of data. The frame memory 23 temporarily stores image data for printing created under the control of the camera controller 17. The display control circuit 29 performs various kinds of signal processing relating to the display, such as processing for creating an image signal to be displayed in a form best suited for the image display by the display unit based on the image data obtained by the digital camera 10 or the image data recorded on the recording medium 33 (which will be described later). The display apparatus 30 is a display unit including a display portion for displaying image signals output from the display control circuit 29 as an image. The recording medium interface 31 is provided between the camera controller 17 and the recording medium 33 (which will be described later) and transfers image data for recording. The recording medium 33 comprises a semiconductor memory medium and/or a magnetic or optical recording medium for recording image data for recording obtained by the digital camera 10 and created by predetermined signal processing. The recording medium installing portion 32 is provided between the recording medium 33 and the recording medium interface 31 and electrically connects therebetween. The firmware 28 is a memory in which operation programs for the digital camera 10 are recorded in advance. Basic initial setting values relating to operations of the digital camera 10 are recorded in the ROM 26 and the RAM 27. The camera side connection connector 34 removably connects the digital camera 10 to the image printer 50. The connection interface 35 is a circuit in a data transfer unit and is provided between the camera side connection connector 34 and the camera controller 17. The connection interface 35 is a data transfer unit for transferring image data and/or various instruction signals. The chargeable battery 37 is a main power source of the digital camera 10 and includes a secondary battery. The charging control portion 36 receives a part (DC2) of electric power supplied from a direct-current power source control portion 70 (which will be described later) of the image printer 50 to be connected to the digital camera 10 through the connection connectors 34 and 54 and charges the chargeable battery 37. The camera side power source circuit 38 controls a part (DC1) of electric power supplied from the direct-current power source control portion 70 of the image printer 50 through the connection connectors 34 and 54 to supply required electric power to the electric circuits of the digital camera 10. The strobe light emitting apparatus 40 is an auxiliary light source for shooting.

The circuits in the digital camera 10 are electrically connected to the camera controller 17 through a bus line 39. Thus, the camera controller 17 and each of the components can exchange image data and so on with each other.

As described above, the camera controller 17 is a control unit for entirely controlling the digital camera 10 and can control the entire image printing system when the digital camera 10 and the image printer 50 are connected. In this case, the camera controller 17 controls to send various instruction signals and/or predetermined image data to the printer controller 51 (which will be described later) for entirely controlling the image printer 50.

In the digital camera 10, the camera controller 17 controls the image pickup element 13 to obtain image signals representing an object image, and controls the preprocess circuit 14, A/D converting circuit 15 and digital processing circuit 16 to perform various kinds of image signal processing on the image signals to create image data in a predetermined form.

Image signals are obtained by the image pickup element 13, and predetermined signal processing is performed on the image signals by the preprocess circuit 14. Then, the imaging signals are converted to digital signals by the A/D converting circuit 15. Then, the digital processing circuit 16 performs various kinds of signal processing on the image signals, such as signal processing for creating image data for recording in a form best suited to recording (such as compressed image data), for decompressing image data for recording (compressed data) read from the recording medium 33, which will be described later, and for converting the image data to electric signals in a predetermined form. In other words, the digital processing circuit 16 acts as a unit for compressing image signals and/or decompressing unit for decompressing image data recorded in an applicable recording medium to image data for printing in a form compliant with the image printer.

The created image data in various forms are output to the image printer 50 through the display apparatus 30, memory controller 22, recording medium 33, connection interface 35 and camera side connection connector 34.

As described above, in the image printing system according to this embodiment, the digital camera 10 and the image printer 50 are connected through a predetermined connection unit, that is, the camera side connection connector 34 and the printer side connection connector 54.

In this case, when the digital camera 10 and the image printer 50 are directly connected, the digital camera 10 and the image printer 50 can exchange various kinds of information, instruction signals, control signals and image data, which have been signal-processed into a predetermined form. Furthermore, electric power can be supplied from the image printer 50 to the digital camera 10.

When the digital camera 10 operates alone, the charging control portion 36 receives electric power from the chargeable battery 37 and controls a power source system of the digital camera 10 to supply required electric power to circuit units (not shown) of the digital camera 10 (see D2 in FIGS. 2 and 3).

When the digital camera 10 and the image printer 50 are connected by both of the connection connectors 34 and 54, the direct-current power source control portion 70 of the image printer 50 are electrically connected to the camera side power source circuit 38 and charging control portion 36 of the digital camera 10 through both of the connection connectors 34 and 54.

Under this condition, the direct-current power source control portion 70 of the image printer 50 functions as a power source for supplying electric power to the entire image printing system including both of the digital camera 10 and the image printer 50.

In other words, when the digital camera 10 and the image printer 50 are connected, and when the image printing system operates, the electric power is supplied from the direct-current power source control portion 70 of the image printer 50 to the camera side power source circuit 38 through both of the connection connectors 54 and 34. Thus, the image printing system can operate. In other words, the direct-current power source control portion 70 of the image printer 50 acts as a main power source in the image printing system according to this embodiment.

Additionally, when the digital camera 10 and he image printer 50 are connected, the chargeable battery 37 can receive electric power from the direct-current power source control portion 70 of the image printer 50 through the charging control portion 36. That is, the direct-current power source control portion 70 of the image printer 50 can charge the chargeable battery 37 of the digital camera 10.

The basic construction of the digital camera 10 has substantially the same functions as those of a conventional general digital camera.

Next, main components in the image printer 50 will be described below with reference to FIGS. 1 and 2.

The image printer 50 in the printing system according to this embodiment may adopt a general printing method such as a dye-sublimation thermal transfer method or an ink-jet method. In this embodiment, the image printer 50 adopts a dye-sublimation thermal transfer method including a thermal print head and an ink ribbon.

The image printer 50 has a paper cassette 50d removably attached to a body portion 50a. The paper cassette 50d stores multiple pieces of predetermined print paper 100 to be supplied when a printing operation is performed as shown in FIG. 1.

The image printer 50 further includes an ink-ribbon cassette (not especially shown) removably attached at a predetermined position in the body portion 50a. An ink ribbon on which a dye to be used for printing a desired image on the print paper 100 is wound about the ink-ribbon cassette for storage.

Therefore, the body portion 50a of the image printer 50 has a cassette opening 50b and an eject opening 50c at predetermined positions. The cassette opening 50b can accept the paper cassette 50d. The eject opening 50c ejects the print paper 100 (see FIG. 1) on which a desired image has been printed by a printing operation. In addition, the body portion 50a has a storage opening, not shown, at a predetermined position. The storage opening is used for storing the ink-ribbon cassette into the body portion 50b.

Multiple operating members 67 (those of which described are only shown) such as a printer power source operating member 67A and a print-start operating member 67B are provided at predetermined positions on the exterior of the body portion 50a of the image printer 50. The printer power source operating member 67A is an operating member for turning ON and OFF of the main power source. The print-start operating portion 67B is an operating member for starting a print operation. These multiple operating members are operated by a user when the image printer 50 and the digital camera 10 are connected.

A state indicating unit 68 is located at a predetermined position on the exterior of the body portion 50a of the image printer 50. The state indicating unit 68 includes multiple light emitting diodes (LED) for indicating the state of the image printer 50. The state indicating unit 68 indicates the operational state of the image printer by performing controls like flashing light or changing the color when light is emitted.

On the other hand, as shown in FIG. 3, the image printer 50 includes components such as the printer controller 51, the printer side connection connector 54, a connection interface 55, a read only memory (ROM) 52, a line buffer 53, a head 63, a head driving portion 62, a thermistor 64, an interface 65, a ribbon driving portion 56, an ink ribbon motor 57, a ribbon sensor 58, a paper driving portion 59, a paper-feeding motor 60, a paper-feeding sensor 61, a timer 66, switches, a direct-current power source control portion 70, and the state indicating unit 68. The printer controller 51 entirely controls the image printer 50 in connection with the camera controller 17 of the digital camera 10. The printer side connection connector 54 is a part of the data transfer unit responsible for data transfer between the image printer 50 and the digital camera 10 in connection with the camera side connection connector 34 of the digital camera 10 and is a second connection unit also acting as a power source supply unit for supplying electric power from the image printer 50 side to the digital camera 10 side. The connection interface 55 is a circuit of the data transfer unit and is provided between the printer side connection connector 54 and the printer controller 51. The connection interface 55 transfers image data and various instruction signals. In the RON 52, basic initial setting values (such as a printer ID and the like) relating to operations of the image printer 50 have been recorded in advance. The line buffer 53 is an internal memory for temporarily recording image data for each line transferred from the digital camera 10 and comprises a semiconductor element, for example. The head 63 is a thermal print head of a print engine including a mechanism for transferring a dye on an ink ribbon (not shown) onto the predetermined print paper 100 in accordance with received image data to print the image. The head driving portion 62 is a part of the print engine. The head driving portion 62 reads image data temporarily recorded in the line buffer 53 line by line, outputs them to the head 63 and drives and controls the head 63. The thermistor 64 is a measuring unit for detecting a temperature of the head 63 or near the head 63. The interface 65 converts a resistance value of the thermistor 64 to an electric signal in a predetermined form and transfers the electric signal to the printer controller 51. The ribbon driving portion 56 controls the feeding of the ink ribbon based on the instruction signal from the printer controller 51. The ink ribbon motor 57 feed an ink ribbon stored in the ink-ribbon cassette (not shown) as required under the control of the ribbon driving portion 56. The ribbon sensor 58 monitors the state of the ink ribbon and the ink ribbon cassette within the image printer 50. The paper driving portion 59 controls the feeding of the print paper 100 based on the instruction signal from the printer controller 51. The paper-feeding motor 60 feeds the print paper 100 properly at a predetermined time by a predetermined amount at a predetermined speed under the control of the paper driving portion 59. The paper-feeding sensor 61 monitors the state of the print paper 100 within the image printer 50. The timer 66 is a time-keeping unit (timer unit) for measuring a predetermined time. The switches are used to generate predetermined instruction signals in connection with the operating members 67 including the printer power source operating member 67A and the print start operating member 67B (see FIG. 1). The switches include a power source switch 67a and print start switch 67b implemented on a circuit unit (not shown) of the image printer 50. The direct-current power source control portion 70 acts as a power source for receiving electric power supplied from an external power source (AC), converting the electric power to voltage compliant with the circuit units (not shown) of the image printer 50, controlling the feeding of the voltage, and supplying electric power to the entire image printing system including both of the digital camera 10 and the image printer 50 when the image printer 50 and the digital camera 10 are connected. The state indicating unit 68 comprises multiple light emitting diodes (LED) for indicating the state of the image printer 50.

As described above, the image printer 50 does not have various component blocks, which are generally provided in a conventional image printer, such as a data converting block, a decompressing block, an image memory block and an image display block. The data converting block converts image data (RGB data) obtained by the digital camera 10 to image data for printing (CHY data) in a form best suitable for printing. The decompressing block decompresses compressed image data recorded in the recording medium 33. The image memory block temporarily records one or multiple pieces of image data for printing. The image display block includes a display unit for displaying an image corresponding to the image data to be printed and a display control circuit for controlling the display unit.

When the image printer 50 is used to print a desired image, the image printer 50 and the digital camera 10 are directly connected. By directly connecting them, the printer controller 51 of the image printer 50 and the camera controller 17 of the digital camera 10 perform control operations in connection with each other. The functions to be implemented by the omitted component blocks are implemented by the corresponding predetermined component blocks of he digital camera 10.

The image data (CMY data) for printing created by the digital camera 10 is transferred to the image printer 50 line by line or every several lines. The printer controller 51 of the image printer 50 receives the image data for printing and performs a predetermined control thereon to print the image.

Therefore, the image printer 50 applied in the printing system according to this embodiment cannot perform a printing operation alone and can operate only when the image printer 50 is directly connected to the digital camera 10.

The printer controller 51 acts as a control unit for receiving an instruction signal and/or image data sent from the digital camera 10 through the connection interface 35 and connection connector 34 of the camera and the connection connector 54 and connection interface 55 of the printer and for controlling the printing operation of the image printer 50 based on the received instruction signal and/or image data.

The printer controller 51 monitors various instruction signals in accordance with the switch members corresponding to the operating member 67 on the body portion 50a of the image printer 50 and controls a driving circuit corresponding to the operation on the operating member 67 by a user.

For example, when a user manipulates the printer power source operating member 67A, which is one of the operating members 67 of the image printer 50, the power source switch 67a operates in connection thereto. Thus, an instruction signal is generated for instructing the opening or closing (ON or OFF) of the power source of the image printer 50, and the instruction signal is transferred to the printer controller 51. In response to this, the printer controller 51 performs a predetermined driving control.

For example, when a user manipulates the print start operating member 67B, which is one of the operating members 67 of the image printer 50, the print start switch 67b operates in connection thereto. Thus, a predetermined instruction signal for starting the printing operation is generated, and the instruction signal is transferred to the printer controller 51.

In other words, when a user manipulates a predetermined one of the operating members 67 of the image printer 50, a predetermined instruction signal is generated from the corresponding switch member. In response to this, the printer controller 51 performs the corresponding control. Thus, the image desired by the user can be printed.

The other basic construction of the image printer 50 is substantially the same as that of the conventional, general dye-sublimation thermal transfer type image printer.

The operation of the printing system according to this embodiment having the construction as described above will be described below.

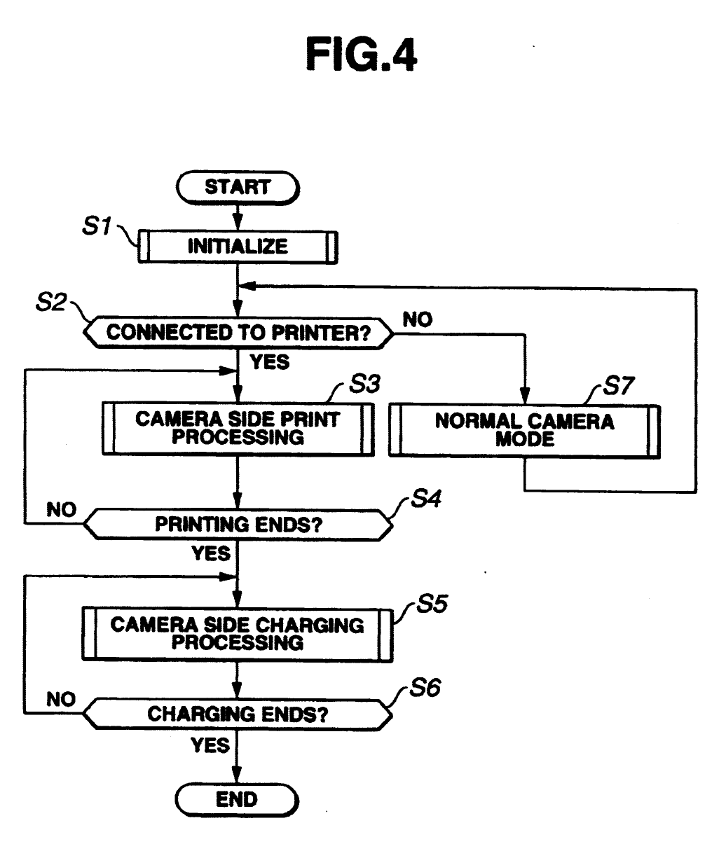

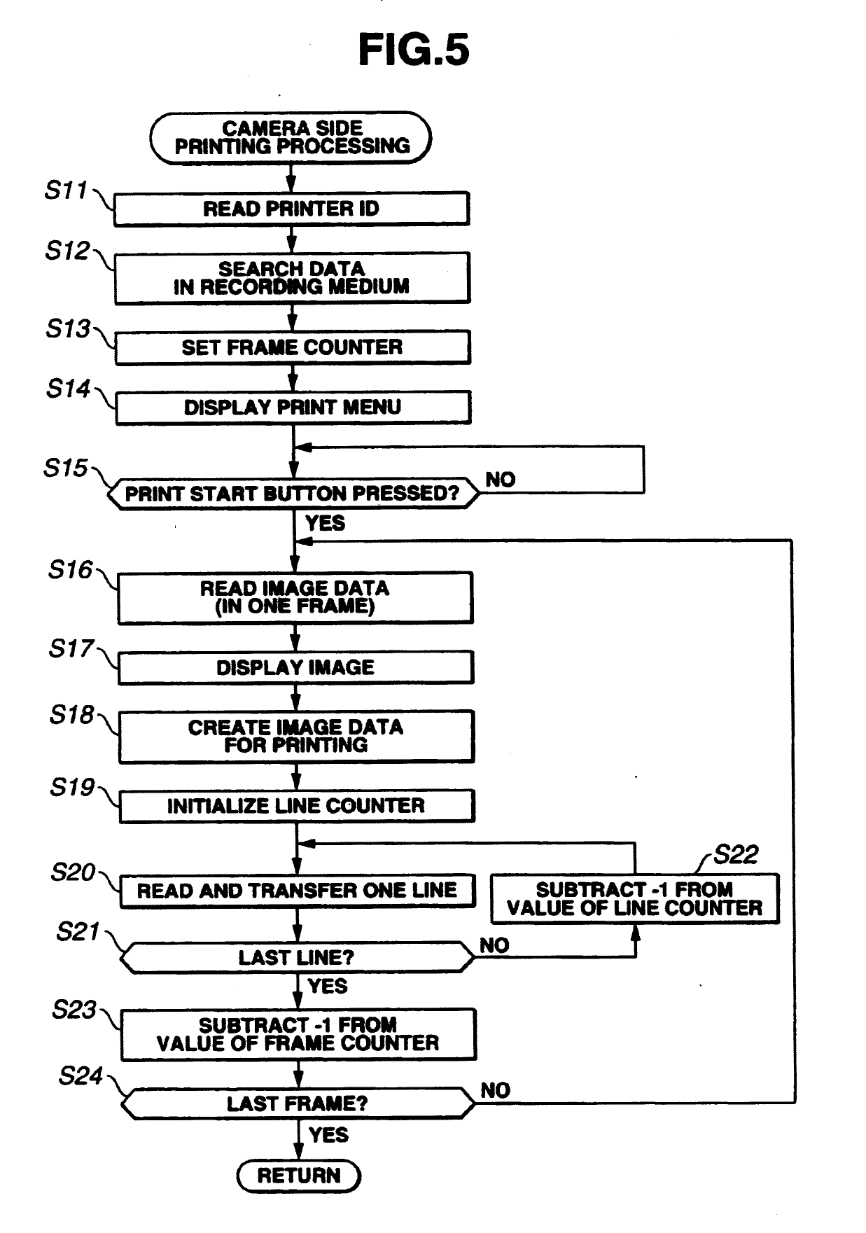

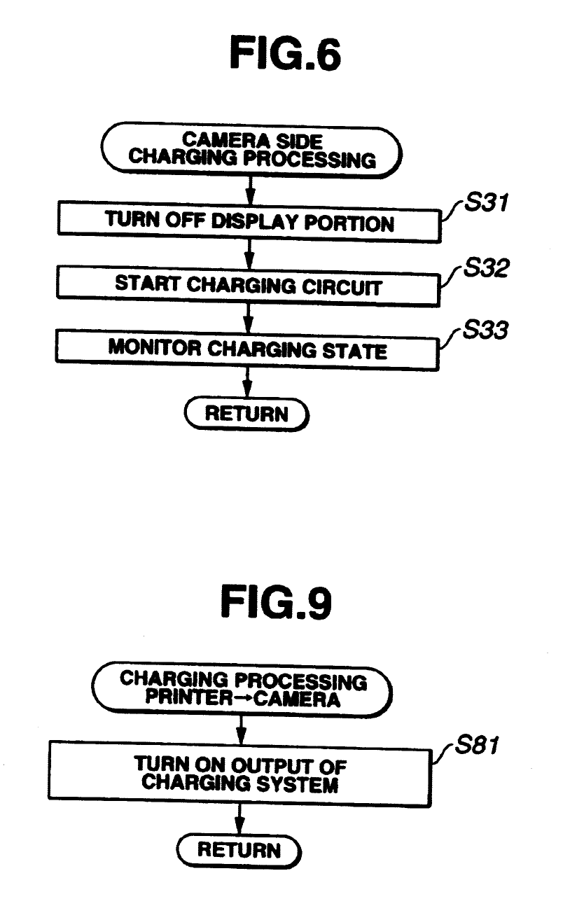

FIGS. 4, 5 and 6 are flowcharts each showing an operation of the digital camera in the image printing system according to this embodiment. FIG. 4 is a flowchart schematically showing a flow of a main operation of the digital camera. FIG. 5 is a flowchart schematically showing a flow of an operation relating to printing processing of operations of the digital camera. FIG. 6 is a flowchart schematically showing a flow of an operation relating to charging processing of operations of the digital camera.

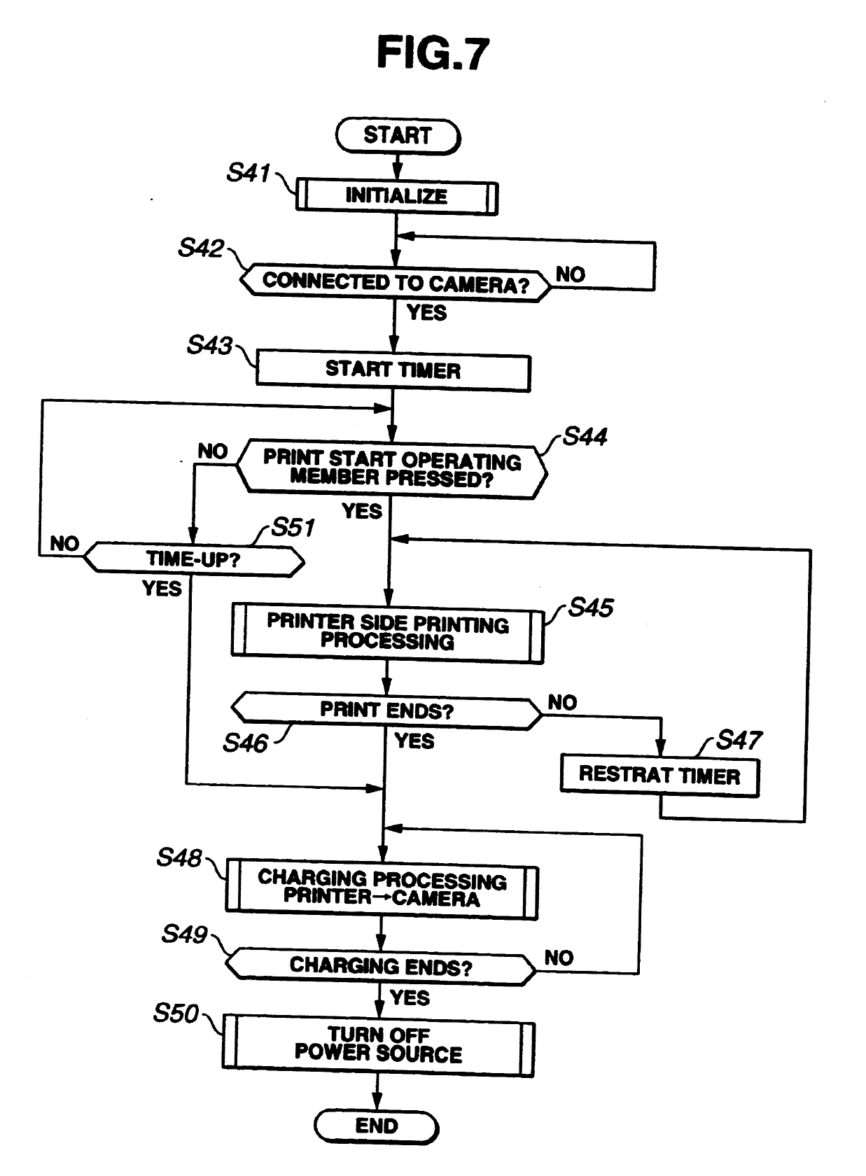

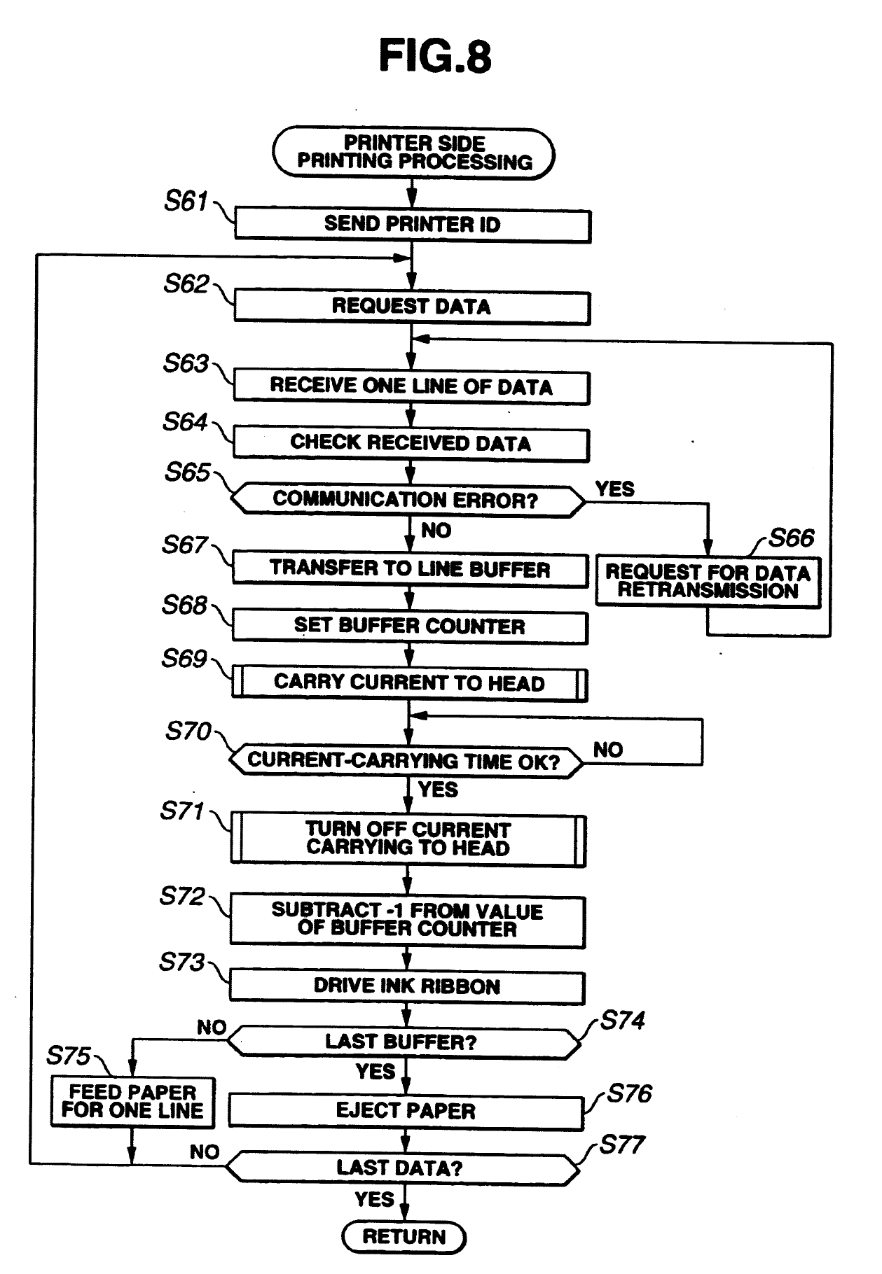

FIGS. 7, 8 and 9 are flowcharts each showing an operation of the image printer in the image printing system according to this embodiment. FIG. 7 is a flowchart schematically showing a flow of a main operation of the image printer. FIG. 8 is a flowchart schematically showing a flow of an operation relating to printing processing of operations of the image printer. FIG. 9 is a flowchart schematically showing a flow of an operation relating to charging processing for charging a secondary battery applied to the digital camera from the printer, the operation belonging to operations of the image printer.

First of all, the flow of the main operation of the digital camera 10 in the image printing system will be described with reference to FIG. 4.

When a user manipulates a camera power source operating member 25D of the digital camera 10, the power source state of the digital camera 10 is switched to close (ON). Then, the instruction signal is transferred to the camera controller 17. In response to this, the camera controller 17 performs predetermined initializing processing in the digital camera 10 at a step S1 as shown in FIG. 4. When the initializing processing completes, the processing goes to a next step S2.

At the step S2, the camera controller 17 checks whether or not the digital camera 10 is connected to the image printer 50. Here, it is checked whether the controllers 17 and 51 of the digital camera 10 and image printer 50 can be communicated through the connection interfaces 34 and 55 by connecting the camera side connection connector 34 and the printer side connection connector 54. When it is determined that the digital camera 10 and the image printer 50 are connected, the processing goes to the next step S3. On the other hand, when it is determined that the digital camera 10 is not connected with the image printer 50 and is active alone, the processing goes to a step S7. At the step S7, the digital camera 10 enters general camera mode processing (step 57) in which a shooting operation can be performed.

Then, while the general camera mode processing is being performed at the step S7, the digital camera 10 monitors an output signal from the connection interface 35 every predetermined time and repeatedly checks whether the image printer 50 is connected or not. In this case, if it is determined that the image printer 50 is connected to the digital camera 10, the processing goes to the step S3 immediately.

At the step S3, the camera controller 17 performs predetermined printing processing (processing following a flowchart in FIG. 5 in detail) in the camera side. The detail of the camera side printing processing will be described later. Next, the processing goes to a step S4.

At the step S4, the camera controller 17 checks whether the predetermined printing processing ends or not. Here, if it is determined that printing processing ends, the processing goes to a step S5. If it is determined that the printing processing has not ended yet, the processing returns to the step S3, and the step S3 and the subsequent steps are repeated.

At the step S5, the camera controller 17 performs the predetermined charging processing (processing following the flowchart in FIG. 6 in detail) in the camera side. The detail of the camera side charging processing will be described later. Then, the processing goes to a step S6.

At the step S6, the camera controller 17 monitors the charging control portion 36 and checks whether or not the predetermined charging of the chargeable battery 37 has completed. Here, if it is determined that the chargeable battery 37 has been changed completely, the instruction signal indicating the completion of the charging is transferred to the printer controller 51 of the image printer 50, and the processing including the series of steps ends. If it is determined that the charging has not been completed yet, the processing returns to the step S5, and the step S5 and subsequent steps will be continued until the charging of the chargeable battery 37 has completed.

Next, the detail of the camera side printing processing (the step S3 in FIG. 4) in the digital camera 10 will be described below with reference to FIG. 5.

As described above, at the step S2 in FIG. 4, if it is determined that the digital camera 10 and the image printer 50 are connected, the camera controller 17 of the digital camera 10 performs the camera side printing processing (the sequence in FIG. 5, that is the step S3 in FIG. 4).

In the beginning of the camera side printing processing, at a step S11 in FIG. 5, the camera controller 17 requests a printer ID to the printer controller 51 through both of the connection interfaces 35 and 55 and both of the connection connectors 34 and 54. In response to this, the printer controller 51 reads a predetermined printer ID from the initial setting value having been recorded in the ROM 52 in advance and sends the predetermined printer ID to the camera controller 17 (see a step S61 in FIG. 8). Then, the processing goes to a step S12.

Here, the term, “printer ID” refers to unique information defined for identifying the kind of the image printer 50 and includes various kinds of information such as a printing resolution (dot/line), a total number of processable lines of image data, color correction data and gamma correction data.

In other words, in the image printing system according to this embodiment, multiple kinds of image printer 50 are connected to one specific digital camera 10 selectively to print an image. Therefore, in order to perform the printing operation, the digital camera 10 must identify the kind of the image printer connected to the digital camera 10 and create image data for printing in accordance with the specification of the image printer.

Therefore, if it is determined that the digital camera 10 is connected to an image printer, the digital camera 10 obtains the printer ID of the image printer 50 connected to the digital camera 10 in the beginning of the printing processing in order to print an image.

Because of this step, the image printing system can include any combination of the digital camera 10 and the image printer 50 with no problems, and good printed results can be always obtained.

Next, at the step S12, the camera controller 17 searches multiple pieces of image data having recorded in the recording medium 33 installed in the recording medium installing portion 32 through the recording medium interface 31 and obtains information on the total number of pieces of image data, for example. Then, the processing goes to a step S13.

At the step S13, the camera controller 17 sets a counter, more specifically, a frame counter, for images to be printed, based on the information obtained at the step S12. Then, the processing goes to a step S14.

At the step S14, the camera controller 17 controls the display apparatus 30 through the display control circuit 29, and the display apparatus 30 is used to display a predetermined printing menu. The printing menu is displayed based on predetermined display information having been recorded in the RON 26 or RAN 27, for example, in advance. Then, the processing goes to a step S15.

At the step S15, the camera controller 17 monitors a predetermined instruction signal, that is, an instruction signals for instructing to start printing (called print start instructing signal hereinafter), from the print start switch 67b in response to the operation on the print start operating member 67B of he image printer 50. Here, the processing waits until the camera controller 17 identifies the print start instructing signal. Once the instructing signal is identified, the processing goes to a step S16.

At the step S16, the camera controller 17 reads a frame of image data from the recording medium 33 installed in the recording medium installing portion 32 through the recording medium interface 31. The read image data is temporarily stored in the memory controller 22. Then, the processing goes to a step S17.

At the step S17, the camera controller 17 controls the display control circuit 29 to perform predetermined signal processing on the image data read at the step S16. The predetermined signal processing is processing for converting the read image data to image data (image data for display) in a form best suitable for displaying the image corresponding to the image data by using the display apparatus 30. Then, the corresponding image is displayed on the display portion of the display apparatus 30 based on the created image signals. Then, the processing goes to a step S18.

At the step S18, the camera controller 17 creates image data for printing by performing predetermined signal processing based on the image data having been read at the step S16 and having been temporarily stored in the memory controller 22. Then, the image data for printing is temporarily stored in the frame memory 23. The signal processing to be implemented here is general signal processing for printing an image based on the image data such as data decompressing processing, color converting processing, gamma setting and line length converting processing. Then, the processing goes to a step S19.

At the step S19, the camera controller 17 performs processing for initializing the set value of a line counter (not shown) in the camera controller 17. The line counter acts as a counter used for transferring image data to be printed to the image printer 50 line by line. Then, the processing waits an instruction of the request for sending image data for printing (see a step S62 in FIG. 8, which will be described later) from the printer controller 51. When the instruction of the request for sending image data for printing is received, the processing goes to a step S20.

At the step S20, the camera controller 17 reads one line of image data for printing temporarily stored in the frame memory 23 and transfers this (the one line of image data) to the printer controller 51 of the image printer 50 through the connection interface 35 and 55 and the connection connectors 34 and 54. Here, the printer controller 51 receives the transferred data and temporarily stores the received data in the line buffer 53 (see a step S63 in FIG. 8, the detail of which will be described later). Then, the processing goes to a step S21.

At the step S21, the camera controller 17 checks whether the count value of the line counter indicates the last line or not. If it is determined here that the image data transferred at that time is the last line, the processing goes to a step S23. If not, the processing goes to a step S22. At the step S22, subtraction processing is performed on the count value of the line counter, and the processing then returns to the step S20. Then, the step S20 and subsequent steps are repeated.

At the step S23, the camera controller 17 performs the subtraction processing on the count value of the frame counter. In other words, by subtracting 1 from the count value of the frame counter here, the information indicating the completion of the printing of the image corresponding to the image data of the first frame is obtained. Then, the processing goes to a step S24.

At the step S24, the camera controller 17 checks the count value of the frame counter in order to determine whether the printed image is of the final frame or not. If it is determined here that the printed image is not of the last frame, the processing returns to the step S16. Then, the step S16 and subsequent steps are repeated until the printing of the last frame has completed. If it is determined here that the printed image is of the last frame, the printing processing having the series of the steps ends, and the processing returns to the sequence in FIG. 4 (return).

Next, the detail of the camera side charging processing (the step S5 in FIG. 4) in the digital camera 10 will be described below with reference to FIG. 6.

As described above, if it is determined that the predetermined printing processing ends at the step S4 in FIG. 4, the camera controller 17 of the digital camera 10 performs the camera side charging processing (the step S5 in FIG. 4, that is the sequence in FIG. 6).

In the beginning of the camera side charging processing at a step S31 in FIG. 6, the camera controller 17 first of all controls the display apparatus 30 through the display control circuit 29 to finish the display by the display portion. Then, the processing goes to a step S32.

At the step S32, the camera controller 17 controls to launch a charging circuit of the charging control portion 36. Then, the processing goes to a step S33.

At the step S33, the camera controller 17 monitors the charging control portion 36 to monitor a state of charge of the chargeable battery 37 by the charging circuit of the charging control-portion 36. After the series of steps ends, the processing goes to the step S6 in FIG. 4 (return).

Then, as described above, the camera controller 17 checks whether the charging to the chargeable battery 37 has been completed or not at the step S6 (in FIG. 4). If the completion of the changing is determined, the camera controller 17 transfers an instruction signal indicating the completion of the charging to the printer controller 51 of the image printer 50. Then, this processing ends.

In this way, in the image printing system, after the series of the steps of the printing operation ends, the charging to the chargeable battery 37 of the digital camera 10 is automatically performed. Furthermore, when the completion of the charging processing is detected, the power source of the digital camera 10 is switched off.

On the other hand, the flow of the main operation in the image printer 50 will be described with reference to FIG. 7.

When a user manipulates the printer power source operating member 67A of the image printer 50, an instruction signal indicating that the power source of the image printer 50 is switched to open (ON) is generated from the power source switch 67a in connection thereto. The instruction signal is sent to the printer controller 51. The printer controller 51 receives the instruction signal and performs predetermined initializing processing in the image printer 50 at a step S41 in FIG. 7. Once the initializing processing has completed, the processing goes to the next step S42.

At the step S42, the printer controller 51 checks whether or not the image printer 50 is connected to the digital camera 10. The checking is the same processing as that of the step S2 (see FIG. 4) in the operation sequence of the digital camera. Thus, it is checked whether or not the controllers 17 and 51 of the apparatuses 10 and 50 can communicate through the connection interfaces 34 and 55 by connecting the camera side connection connector 34 and the printer side connection connector 54. Here, the checking is repeated until it is determined that the image printer 50 and the digital camera 10 are connected. If the connection between the apparatuses 10 and 50 is determined, the processing goes to the next step S43. The power source of the digital camera 10 can have any state here. In other words, the image printer 50 is controlled to start the printing operation and the charging operation once the connection between the image printer 50 and the digital camera 10 is determined, independently from the state of the power source of the digital camera, that is, independently from the switched state of the camera power source operating member 25D.

At the step S43, the printer controller 51 controls the timer 66 to start the time-measuring operation by the timer 66. Then, the processing goes to a step S44.

At the step S44, the printer controller 51 checks whether or not the print start operating member 67B has been pressed. In this step, the printer controller 51 monitors a print start instructing signal from the print start switch 67b in accordance with the manipulation on the print start operating member 67B to identify the instruction signal. Here, if the printer controller 51 cannot identify the print start instruction signal, the processing goes to a step S51.

Then, at the step S51, the printer controller 51 checks whether the set time of the timer 66 has passed or not (time-up). If the time is not up here, the processing returns to the step S44. Then, the step S44 and subsequent steps are repeated. If the time-up is determined, it is determined that the printing operation will not be performed. Then, the processing goes to a step S48, that is, the charging processing.

In the image printing system, when the image printer 50 and the digital camera 10 are connected to each other (step S42), the timer 66 starts to measure time (step S43). In this case, if the timer 66 measures a predetermined set time (time up) without an instruction signal from the print start switch 67b, the charging processing is controlled to start (step S48).

On the other hand, if the printer controller 51 identifies a predetermined print start instruction signal at the step S44, the processing goes to the next step S45.

At the step S45, the printer controller 51 performs predetermined printing processing (the detail of which are shown in the flowchart in FIG. 8) in the printer side. The detail of the printing processing in the printer will be described later. Next, the processing goes to a step S46.

At the step S46, the printer controller 51 checks whether the predetermined printing processing has completed or not. Here, if it is determined the completion of the printing processing, the processing goes to the next step S48. If it is determined that the printing processing has not been completed, the processing goes to a step S47. At the step S47, the printer controller 51 restarts the timer 66, and the processing then returns to the step S45. Then, the step S45 and subsequent steps are repeated.

A little longer time than the time required for printing a frame of image, for example, is set as the set time of the timer here.

At the step S48, the printer controller 51 performs the charging processing (the detail of which is described in the flowchart in FIG. 9) for charging the secondary battery 37 applied to the digital camera side from the printer side. The detail of the camera side charging processing will be described later. Then, the processing goes to the next step S49.

At the step S49, the printer controller 51 checks whether or not the instruction signal indicating the completion of the charging has been transmitted from the camera controller 17. The printer controller 51 waits until the instruction signal is received. If it is determined from the receipt of the instruction signal that the charging to the chargeable battery 37 of the digital camera has completed, the processing goes to the next step S50.

At the step S50, the printer controller 51 controls the direct-current power source control portion 70 to perform processing for shutting off the main power source of itself (power-source shut-off processing). Then, this processing ends (return).

Next, the detail of the printer side printing processing (the step 645 in FIG. 7) in the image printer 50 will be described below with reference to FIG. 8.

As described above, when the digital camera 10 and the image printer 50 are connected, and if it is determined that the print start operating member 67B has been manipulated at the step S44 in FIG. 7, the printer controller 51 performs the printer side printing processing (the step S45 in FIG. 7, that is the sequence in FIG. 8).

In the beginning of the printer side printing processing, at a step S61 in FIG. 8, the printer controller 51 reads a predetermined printer ID from the RON 52 in response to a request for transmitting the printer ID (see the step S11 in FIG. 5) from the camera controller 17 of the digital camera 10. Then, the printer controller 51 sends the predetermined printer ID to the camera controller 17. Then, the processing goes to the next step S62.

At the step S62, the printer controller 51 sends an instruction for requesting the transmission of image data for printing of the image to be printed to the camera controller 17. In response this, the camera controller 17 transfers one line of the image data for printing to the printer controller 51 at the step S20 in FIG. 5 as described above. Then, the processing goes to a step S63.

At the step S63, the printer controller 51 receives one line of the image data for printing having been transferred from the digital camera 10. Then, the processing goes to a step S64.

At the step S64, the printer controller 51 checks whether or not one line of the image data for printing having received at the step S62 is image data in a normal form, that is, the printer controller 51 performs received-data checking processing on the received one line of image data for printing. Then, the processing goes to a step S65.

Then, at the step S65, the printer controller 51 checks whether or not the communication operation between the image printer 50 and the digital camera 10 has an abnormality, that is, the printer controller 51 performs communication-error checking processing. Here, if the communication error is not identified, and if the result of the data checking at the step S64 is determined as normal, the processing goes to a step S67.

On the other hand, if the communication error is identified at the step S65, or if it is determined that the received data has an abnormality as a result of the data checking at the step S64, the processing goes to a step S66. At the step S66, the printer controller 51 sends to the camera controller 17 an instruction for requesting to send image data again. Then, the processing returns to the step S63, and the step S63 and subsequent steps are repeated.

If the received data has no abnormality and the communication operation does not have an error, and the processing goes to the step S67, the printer controller 51 transfers the received one line of image data for printing to the line buffer 53 at the step S67. Thus, the received data is temporarily recorded therein. Then, the processing goes to a step S68.

At the step S68, the printer controller 51 performs processing for setting a count value of a buffer counter (not shown) within the printer controller 51. The buffer counter is used to count the number of received lines of image data for printing. After that, the processing goes to a step S69.

Next, at the step S69, the printer controller 51 controls the head 63 through the head driving portion 62 to start current-carrying to the head 63 (head current-carrying ON processing). After that, the processing goes to a step S70.

At the step S70, the printer controller 51 checks the current-carrying time to the head 63. After a predetermined time, the processing goes to the next step S71.

At the step S71, the printer controller 51 controls the head 63 through the head driving portion 62 to stop the current-carrying to the head 63 (that is, the current-carrying-off processing). Then, the processing goes to a step S72.

At the step S72, the printer controller 51 subtracts 1 from the count value of the buffer counter. Then, the processing goes to a step S73.

At the step S73, the printer controller 51 controls to drive the ink ribbon motor 57 through the ribbon driving portion 56. Thus, an amount of ink-ribbon to be supplied corresponding to the one-line of the image data for printing is transported. Then, the processing goes to a step S74.

At the step S74, the printer controller 51 checks whether the count value of the buffer counter is the count value indicating the last buffer or not. Here, if it is determined that the just printed image data is not the last buffer, the processing goes to a step S75 for preparation for printing the next one line of image data.

Then, at the step S75, the printer controller 51 controls to drive the paper-feeding motor 60 through the paper driving portion 59 and performs paper-feeding processing for moving the print paper 100 by an amount corresponding to one line. Then, the processing returns to the step S62, and an instruction to request for transferring the next one line of image data to the camera controller 17 at the step S62. Then, the subsequent steps are repeated.

On the other hand, if it is determined that the just printed image data is the last buffer at the step S74, it is determined that the printing processing on one predetermined image has completed by this printing processing for one line. Then, the processing goes to a step S76.

Then, at the step S76, the printer controller 51 controls to drive the paper-feeding motor 60 through the paper driving portion 59 and performs paper-ejecting processing for ejecting the print paper 100 to the outside of the image printer 50. Then, the processing goes to a step S77.

Next, at the step S77, the printer controller 51 checks whether the just printed image data is the image data of the last frame or not. Here, if it is determined that it is not the image data of the last frame, the processing returns to the step S62. At the step S62, the printer controller sends to the camera controller 17 an instruction for requesting to transfer image data of the frame to be printed next. Then, the subsequent steps are repeated.

At the step S77, if it is determined that the just printed image data is the image data of the last frame, this processing ends (return).

Next, the detail of the printer side charging processing the step (S48 in FIG. 7) in the image printer 50 will be described below with reference to FIG. 9.

As described above, if the completion of the predetermined printing processing is determined at the step S46 in FIG. 7, the printer controller 51 of the image printer 50 performs printer side charging processing (the step S48 in FIG. 7, that is the sequence in FIG. 9).

In the beginning of the printer side charging processing, at a step S81 in FIG. 9, the printer controller 51 controls the direct-current power source control portion 70 to activate a power source (DC2) for charging, which is one of two outputs of the direct-current power source control portion 70. Then, the charging processing ends (return). After that, the processing goes to the step S49 shown in FIG. 7.

As described above, according to the first embodiment, the digital camera 10 and the image printer 50 can connect to each other directly without a connection cable. When both of the apparatus 10 and 50 are connected, the print start operating member 67B of the image printer 50 is only manipulated to start a printing operation. Then, recorded image data is automatically read out from the recording medium 33 attached to the digital camera 10, and an image corresponding to the image data can be printed.

After the completion of the printing operation by the image printer 50, the chargeable battery 37 (secondary battery) of the digital camera 10 is charged. Thus, the chargeable battery 37, which is a main power source of the digital camera 10, can be always charged. Therefore, when the digital camera 10 is not used, the digital camera 10 may be mounted at a predetermined position, that is, at the mount portion 50d of the image printer 50 so that the digital camera 10 can be used anytime.

Furthermore, when the digital camera 10 and the image printer 50 are connected, and if no instructions from the print start switch 67b are received for a predetermined period of time, a charging operation is controlled to automatically start. The charging operation terminates at a fully-charged state. Thus, the chargeable battery 37 of the digital camera 10 can be maintained in a fully-charged condition.

As described above, in the image printing system according to this embodiment, the control is performed in consideration of the implementation timing of the operation for printing an image corresponding to the image data obtained by the digital camera 10 and the operation for charging the digital camera 10. Thus, the image printing system with better operability and excellent usability can be provided.

While the recording medium 33 is removable in the above-described embodiment, the same effect can be obtained even when the recording medium 33 is a recording medium built in the camera. Furthermore, the chargeable battery 37 may be removable or a chargeable battery built in the camera.

As described above, according to the first embodiment of the invention, an image printing system for performing a printing operation and a charging operation when the digital camera and the image printer are connected can be provided which has better operability and excellent usability.

Next, an image printing system according to a second embodiment of the invention will be described.

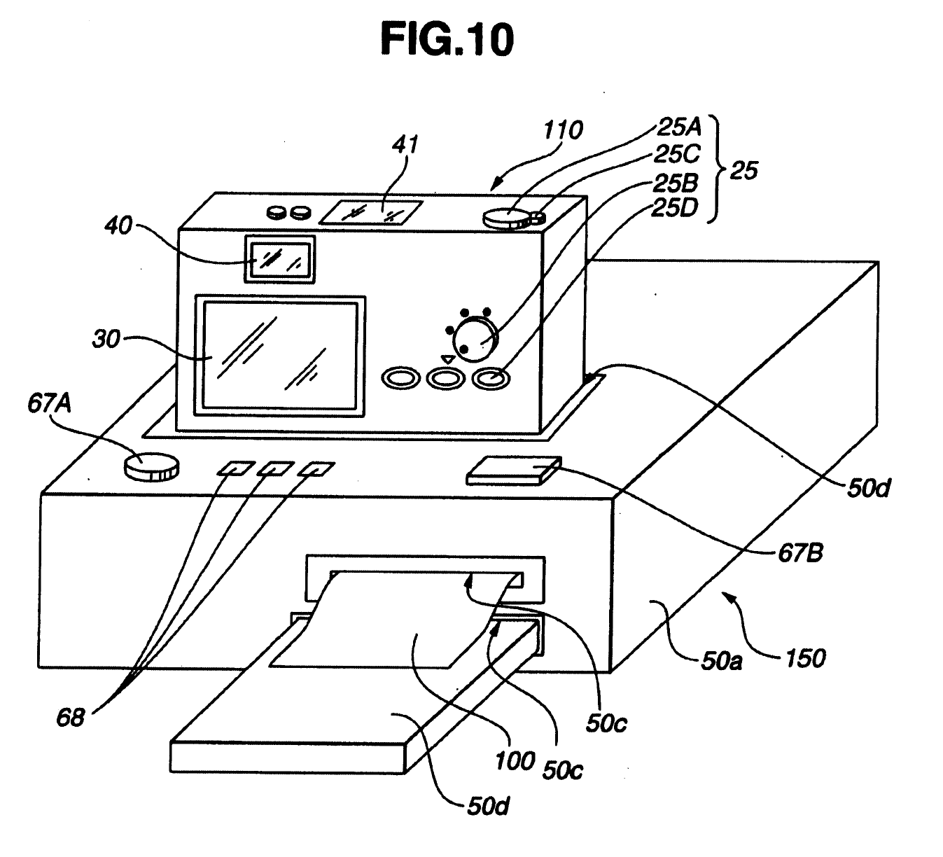

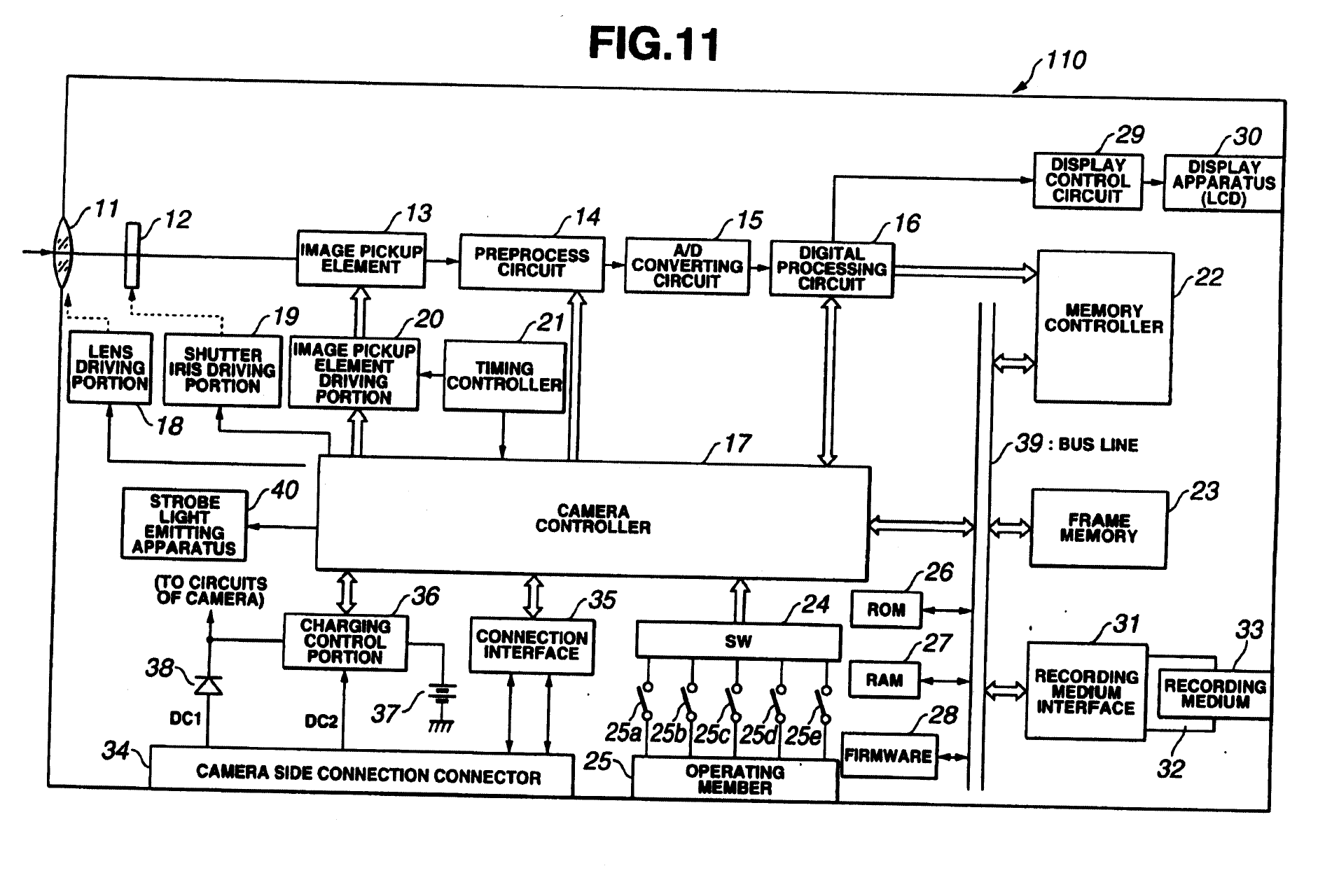

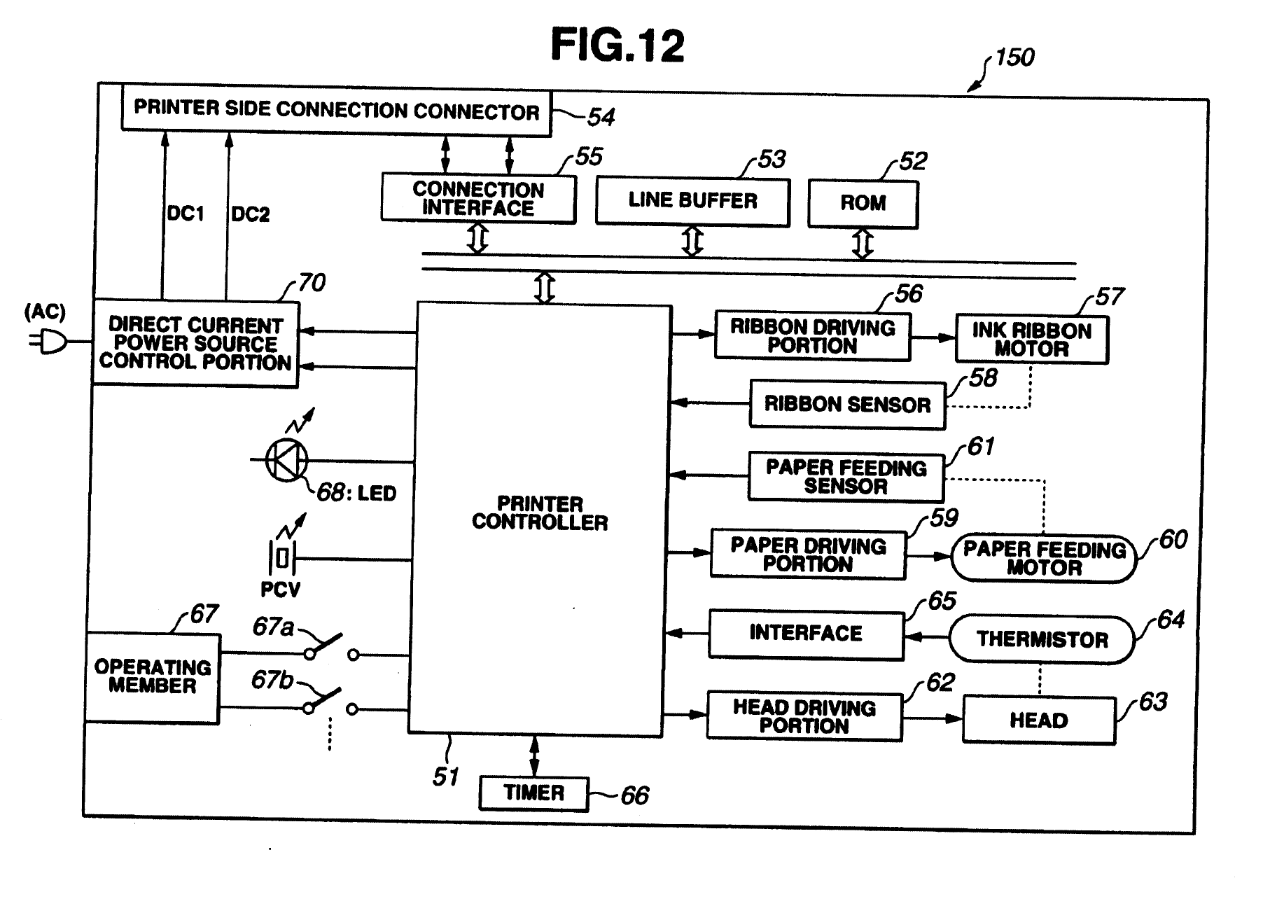

FIG. 10 is an entire perspective showing an overview of an image printing system according to a second embodiment of the invention. FIG. 11 is a schematic block construction diagram showing a digital camera (electronic camera) in the image printing system. FIG. 12 is a schematic block construction diagram showing an image printer in the image printing system.

As shown in FIG. 10, the image printing system according to this embodiment includes two apparatuses of a digital camera (that is, electronic camera) 110, and an image printer 150. The digital camera 110 can obtain a desired object image as electric image signals and can record the image signals as image data in a predetermined form. The image printer 150 can print an image based on the image data obtained and recorded by the digital camera 110.

The components of the digital camera 110 and image printer 150 in the image printing system according to this embodiment include the same components as those of the first embodiments, and the same reference numerals are given to the same components in the description below.

A mount portion 50d for the digital camera 110 is provided on the top surface of the image printer 150. The mount portion 50d has a printer side connection connector 54 (that is, a second connection unit, not shown in FIG. 10, but see FIG. 12) removably connecting the image printer 150 to the digital camera 110. Correspondingly, the digital camera 110 has on the bottom surface a camera side connection connector 34 (not shown in FIG. 10 but see FIG. 11) that is a first connection unit for removably connecting the digital camera 110 to the image printer 150.

The camera side connection connector 34 (first connection unit) and the printer side connection connector 54 (second connection unit) are parts of a data transfer unit allowing both of the apparatuses to perform data communication with each other and act as a power supply unit allowing the supply of electric power from the image printer 150 side to the digital camera 110 side.

Thus, by mounting the digital camera 110 on the mount portion 50d of the image printer 150, both of the apparatuses can be electrically connected by the first connection unit 34 and the second connection unit 54. Thus, an image printing system of this embodiment can be obtained. Under this condition, both of the apparatuses are controlled by included control units, that is, a camera controller 17 and the printer controller 51 in connection with each other (which will be described later in detail with reference to FIGS. 11 and 12). The camera controller 17 and the printer controller 51 can control a data transfer operation between both of the apparatuses, a printing operation by the image printer 150 and a charging operation onto the digital camera 110.

Here, main components of the digital camera 110 will be described below with reference to FIGS. 10 and 11.

Multiple operating members 25 (see FIGS. 10 and 11) are provided at predetermined positions on the top surface and back surface of the exterior of the digital camera 110 in the image printing system of this embodiment. Each of the operating members 25 is manipulated by a user of the digital camera 110 for implementing a desired operation. The operating members 25 are used to generate instruction signals for instructing various settings and operations. As shown in FIG. 10, for example, the operating members 25 include

a release button 25A for instructing the start of a shooting operation,

a mode dial 25B for selecting and switching an operation form of the digital camera 110,

a zoom lever 25C for varying a scale of a shooting optical system,

a camera power source operating member 25D, which is an operating member for switching ON and OFF of the power source, and

a re-print button 25E to be manipulated for instructing a re-printing operation. When one of the operating members 25 is manipulated, a predetermined instruction signal is generated from one of the switches 25a, 25b, 25c, 25d and 25e (not shown in FIG. 10 but see FIG. 11) linking to the manipulated operating member 25. The instruction signal is transferred to the camera controller 17 through a switch controller (SW) 24 shown in FIG. 11. In response to this, the camera controller 17 implements a predetermined control.

The camera controller 17 functions to generally control components of the digital camera 110 and to control operations of the image printing system of the invention in connection with the printer controller 51.

A display apparatus 30, that is an image display unit, is provided at a predetermined position on the back surface of the digital camera 110. The display surface of the display portion of the display apparatus 30 is exposed to the outside. The display apparatus 30 is a image display unit for displaying an image corresponding to the image signals obtained by the digital camera 110 and includes a liquid crystal display (LCD), for example.

A finder portion 40 is provided near the display apparatus 30. The finder portion 40 is used to observe an object to be shot and to assist the setting of the composition for shooting. The finder 40 is a general finder including multiple optical lenses, for example.

An information display portion 41 is provided on the top surface of the exterior of the digital camera 110. The information display portion 41 displays setting items in the digital camera 110 in a visually identifiable form. The information display portion 41 comprises a small-sized LCD, for example. The information display portion 41 is not shown in FIG. 11.

FIG. 11 shows the internal construction of the digital camera 110. That is, the digital camera 110 includes the camera controller 17, a shooting optical system 11, a lens driving portion 18, a shutter iris portion 12, a shutter iris driving portion 19, an image pickup element 13, an image pickup element driving portion 20, a timing controller 21, a preprocess circuit 14, an A/D converting circuit 15, a digital processing circuit 16, a memory controller 22, a frame memory 23, a display control circuit 29, a display apparatus 30, a recording medium interface 31, a recording medium 33, a recording medium installing portion 32, firmware 28, a read only memory (ROM) 26, a random access memory (RAM) 27, a camera side connection connector 34, a connection interface 35, a chargeable battery 37, a charging control portion 36, a camera side power source circuit 38, and a strobe light emitting apparatus 40. The camera controller 17 is a control unit for entirely controlling operations of the digital camera 110 and includes a central processing unit (CPU) having a system large scale integration (LSI), for example. The shooting optical system 11 includes multiple optical elements and gathers pencils of light from an object to form an optical object image. The lens driving portion 18 mechanically drives the shooting optical system 11 under the control of the camera controller 17. The shutter iris portion 12 is provided on a light axis of a pencil of light passing through the shooting optical system 11 and adjusts an amount of light to be irradiated to a photoreceptive surface of the image pickup element 13, which will be described later. The shutter iris driving portion 19 mechanically drives the shutter iris portion 12 under the control of the camera controller 17. The image pickup element 13 comprises an optoelectronic transducer, such as a charge-coupled device (CCD) sensor. The image pickup element driving portion 20 drives the image pickup element 13. The timing controller 21 sends a synchronous signal to the image pickup element driving portion 20 to control driving timing of the image pickup element 13. The preprocess circuit 14 performs predetermined signal processing in response to the electric signal corresponding to the object image obtained by the image pickup element 13. The A/D converting circuit 15 converts an output (analog signal) received from the preprocess circuit 14 to a digital signal. The digital processing circuit 16 performs predetermined digital signal processing on the output (digital signal) received from the A/D converting circuit 15. The memory controller 22 is a temporary recording unit for temporarily storing image data and various kinds of data. The frame memory 23 temporarily stores image data for printing created under the control of the camera controller 17. The display control circuit 29 performs various kinds of signal processing relating to the display, such as processing for creating an image signal to be displayed in a form best suited for the image display by the image-display unit based on the image data obtained by the digital camera 110 or the image data recorded in the recording medium 33 (which will be described later). The display apparatus 30 is an image-display unit including a display portion for displaying image signals output from the display control circuit 29 as an image. The recording medium interface 31 is provided between the camera controller 17 and the recording medium 33 (which will be described later) and exchanges image data for recording. The recording medium 33 is a recording memory including a semiconductor memory and/or a magnetic or optical recording medium for recording image data for recording obtained by the digital camera 110 and created by predetermined signal processing. The recording medium installing portion 32 is provided between the recording medium 33 and the recording medium interface 31 and electrically connects therebetween. The firmware 28 is a memory in which operation programs for the digital camera 110 are recorded in advance. Basic initial setting values relating to operations of the digital camera 110 are recorded in the RON 26 and the RAK 27. The camera side connection connector 34 removably connects the digital camera 110 to the image printer 150. The connection interface 35 is a circuit in a data transfer unit and is provided between the camera side connection connector 34 and the camera controller 17. The connection interface 35 is a data transfer unit for transferring image data and/or various instruction signals. The chargeable battery 37 is a main power source of the digital camera 110 and comprises a secondary battery. The charging control portion 36 receives a part (DC2) of electric power supplied from a direct-current power source control portion 70 (which will be described later with reference to FIG. 12) of the image printer 150 to be connected to the digital camera 110 through the connection connectors 34 and 54 and charges the chargeable battery 37. The camera side power source circuit 38 controls a part (DC1) of electric power supplied from the direct-current power source control portion 70 of the image printer 150 through the connection connectors 34 and 54 to supply required electric power to the electric circuits of the digital camera 110. The strobe light emitting apparatus 40 is an auxiliary light source for shooting.

The circuits in the digital camera 110 are electrically connected to the camera controller 17 through a bus line 39. Thus, the camera controller 17 and each of the components can exchange image data and so on with each other.

As described above, the camera controller 17 is a control unit for entirely controlling the digital camera 110 and can control the entire image printing system when the digital camera 110 and the image printer 150 are connected. In this case, the camera controller 17 controls to send various instruction signals and/or predetermined image data to the printer controller 51 (which will be described later) for entirely control the image printer 150.

In the digital camera 110, the camera controller 17 controls the image pickup element 13 to obtain image signals representing an object image, and controls the preprocess circuit 14, A/D converting circuit 15 and digital processing circuit 16 to perform various kinds of image signal processing on the image signals obtained by the image pickup element 13 to create image data in a predetermined form.

Image signals are obtained by the image pickup element 13, and predetermined signal processing is performed on the image signals by the preprocess circuit 14. Then, the imaging signals are converted to digital signals by the A/D converting circuit 15. Then, the digital processing circuit 16 performs various kinds of signal processing on the image signals, such as signal processing for creating image data for recording in a form best suited to recording (such as compressed image data), for decompressing image data for recording (compressed data) read from the recording medium 33, which will be described later, and converting the image data to electric signals in a predetermined form. In other words, the digital processing circuit 16 acts as units for compressing and/or decompressing image signals.

The image data in various forms, which are created in the digital processing circuit 16, are output to predetermined components such as the display apparatus 30, memory controller 22 and recording medium interface 31 through the display control circuit 29, and the recording medium 33 through the recording medium installing portion 32, and are output to the image printer 150 through the connection interface 35 and camera side connection connector 34.

As described above, in the image printing system according to this embodiment, the digital camera 110 and the image printer 150 are connected through a predetermined connection unit, that is, the camera side connection connector 34 and the printer side connection connector 54.

In this case, when the digital camera 110 and the image printer 150 are directly connected, the digital camera 110 and the image printer 150 can exchange various kinds of information, instruction signals, control signals and image data signal-processed into a predetermined form. Furthermore, electric power can be supplied from the image printer 150 to the digital camera 110.

When the digital camera 110 operates alone, the charging control portion 36 receives electric power from the chargeable battery 37 and controls a power source system of the digital camera 110 to supply required electric power to circuit units (not shown) of the digital camera 110 (see DC2 in FIGS. 11 and 12).

When the digital camera 110 and the image printer 150 are connected by both of the connection connectors 34 and 54, the direct-current power source control portion 70 of he image printer 150 electrically connected to the camera side power source circuit 38 and charging control portion 36 of the digital camera 110 through both of the connection connectors 34 and 54.

Under this condition, the direct-current power source control portion 70 of the image printer 150 functions as a power source for supplying electric power to the entire image printing system including both of the digital camera 110 and the image printer 150.

In other words, when the digital camera 110 and the image printer 150 are connected, and when the image printing system operates, the electric power is supplied from the direct-current power source control portion 70 of the image printer 150 to the camera side power source circuit 38 through both of the connection connectors 54 and 34. Thus, the image printing system can operate. In other words, the direct-current power source control portion 70 of the image printer 150 acts as a main power source in the image printing system according to this embodiment.

Additionally, when the digital camera 110 and he image printer 150 are connected, the chargeable battery 37 can receive electric power from the direct-current power source control portion 70 of the image printer 150 through the charging control portion 36. That is, the direct-current power source control portion 70 of the image printer 150 can charge the chargeable battery 37 of the digital camera 110.

Next, main components in the image printer 150 will be described below with reference to FIGS. 10 and 12.

The image printer 150 in the printing system according to this embodiment may adopt a general printing method such as a dye-sublimation thermal transfer method or an ink-jet method. In this embodiment, the image printer 150 adopts a dye-sublimation thermal transfer method including a thermal print head and an ink ribbon.

The image printer 150 has a paper cassette 50d removably attached to a body portion 50a. The paper cassette 50d stores multiple pieces of predetermined print paper 100 to be supplied when a printing operation is performed as shown in FIG. 10.

The image printer 150 further includes an ink-ribbon cassette (not especially shown) removably attached at a predetermined position in the body portion 50a. An ink ribbon on which a dye to be used for printing a desired image on the print paper 100 is wound about the ink-ribbon cassette for storage.

Therefore, the body portion 50a of the image printer 150 has a cassette opening 50b and an eject opening 50c at predetermined positions. The cassette opening 50b can accept the paper cassette 50d. The eject opening 50c ejects the print paper 100 (see FIG. 10) on which a desired image has been printed by a printing operation. In addition, the body portion 50a has a storage opening, not shown, at a predetermined position. The storage opening is used for storing the ink-ribbon cassette into the body portion 50b.

Multiple operating members 67 (see FIG. 12, those of which described are only shown in FIG. 10 and 12) such as a printer power source operating member 67A and a print-start operating member 67B are provided at predetermined positions on the exterior of the body portion 50a of the image printer 150. The printer power source operating member 67A is an operating member for operating ON and OFF of the main power source. The print-start operating portion 67B is an operating member for starting a print operation. These multiple operating members 67 are operated by a user when the image printer 150 and the digital camera 110 are connected.

A state indicating unit 68 is located at a predetermined position on the exterior of the body portion 50a of the image printer 150. The state indicating unit 68 includes multiple light emitting diodes (LED) for indicating the state of the image printer 150. The state indicating unit 68 indicates the operation state of the image printer by performing controls like flashing light or changing the color when light is emitted.

On the other hand, as shown in FIG. 12, the image printer 150 includes components such as the printer controller 51, the printer side connection connector 54, a connection interface 55, a read only memory (ROM) 52, a line buffer 53, a head 63, a head driving portion 62, a thermistor 64, an interface 65, a ribbon driving portion 56, an ink ribbon motor 57, a ribbon sensor 58, a paper driving portion 59, a paper-feeding motor 60, a paper-feeding sensor 61, a timer 66, switches, a direct-current power source control portion 70, and the state indicating unit 68. The printer controller 51 entirely controls the image printer 150 in connection with the camera controller 17 of the digital camera 110. The printer side connection connector 54 is a part of the data transfer unit responsible for data transfer between the image printer 150 and the digital camera 110 in connection with the camera side connection connector 34 of the digital camera 110 and is a second connection unit also acting as a power source supply unit for supplying electric power from the image printer 150 side to the digital camera 110 side. The connection interface 55 is a circuit of the data transfer unit and is provided between the printer side connection connector 54 and the printer controller 51. The connection interface 55 transfers image data and various instruction signals. In the ROM 52, basic initial setting values (such as a printer ID) relating to operations of the image printer 150 have been recorded in advance. The line buffer 53 is an internal memory for temporarily recording image data for each line transferred from the digital camera 110 and comprises a semiconductor element, for example. The head 63 is a thermal print head of a print engine including a mechanism for transferring a dye on an ink ribbon (not shown) onto the predetermined print paper 100 in accordance with received image data to print the image. The head driving portion 62 is a part of the print engine. The head driving portion 62 reads image data temporarily recorded in the line buffer 53 line by line, outputs them to the head 63 and drives and controls the head 63. The thermistor 64 is a measuring unit for detecting a temperature of the head 63 or near the head 63. The interface 65 converts a resistance value of the thermistor 64 to an electric signal in a predetermined form and transfers the electric signal to the printer controller 51. The ribbon driving portion 56 controls the feeding of the ink ribbon based on the instruction signal from the printer controller 51. The ink ribbon motor 57 feed an ink ribbon stored in the ink-ribbon cassette (not shown) as required under the control of the ribbon driving portion 56. The ribbon sensor 58 monitors the state of the ink ribbon and the ink ribbon cassette within the image printer 150. The paper driving portion 59 controls the feeding of the print paper 100 based on the instruction signal from the printer controller 51. The paper-feeding motor 60 feeds the print paper 100 properly at a predetermined time by a predetermined amount at a predetermined speed under the control of the paper driving portion 59. The paper-feeding sensor 61 monitors the state of the print paper 100 within the image printer 150. The timer 66 is a time-keeping unit (timer unit) for measuring a predetermined time. The switches are used to generate predetermined instruction signals in connection with the operating members 67 including the printer power source operating member 67A and the print start operating member 67B (see FIG. 10). The switches include a power source switch 67a and a print start switch 67b implemented on a circuit unit (not shown) of the image printer 150. The direct-current power source control portion 70 acts as a power source for receiving electric power supplied from an external power source (AC), converting the electric power to voltage compliant with the circuit units (not shown) of the image printer 150, controls the feeding of the voltage, and supplies electric power to the entire image printing system including both of the digital camera 110 and the image printer 150 when the image printer 150 and the digital camera 110 are connected. The state indicating unit 68 includes multiple light emitting diodes (LED) for indicating the state of the image printer 150.

As described above, the image printer 150 does not have various component blocks, which are generally provided in a conventional image printer, such as a data converting block, a decompressing block, an image memory block and an image display block. The data converting block converts image data (RGB data) obtained by the digital camera 110 to image data for printing (CMY data) in a form best suitable for printing. The decompressing block decompresses compressed image data recorded in the recording medium 33. The image memory block temporarily records one or multiple pieces of image data for printing. The image display block includes an image display unit for displaying an image corresponding to the image data to be printed and a display control circuit for controlling the display unit.

When the image printer 150 is used to print a desired image, the image printer 150 and the digital camera 110 are connected. Under this condition, the printer controller 51 of the image printer 150 and the camera controller 17 of the digital camera 110 perform control operations in connection with each other.

The image data (CMY data) for printing created by the digital camera 110 is transferred to the image printer 150 line by line or every several lines. The printer controller 51 of the image printer 150 receives the image data for printing and performs a predetermined control thereon to print the image.

Therefore, the image printer 150 applied in the printing system according to this embodiment can operate when the image printer 150 is connected to the digital camera 110.

The printer controller 51 acts as a control unit for receiving an instruction signal and/or image data sent from the digital camera 110 through the connection interface 35 and connection connector 34 of the camera and the connection connector 54 and the connection interface 55 of the printer and controlling the printing operation by the image printer 150 based on the received instruction signal and/or image data.

The printer controller 51 monitors various instruction signals in accordance with the switch members corresponding to the operating member 67 (such as 67A and 67B) on the body portion 50a of the image printer 150 and controls a driving circuit corresponding to the operation on the operating member 67 by a user.

For example, when a user manipulates the printer power source operating member 67A, which is one of the operating member 67 of the image printer 150, the power source switch 67a operates in connection thereto. Thus, an instruction signal is generated for instructing ON or OFF of the power source of the image printer 150, and the instruction signal is transferred to the printer controller 51. In response to this, the printer controller 51 performs a predetermined driving control.

For example, when a user manipulates the print start operating member 67B, which is one of the operating members 67 of the image printer 150, the print start switch 67b operates in connection thereto. Thus, a predetermined instruction signal for starting the printing operation is generated, and the instruction signal is transferred to the printer controller 51.

In other words, when a user manipulates a predetermined one of the operating members 67 of the image printer 150, a predetermined instruction signal is generated from the corresponding switch member. In response to this, the printer controller 51 performs the corresponding control. Thus, the image desired by the user can be printed.

The operations in the printing system according to this embodiment having the above-described construction will be described below.

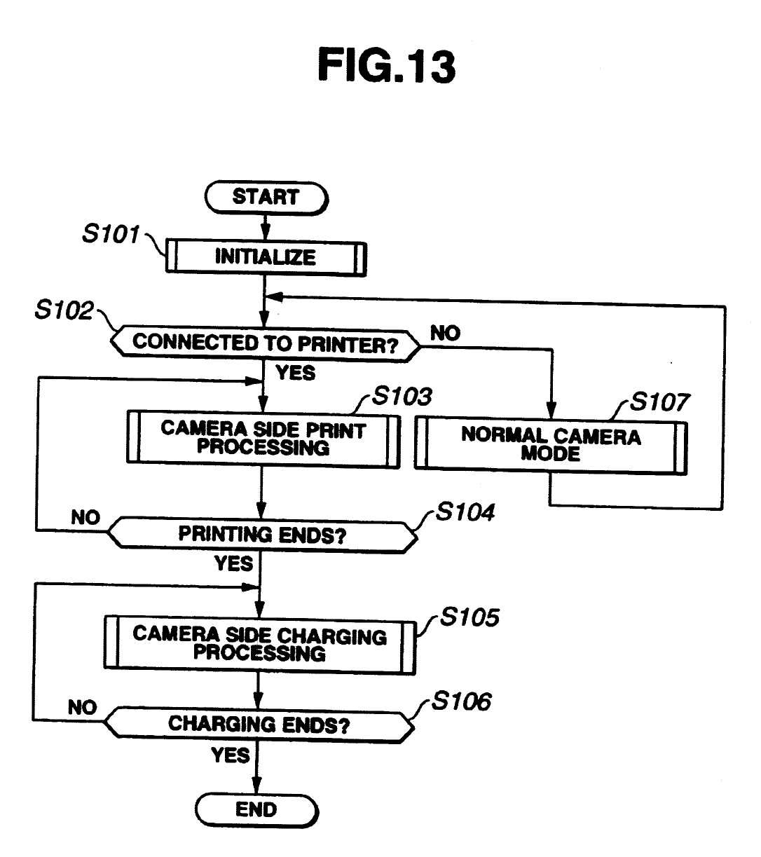

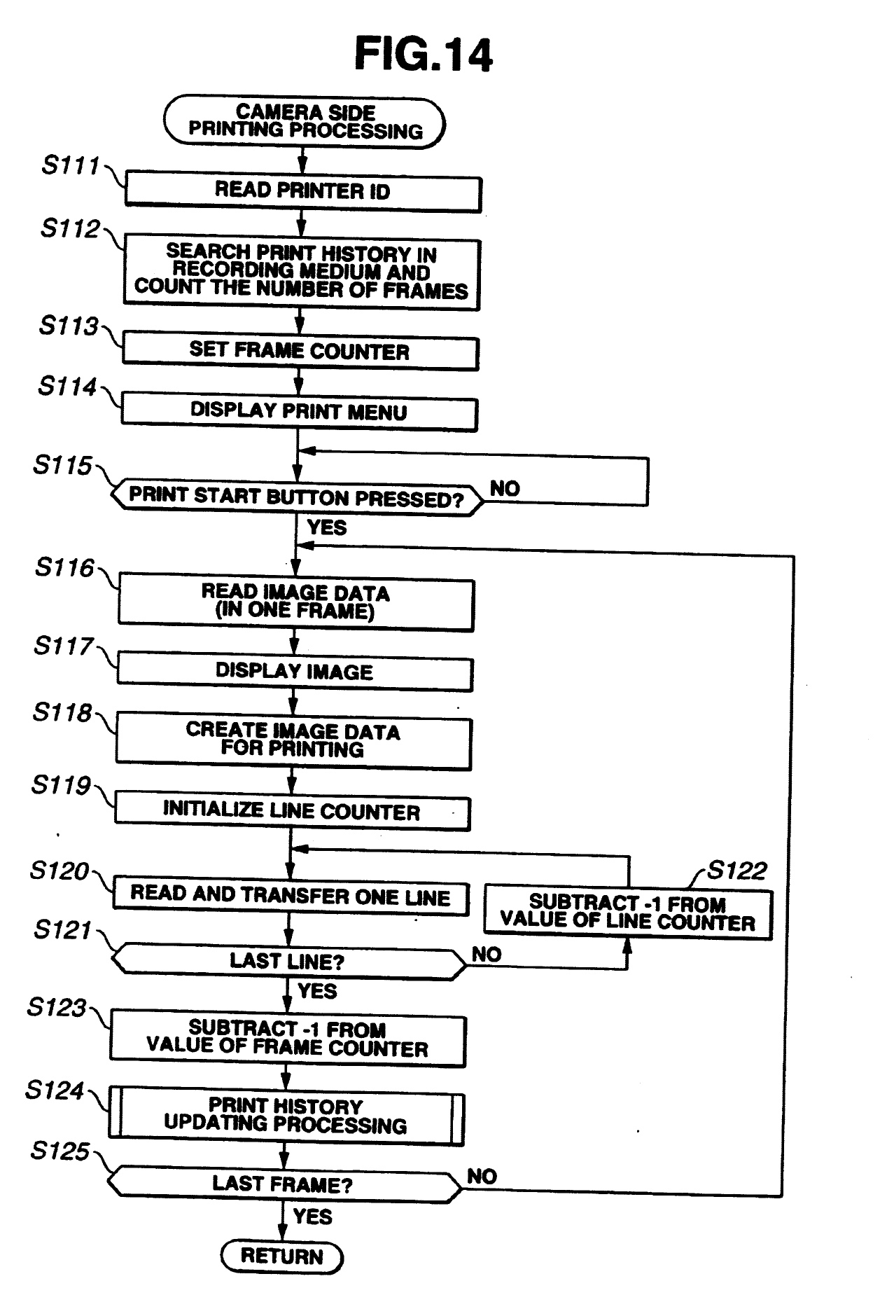

FIGS. 13 and 14 are flowcharts each showing an operation of the digital camera in the image printing system according to this embodiment. FIG. 13 is a flowchart schematically showing a flow of a main operation of the digital camera. FIG. 14 is a flowchart schematically showing a flow of an operation relating to printing processing of operations of the digital camera.

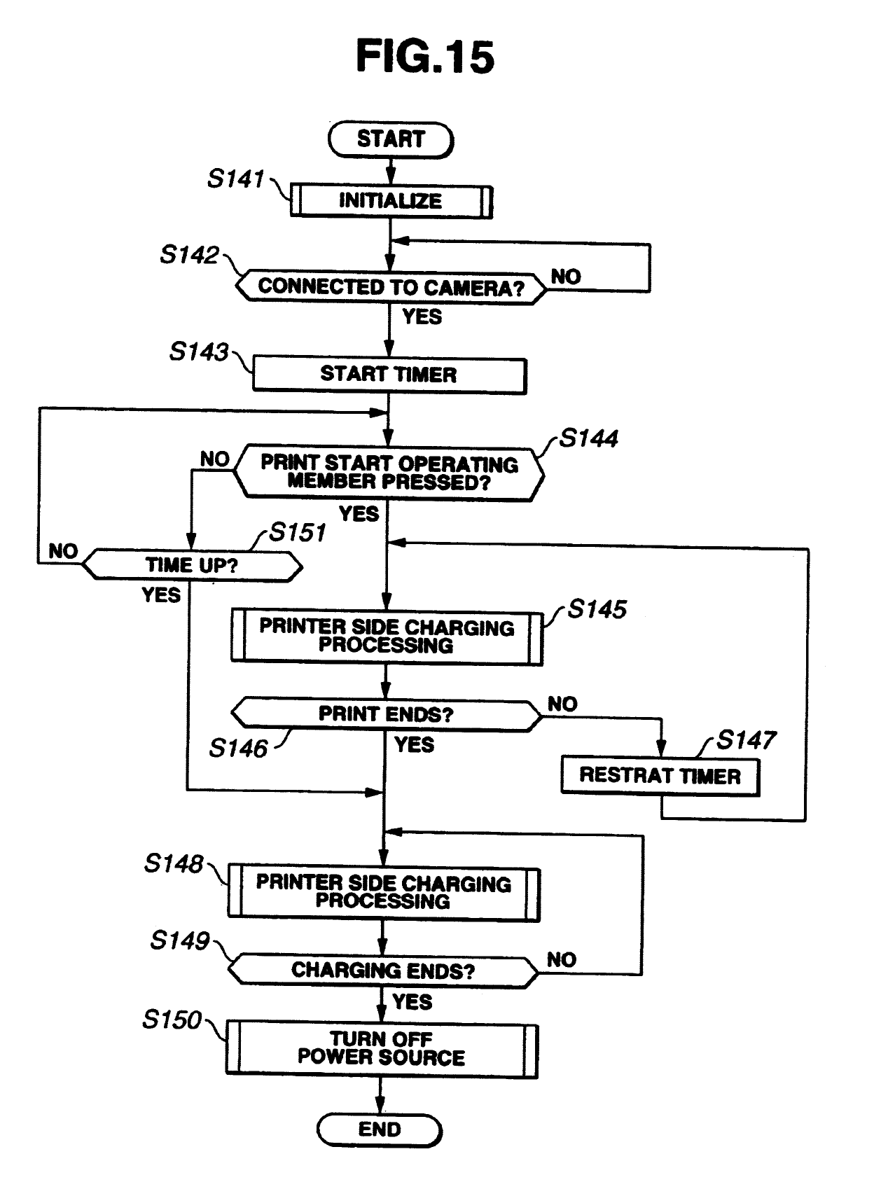

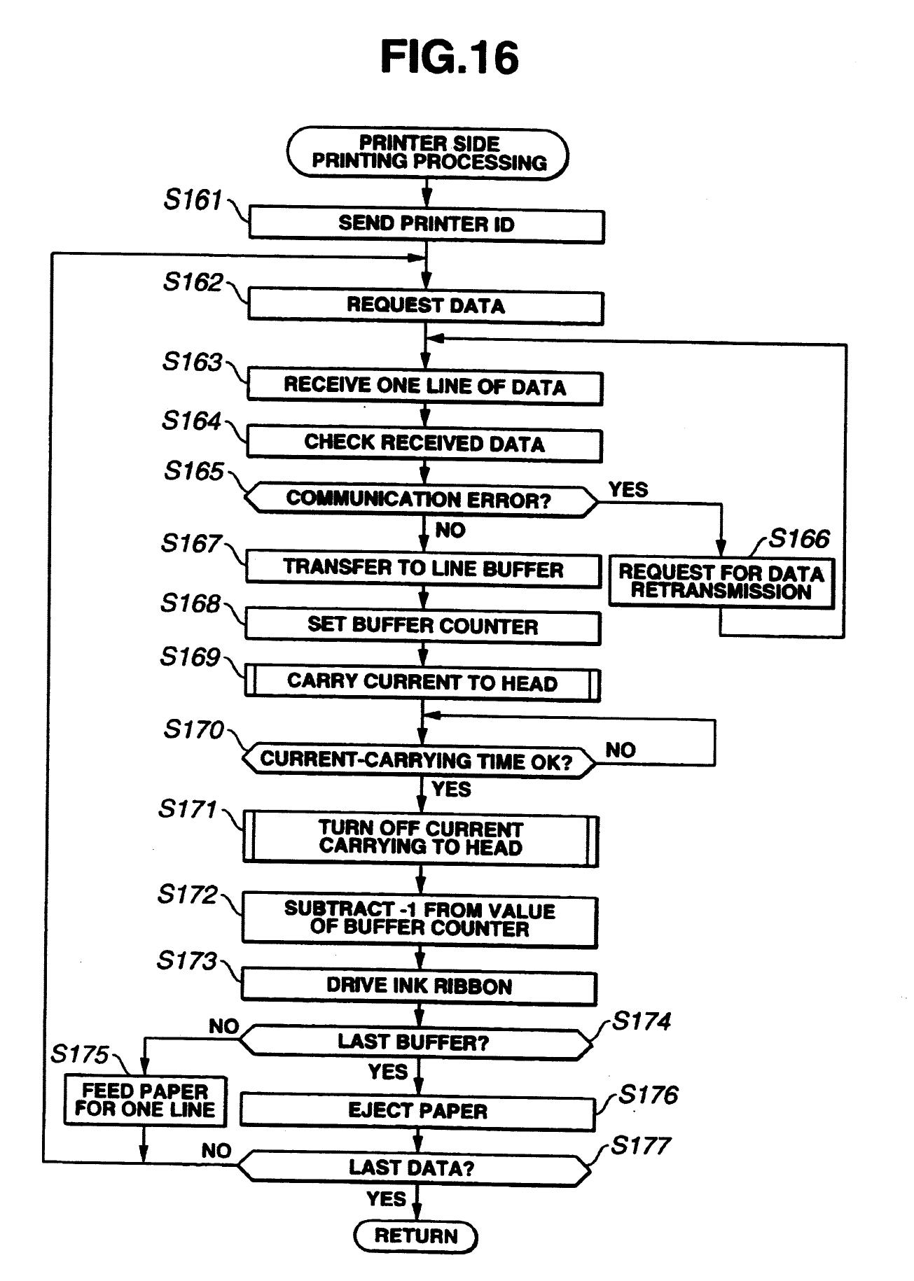

FIGS. 15 and 16 are flowcharts each showing an operation of the image printer in the image printing system according to this embodiment. FIG. 15 is a flowchart schematically showing a flow of a main operation of the image printer. FIG. 16 is a flowchart schematically showing a flow of an operation relating to printing processing of operations of the image printer.

First of all, the flow of the main operation of the digital camera 110 in the image printing system will be described with reference to FIG. 13.

When a user manipulates a camera power source operating member 25D of the digital camera 110, the power source state of the digital camera 110 is switched to close (ON). Then, the instruction signal is transferred to the camera controller 17 through the switch 25d and the switch controller (SW) 24. In response to this, the camera controller 17 performs predetermined initializing processing in the digital camera 110 at a step S101 as shown in FIG. 13. When the initializing processing completes, the processing goes to the next step S102.

At the step S102, the camera controller 17 checks whether or not the digital camera 110 is connected to the image printer 150. Here, it is checked whether the controllers 17 and 51 of the digital camera 110 and image printer 150 can communicate through the connection interfaces 34 and 55 by connecting the camera side connection connector 34 and the printer side connection connector 54.

When it is determined that the digital camera 110 and the image printer 150 are connected, the processing goes to the next step S103. On the other hand, when it is determined that the digital camera 110 is not connected with the image printer 150 and is active alone, the processing goes to a step S107. At the step S107, the digital camera 110 enters general camera mode processing (step S107) in which a shooting operation can be operated.

Then, while the general camera mode processing is being performed at the step S107, the digital camera 110 monitors an output signal from the connection interface 35 every predetermined time and repeatedly checks whether the image printer 150 is connected or not. In this case, if it is determined that the image printer 150 is connected to the digital camera 110, the processing goes to the step S103 immediately.

At the step S103, the camera controller 17 performs predetermined printing processing (processing following a flowchart in FIG. 14) in the camera side. The detail of the camera side printing processing will be described later. Next, the processing goes to a step S104.

At the step S104, the camera controller 17 checks whether the predetermined printing processing ends or not. Here, if it is determined that printing processing ends, the processing goes to a step S105. If it is determined that the printing processing has not ended yet, the processing returns to the step S103 described above, and the subsequent processing is repeated.

At a step S105, the camera controller 17 performs the predetermined charging processing in the camera side. The camera side charging processing is general processing in a conventional digital camera, and the detail is omitted herein. Then, the processing goes to a step S106.

At the step S106, the camera controller 17 monitors the charging control portion 36 and checks whether or not the predetermined charging of the chargeable battery 37 has completed. Here, if it is determined that the chargeable battery 37 has been changed completely, the instruction signal indicating the completion of the charging is transferred to the printer controller 51 of the image printer 150, and the processing including the series of steps ends. If it is determined that the charging has not been completed yet, the processing returns to the step S105, and the following steps will be continued until the charging of the chargeable battery 37 has completed.

Next, the detail of the camera side printing processing (the step S103 in FIG. 13) in the digital camera 110 will be described below with reference to FIG. 14.

As described above., at the step S102 in FIG. 13, if it is determined that the digital camera 110 and the image printer 150 are connected, the camera controller 17 of the digital camera 110 performs the camera side printing processing (the sequence in FIG. 14, that is the step S103 in FIG. 13).

In the beginning of the camera side printing processing, at a step S111 in FIG. 14, the camera controller 17 requests a printer ID to the printer controller 51 through both of the connection interfaces 35 and 55 and both of the connection connectors 34 and 54. In response to this, the printer controller 51 reads a predetermined printer ID from the initial setting value having been recorded in the RON 52 in advance and sends the predetermined printer ID to the camera controller 17 (see a step S161 in FIG. 16). Then, the processing goes to a step S112.

Here, the term, “printer ID” refers to unique information determined so as to identify the kind of the image printer 150 and includes various kinds of information such as a printing resolution (dot/line), a total number of processable lines of image data, color correction data and gamma correction data.

In other words, in the image printing system according to this embodiment, multiple kinds of image printer 150 are connected to a specific digital camera 110 selectively to print an image. Therefore, in order to perform the printing operation, the digital camera 110 must identify the kind of the image printer 150 connected to the digital camera 110 and create image data for printing in accordance with the specification of the image printer 150.

Therefore, when it is determined that the digital camera 110 is connected to an image printer 150, the digital camera 110 obtains the printer ID of the image printer 150 connected to the digital camera 110 in the beginning of the printing processing in order to print an image.

Since this processing is performed, the image printing system can include any combination of the digital camera 110 and the image printer 150 with no problems, and good printed results can be always obtained.

Next, at the step S112, the camera controller 17 searches multiple pieces of image data having recorded in the recording medium 33 installed in the recording medium installing portion 32 through the recording medium interface 31 and obtains information such as information on the total number of pieces of image data and print history information relating to each piece of image data. Then, the processing goes to a step S113.

Here, the term, “print history information” refers to information regarding the print history, that is, information relating to the past condition of use of image data, such as “Printed” information indicating whether given image data was printed by the image printer 150 in the past or not, “Printed Date” information and “Number of Times of Printing” information if the image data was printed, “Re-printing Instruction” information for the case where reprinting is instructed. The print history information is attribute information associated with each image data.

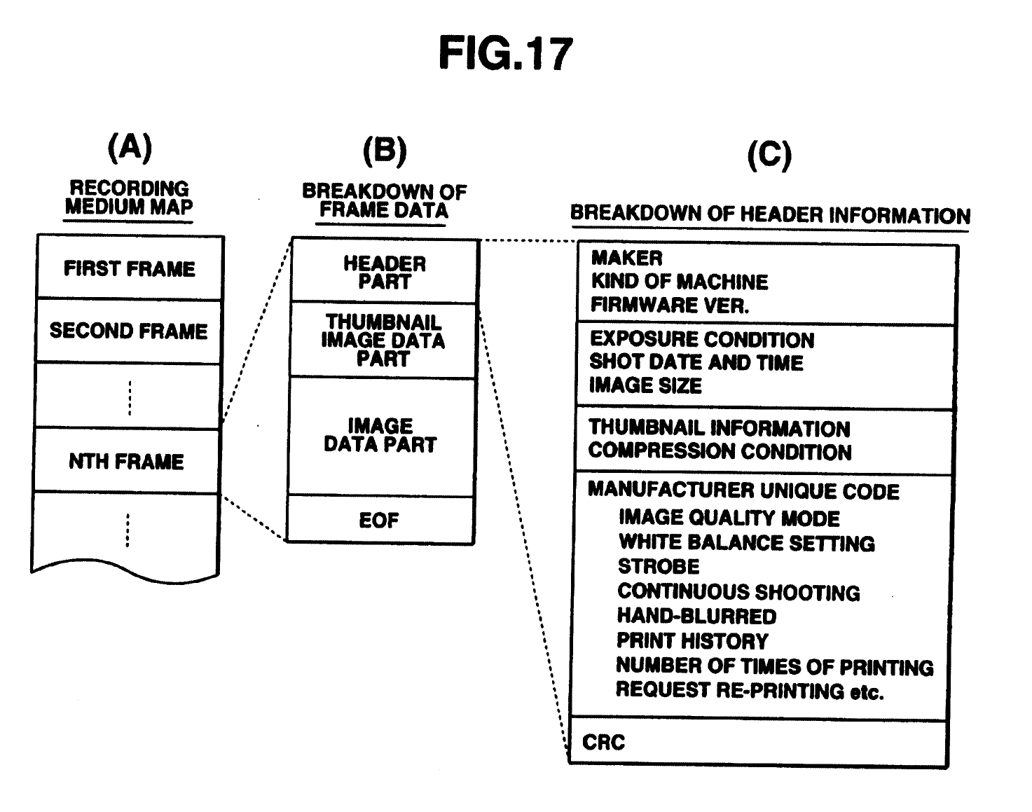

FIG. 17 is a conceptual diagram showing a detail of a data file including image data to be recorded in a recording medium used in the image printing system according to this embodiment.

The recording medium used in the image printing system according to this embodiment stores multiple data files including image data as indicated by (A) in FIG. 17. As indicated by (B) in FIG. 17, each data file has a header portion, a thumbnail image data portion, image data portion, and End-Of-File (EOF) portion. The header portion stores information indicating the beginning of the data file. The thumbnail image data portion stores data of a reduced image of an image represented by the image data included in the data file. The image data portion stores the body of the image data. The EOF portion stores information indicating the end of the data file.

As indicated by (C) in FIG. 17, the header portion stores, in an encoded form, various kinds of information compliant with DPOF standard, for example, including the name of the manufacturer (maker) of the camera and the data when the file was created and also stores unique information such as the print history information.

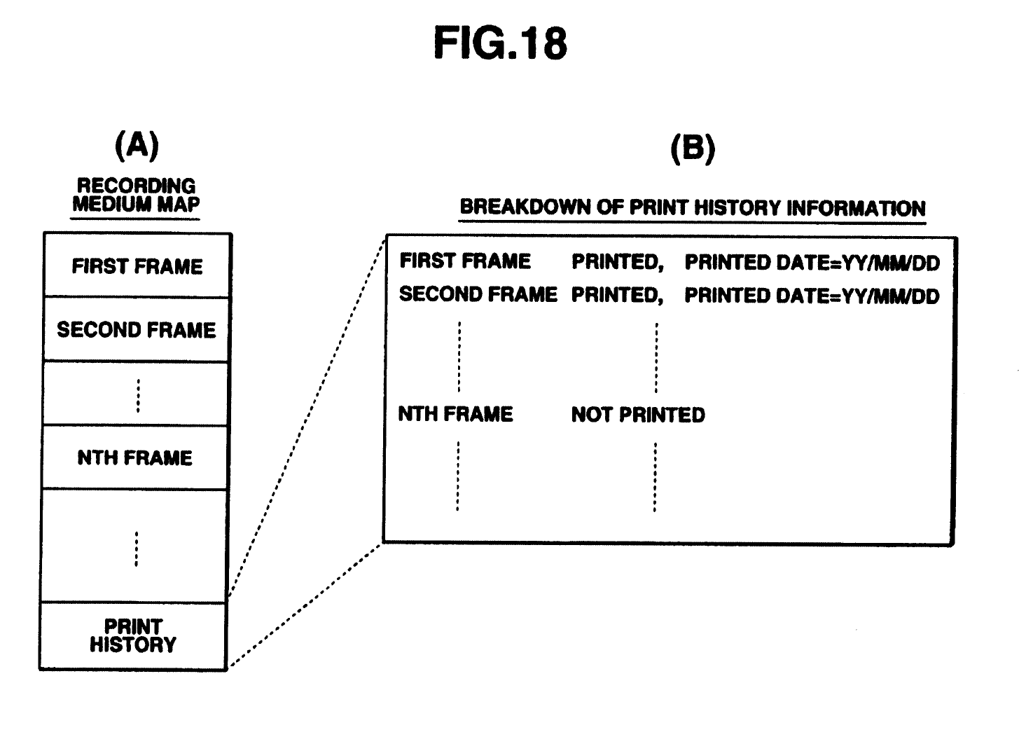

On the other hand, FIG. 18 is a conceptual diagram showing a detail of another example of the data file including image data to be recorded in the recording medium used in the image printing system according to this embodiment.

In this example, the print history information is stored in the recording medium as another data file than the data file including multiple pieces of image data as a single data file (see (A) in FIG. 18). The print history information corresponding to the multiple data file recorded in the recording medium are listed in the single print history information file all together (see (B) in FIG. 18).

The print history information corresponding to each image data is stored in the recording medium when the image data is recorded therein as a data file simultaneously. Every time the image printer prints predetermined image data, the corresponding print history information is updated by the recording medium interface 31 controlled by the camera controller 17. Therefore, in this case, the recording medium interface 31 acts as an update unit for updating print history information.

Referring back to FIG. 14, at the step S113, the camera controller 17 performs setting for specifying an image to be printed based on the information obtained at the step S112. The setting may be for sequentially printing an image, which is not printed at least before the print starting time. Then, the processing goes to a step S114.

At the step S114, the camera controller 17 controls the display apparatus 30 through the display control circuit 29, and the display apparatus 30 is used to display a predetermined printing menu. The printing menu is displayed based on predetermined display information having been recorded in the RON 26 or RAN 27, for example, in advance, and is a display of a guide message prompting an operation for starting printing or conditions set for the printing. For example, the display may be “Press Print Start button” and/or “Image with frame number N will be printed”. Then, the processing goes to a step S115.

Referring back to FIG. 14, at the step S115, the camera controller 17 monitors a predetermined instruction signal, that is, an instruction signals for instructing to start printing (called print start instructing signal hereinafter), from the print start switch 67b in response to the operation on the print start operating member 67B of the image printer 150. Here, the processing waits until the camera controller 17 identifies the print start instructing signal. Once the instructing signal is identified, the processing goes to a step S116.

At the step S116, the camera controller 17 reads a frame of image data from the recording medium 33 installed in the recording medium installing portion 32 through the recording medium interface 31. The read image data is temporarily stored in the memory controller 22. Then, the processing goes to a step S117.

At the step S117, the camera controller 17 controls the display control circuit 29 to perform predetermined signal processing on the image data read at the step S116. The predetermined signal processing is processing for converting the read image data to image data (image data for display) in a form best suitable for displaying the image corresponding to the image data by using the display apparatus 30. Then, the corresponding image is displayed on the display portion of the display apparatus 30 based on the created image signals. Then, the processing goes to a step S118.

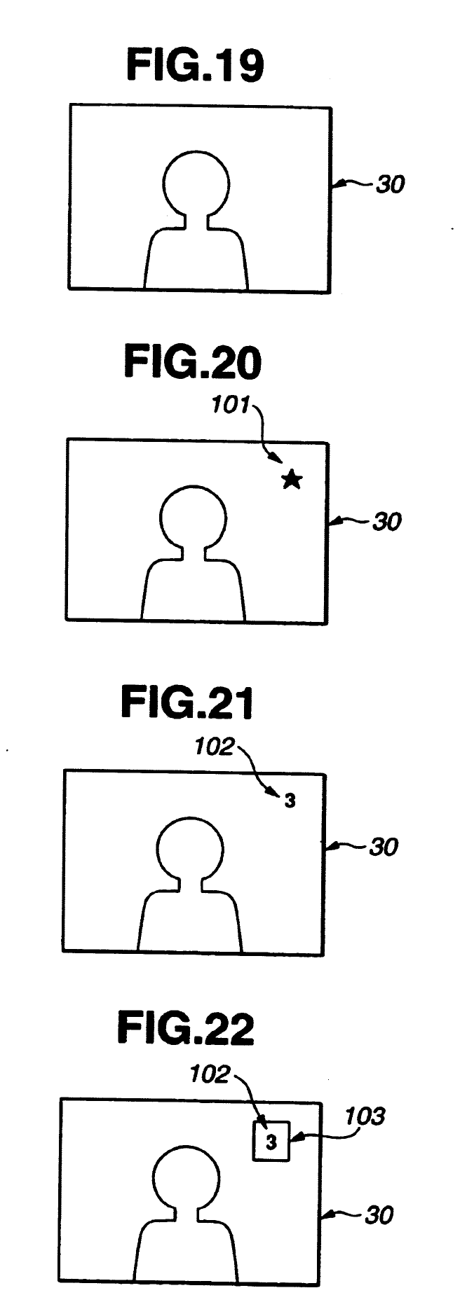

In the image display herein, a predetermined symbol or the like based on print history information relating to a given image is displayed on the image corresponding to image data. FIGS. 19 to 22 illustrate the display forms in this case.

In FIG. 19, a predetermined image is only displayed on the display portion of the display apparatus 30. The display form indicates that the print history information corresponding to given image data has “Printed” information indicating that the image data underwent a printing operation in the past.

In FIG. 20, a predetermined image is displayed on the display portion of the display apparatus 30. In this case, a symbol 101 (star in FIG. 20) indicating “Not-Printed” is displayed at a predetermined position on the predetermined image within the screen. The display form indicates that the print history information corresponding to the image data includes “Not-Printed” information indicating that no printing operations have been performed in the past.

In FIG. 21, a predetermined image is displayed on the display portion of the display apparatus 30. In this case, a symbol 102 (reference numeral [3] in FIG. 21) indicating “the number of times of printing” is displayed at a predetermined position on the predetermined image within the screen. The display form indicates that the print history information corresponding to the image data includes “the number of times of printing” information indicating the number of times of printing operations in the past. The “number of times of printing” information is indicated by using a number. In the example in FIG. 21, the printing processing has been performed three times in the past.

In FIG. 22, a predetermined image is displayed on the display portion of the display apparatus 30. In this case, a symbol 102 (reference numeral [3] in FIG. 22) indicating “the number of times of printing” and a frame symbol 103 around the “number of times of printing” symbol 102 are displayed at a predetermined position on the predetermined image within the screen. The display form indicates that the print history information corresponding to the image data includes “the number of times of printing” information indicating that the printing operation has performed three times in the past and information indicating that the printing is desired in accordance with the manipulation of the re-print button 25E of the operating members 25 of the digital camera 110 by a user (that is, so-called print reservation information). When the re-printing of given image data is instructed through the re-print button 25E, which is a manual operating unit, the image data is printed under the control of the camera controller 17 and the print controller 51 like the other image data which have not been printed before the instruction is given.

Referring back to FIG. 14, at the step S118, the camera controller 17 creates image data for printing by performing predetermined signal processing based on the image data having been read at the step S116 and having been temporarily stored in the memory controller 22. Then, the image data for printing is temporarily stored in the frame memory 23. The signal processing to be implemented here is general signal processing for printing an image based on the image data such as data decompressing processing, color converting processing, gamma setting and line length converting processing. Then, the processing goes to a step S119.

At the step S119, the camera controller 17 performs processing for initializing the set value of a line counter (not shown) in the camera controller 17 itself. The line counter acts as a counter used for transferring image data to be printed to the image printer 150 line by line. Then, the processing waits for an instruction of the request for sending image data for printing (see a step S162 in FIG. 16, which will be described later) from the printer controller 51. When the instruction of the request for sending image data for printing is received, the processing goes to a step S120.

At the step S120, the camera controller 17 reads one line of image data for printing temporarily stored in the frame memory 23 and transfers the one line of image data to the printer controller 51 of the image printer 150 through the connection interface 35 and 55 and the connection connectors 34 and 54. Here, the printer controller 51 receives the transferred data and temporarily stores the received data in the line buffer 53 (see a step S163 in FIG. 16, the detail of which will be described later). Then, the processing goes to a step S121.

At the step S121, the camera controller 17 checks whether the count value of the line counter indicates the final line or not. If it is determined here that the image data transferred at that time is the final line, the processing goers to a step S123. If not, the processing goes to a step S122. At the step S122, subtraction processing is performed on the count value of the line counter, and the processing then returns to the step S120. Then subsequent steps are repeated.

At the step S123, the camera controller 17 performs the subtraction processing on the count value of the frame counter. In other words, by subtracting 1 from the count value of the frame counter here, the information indicating the completion of the printing of the image corresponding to the image data of the first frame is obtained. Then, the processing goes to a step S124.

At the step S124, the camera controller 17 controls the recording medium interface 31 to perform update processing on the print history information in the recording medium 33 installed in the recording medium installing portion 32. After that, the processing goes to the next step S125.

At the step S125, the camera controller 17 checks he count value of the frame counter in order to determine whether the printed image is of the final frame or not. If it is determined here that the printed image is not of the final frame, the processing returns to the step S116. Then, the subsequent steps are repeated until the printing of he final frame has completed. If it is determined here that he printed image is of the final frame, the printing processing having the series of the steps ends, and the processing returns to the sequence in FIG. 13 (return).

As described above, in the image printing system, the chargeable battery 37 of the digital camera 110 is automatically charged after the completion of the printing operation including the series of steps. When the completion of the charging is detected, the power source of the digital camera 110 is controlled to switch off.

Next, the flow of the main operation in the image printer 150 will be described with reference to FIG. 15.

When a user manipulates the printer power source operating member 67A of the image printer 150, an instruction signal indicating that the power source of the image printer 150 is switched to open (ON) from the power source switch 67a in connection thereto. The instruction signal is sent to the printer controller 51. The printer controller 51 receives the instruction signal and performs predetermining initializing processing in the image printer 150 at a step S141 in FIG. 15. Once the initializing processing has completed, the processing goes to the next step S142.

At the step S142, the printer controller 51 checks whether or not the image printer 150 is connected to the digital camera 110. The checking is the same processing as that of the step S112 (see FIG. 13) in the operation sequence of the digital camera. Thus, it is checked whether or not the controllers 17 and 51 of the apparatuses 10 and 50 can communicate through the connection interfaces 34 and 55 by connecting the camera side connection connector 34 and the printer side connection connector 54. Here, the checking is repeated until it is determined that the image printer 150 and the digital camera 110 are connected. If the connection between the apparatuses 10 and 50 is determined, the processing goes to the next step S143.

The power source of the digital camera 110 can have any state here. In other words, the image printer 150 is controlled to start the printing operation and the charging operation once the connection between the image printer 150 and the digital camera 110 is determined, independently from the state of the power source of the digital camera, that is, independently from the switched state of the camera power source operating member 25D.

At the step S143, the printer controller 51 controls the timer 66 to start the time-measuring operation by the timer 66. Then, the processing goes to a step S144.

At the step S144, the printer controller 51 checks whether or not the print start operating member 67B has been pressed. In this step, the printer controller 51 monitors a print start instructing signal from the print start switch 67b in accordance with the manipulation on the print start operating member 67B to identify the instruction signal. Here, if the printer controller 51 cannot identify the print start instruction signal, the processing goes to a step S151.

Then, at the step S151, the printer controller 51 checks whether the set time of the timer 66 has passed or not (time-up). If the time is not up here, the processing returns to the step S144. Then, the subsequent steps are repeated. If the time-up is determined, it is determined that the printing operation will not be performed. Then, the processing goes to a step S148 that is the charging processing.

In the image printing system, when the image printer 150 and the digital camera 110 are connected to each other (step S142), the timer 66 starts to measure time (step S143). In this case, if the timer 66 measures a predetermined set time (time up) without an instruction signal from the print start switch 67b, the charging processing is controlled to start (step S148).

On the other hand, if the printer controller 51 identifies a predetermined print start instruction signal at the step S144, the processing goes to the next step S145.

At the step S145, the printer controller 51 performs predetermined printing processing (the detail of which are shown in the flowchart in FIG. 16) in the printer side. The detail of the printing processing in the printer will be described later. Next, the processing goes to a step S146.

At the step S146, the printer controller 51 checks whether the predetermined printing processing has completed or not. Here, if the printer controller 51 determines the completion of the printing processing, the processing goes to the next step S148. If the printer controller 51 determines that the printing processing has not been completed, the processing goes to a step S147. At the step S147, the printer controller 51 restarts the timer 66, and the processing then returns to the step S145 described above. Then, the step S145 and subsequent steps are repeated.

A little longer time than the time required for printing a frame of image, for example, is set as the set time of the timer here.

At the step S148, the printer controller 51 performs predetermined charging processing (the detail of which is omitted here) in the printer side. Then, the processing goes to the next step S149.

At the step S149, the printer controller 51 checks whether or not the instruction signal indicating the completion of the charging has been transmitted from the camera controller 17. The printer controller 51 waits until the instruction signal is received. When the printer controller 51 determines from the receipt of the instruction signal that the charging to the chargeable battery 37 of the digital camera has completed, the processing goes to the next step S150.

At the step S150, the printer controller 51 controls the direct-current power source control portion 70 to perform processing for shutting off the main power source. Then, the processing having the series of steps ends (return).

Next, the detail of the printer side printing processing (the step S145 in FIG. 15) in the image printer 150 will be described below with reference to FIG. 16.

As described above, when the digital camera 110 and the image printer 150 are connected, and when the printer controller 51 determines that the print start operating member 67B has been manipulated at the step S144 in FIG. 15, the printer controller 51 performs the printer side printing processing (the step S145 in FIG. 15: the sequence in FIG. 16).

In the beginning of the printer side printing processing, at a step S161 in FIG. 16, the printer controller 51 reads a predetermined printer ID from the ROM 52 in response to a request for transmitting the printer ID (see the step S111 in FIG. 14) from the camera controller 17 of the digital camera 110. Then, the printer controller 51 sends the predetermined printer ID to the camera controller 17. Then, the processing goes to the next step S162.

At the step S162, the printer controller 51 sends an instruction for requesting the transmission of image data for printing of the image to be printed to the camera controller 17. In response this, the camera controller 17 transfers one line of the image data for printing to the printer controller 51 at the step S120 in FIG. 14 as described above. Then, the processing goes to a step S163.

At the step S163, the printer controller 51 receives one line of the image data for printing having been transferred from the digital camera 110. Then, the processing goes to a step S164.

At the step S164, the printer controller 51 checks whether or not one line of the image data for printing having received at the step S162 is image data in a normal form, that is, the printer controller 51 performs received-data checking processing on the received one line of image data for printing. Then, the processing goes to a step S165.

Then, at the step S165, the printer controller 51 checks whether or not the communication operation between the image printer 150 and the digital camera 110 has an abnormality, that is, the printer controller 51 performs communication-error checking processing. Here, if the communication error is not identified, and if the result of the data checking at the step S164 is determined as normal, the processing goes to a step S167.

On the other hand, if the communication error is identified at the step S165, or if it is determined that the received data has an abnormality as a result of the data checking at the step S164, the processing goes to a step S166. At the step S166, the printer controller 51 sends to the camera controller 17 an instruction for requesting to send image data again. Then, the processing returns to the step S163, and the step S163 and subsequent steps are repeated.

If the received data has no abnormality and the communication operation does not have an error, and the processing goes to the step S167, the printer controller 51 transfers the received one line of image data for printing to the line buffer 53 at the step S167. Thus, the received data is temporarily recorded therein. Then, the processing goes to a step S168.

At the step S168, the printer controller 51 performs processing for setting a count value of a buffer counter (not shown) within the printer controller 51. The buffer counter is used to count the number of received lines of image data for printing. After that, the processing goes to a step S169.

Next, at the step S169, the printer controller 51 controls the head 63 through the head driving portion 62 to start current-carrying to the head 63 (head current-carrying ON processing). After that, the processing goes to a step S170.

At the step S170, the printer controller 51 checks the current-carrying time to the head 63. After a predetermined time, the processing goes to the next step S171.

At the step S171, the printer controller 51 controls the head 63 through the head driving portion 62 to stop the current-carrying to the head 63 (that is, the current-carrying-off processing). Then, the processing goes to a step S172.

At the step S172, the printer controller 51 subtracts 1 from the count value of the buffer counter. Then, the processing goes to a step S173.

At the step S173, the printer controller 51 controls to drive the ink-ribbon motor 57 through the ribbon driving portion 56. Thus, an amount of ink-ribbon corresponding to the one-line of the image data for printing is transported. Then, the processing goes to a step S174.

At the step S174, the printer controller 51 checks whether the count value of the buffer counter is the count value indicating the last buffer or not. Here, if the printer controller 51 determines that the just printed image data is not the last buffer, the processing goes to a step S175 in preparation for printing the next one line of image data.

Then, at the step S175, the printer controller 51 controls to drive the paper-feeding motor 60 through the paper driving portion 59 and performs paper-feeding processing for moving the print paper 100 by an amount corresponding to one line. Then, the processing returns to the step S162, and an instruction to request for transferring the next one line of image data is sent to the camera controller 17 at the step S162. Then, the subsequent steps are repeated.

On the other hand, if the printer controller 51 determines that the just printed image data is the last buffer at the step S174, it is determined that the printing processing on one predetermined image has completed by this printing processing for one line. Then, the processing goes to a step S176.

Then, at the step S176, the printer controller 51 controls to drive the paper-feeding motor 60 through the paper driving portion 59 and performs paper-ejecting processing for ejecting the print paper 100 to the outside of the image printer 150. Then, the processing goes to a step S177.

Next, at the step S177, the printer controller 51 checks whether the just printed image data is the image data of the last frame or not. Here, if the printer controller 51 determines that it is not the image data of the last frame, the processing returns to the step S162. At the step S162, the printer controller sends to the camera controller 17 an instruction for requesting to transfer image data of the frame to be printed next. Then, the subsequent steps are repeated.

At the step S177, if the printer controller 51 determines that the just printed image data is the image data of the last frame, the processing including the series of steps ends (return).

As described above, according to this embodiment, a user does not have to particularly perform time-consuming setting operation, for example, in order to print a desired image. A user only needs to mount the digital camera 110 including he recording medium 33 storing shot image data at a predetermined position, that is, the mount portion 50d of the image printer 150 and then to manipulate the print start operating member 67B of the image printer 150, which is an extremely simple operation. Thus, the printing result of the desired image can be obtained immediately.

In other words, print history information corresponding to each image data may be recorded. Then, in order to print the image, the printing can be controlled based on the print history information. Thus, the labor for the operation to be performed by a user can be saved. After the printing, the print history information is updated every time. Thus, the latest print history information can be provided together with the corresponding image data. Therefore, when a different kind of image printer is used, printing processing can be always performed based on the latest print history information.

The printing processing is controlled based on various kinds of information recorded in the recording medium 33. Thus, no additional components and changes are required, and a desired effect can be obtained easily. Therefore, the process in the production does not have to be changed, which contributes to the reduction of the production costs.

In this embodiment, the recording medium 33 is removable, but the same effect can be obtained when the recording medium 33 is built in the camera. Furthermore, the chargeable battery 37 may be removable or may be built in the camera.

As described above, according to the second embodiment of the invention, the operations to be performed by a user are simplified for printing an image based on the image data shot by using a digital camera, and a desired image can be printed based on the desired image data easily and fast. Thus, the image printing system having better operability and allowing the reduction of the production cost can be provided.

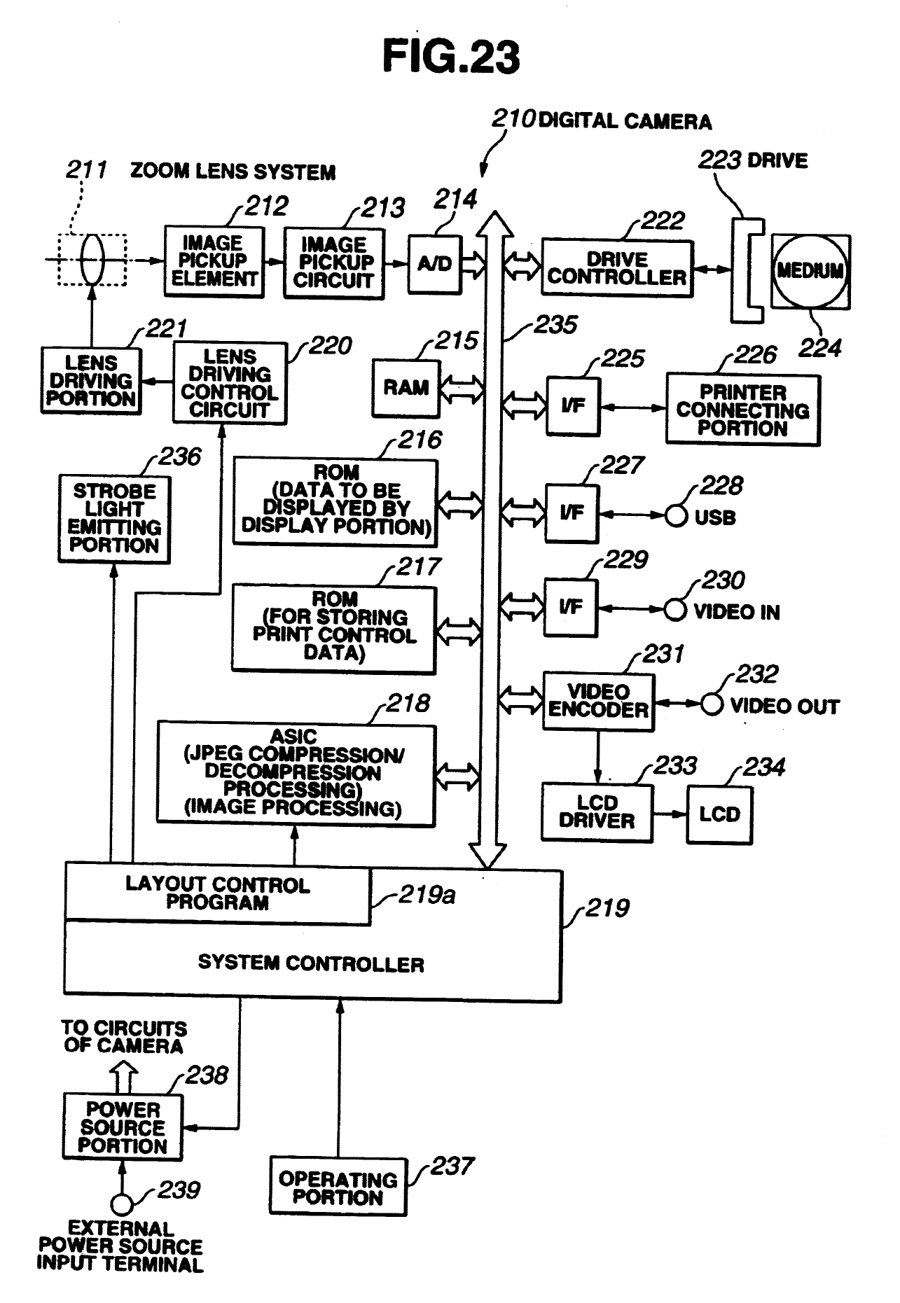

FIG. 23 shows a block diagram of a digital camera in a printing system according to a third embodiment of the invention.

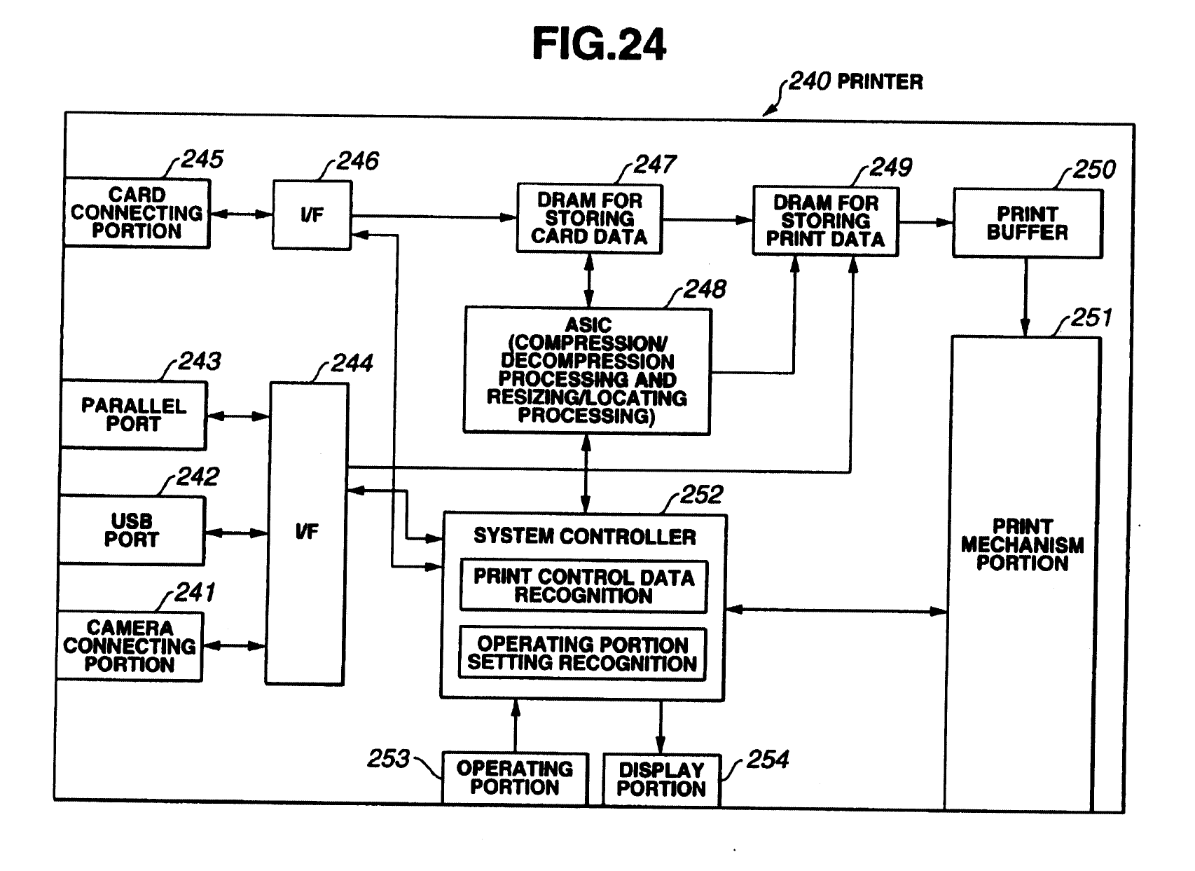

In FIG. 23, the digital camera 210 includes a zoom-lens system 211, an image pickup element 212, an image pickup circuit 213, an A/D converter 214, a RAM 215 as a frame buffer memory, a ROM 216, a RON 217, an Application Specified IC (ASIC, which is an IC designed and manufactured for a specific application) 218, a system controller 219 as a control unit, a lens driving control circuit 220, a lens driving portion 221, a drive controller 222 for media such as a disk and a card, a drive 223, such as a card slot, for various media, a recording medium 224, an interface (I/F hereinafter) 225, a printer connecting portion 226, an I/F 227, a USB input/output terminal 228, an I/F 229, a video input terminal 230, a video encoder 231 as a video output circuit, a video output terminal 232, an LCD driver 233, an image display liquid crystal panel (LCD, hereinafter) 234 as a display portion, a data bus 235, a strobe light emitting portion 236, an operating portion 237, a power source portion 238, and an external power source input terminal 239. The ROM 216 stores layout images as display-portion displaying data. The ROM 217 is a memory portion for storing print control data (data corresponding to operation information of a layout selecting operation and image selecting operation by a user). The ASIC 218 is an image processing IC. The recording medium 224 may be a memory disk, a memory card or the like. The I/P 225 exchanges data with a printer (see FIG. 24). The I/F 227 communicates with USB (standing for Universal Serial Bus, which is the serial interface standard)-compliant external equipment. The I/F 229 is used for inputting video signals from an external video equipment. Video signals are input (Video IN) to the video input terminal 230. Video signals are output (Video Out) from the video output terminal 232. The data bus 235 connects the system controller 219 and digital circuits within the digital camera. The operating portion 237 is used for performing various operations including a layout selection and image selection. In FIG. 23, the recording medium 224 can be removably attached to the digital camera 210.

In this construction, a print setting display on the LCD 234 and the operating portion 237 including operating buttons corresponding to the display establish a selection operation function portion. The ROM 217 and/or the recording medium 224 establish an information recording carrier. The drive controller 222 and the drive 223 establish a print control data storage function portion.

The constructions of the components will be described.

The zoom lens system 211 optically enlarges and forms an object image, and the zoom range is controlled by the lens driving portion 221.

The image pickup element 212 optoelectronically transduces an object image formed on the image pickup surface by the zoom lens system 211 and generates and outputs electric image signals (analog signals).

The image pickup circuit 213 controls the image pickup element 212 and performs and outputs required processing on analog signals output from the image pickup element 212. The A/D converter 214 converts analog signals output from the image pickup circuit 213 to digital signals.

The RAM 215 temporarily stores image data converted by the A/D converter 214, temporarily stores image data read from the recording medium 224 or temporarily stores data read from the ROM 216 to be displayed by the display portion.

The ROM 216 stores a laid-out image (layout image) to be printed, which is one of the characteristics of the invention.

The ROM 217 stores print control data corresponding to operation information of the layout selection operation and image selection operation, which is one of the characteristics of the invention. In other words, the ROM 217 stores data indicating which image is located at which position in which layout.

The ASIC 218 for image processing performs various kinds of image processing on image data stored in the RAM 215 under the control of the system controller 219, which will be described later. The ASIC 218 performs JPEG compression and JPEG decompression on image data to be recorded in and read from the recording medium 224, respectively, which will be described later.

The lens driving control circuit 220 controls the lens driving portion 221, which will be described later, for zooming and/or auto-focusing under the control of the system controller 219. The lens driving portion 211 drives a zoom lens and/or focus lens included in the zoom lens system 211 under the control of the lens driving control circuit 220.

The drive controller 222 controls to record image data compressed in JPEG by the ASIC 219 in the recording medium 224, which will be described later, or controls to read image data recorded in the recording medium 224.

The drive 223 is electrically connected to the recording medium 224 such that the drive 223 can exchange signals with the drive controller 222.

The recording medium 224 is a non-volatile recording medium in a card form, for example, which is removably connected to the drive 223. For example, the recording medium 224 may be a flash memory such as a Smart Media (R) and a Compact Flash (R).

The I/F 225 exchanges signals with the printer under the control of the system controller 219. The printer connecting portion 226 is a contact or a connection cord terminal electrically connecting to the camera connection portion 241 (in FIG. 24). The printer connecting portion 226 is connected with the camera connecting portion 241 in FIG. 24 so as to exchange signals with the printer 240.

The I/F 227 exchanges signals with a USB-compliant external equipment under the control of the system controller 219. The input/output terminal 228 is connected to the USB-compliant external equipment through a connection cord, for example, so as to allow the exchanges of signals with the I/F 227.

The I/F 229 is used to input video signals from an external video equipment having a video output terminal under the control of the system controller 219. The input terminal 230 is connected to an external video equipment such as a TV receiver and a VTR through a connection cord, for example, so as to allow the input of video signals (Video IN) to the I/F 229.

The video encoder 231 outputs an image for LCD display in frame based on shot image data stored in the RAN 215 and outputs an image for LCD display in one frame for playing an image after shooting or recording. The video encoder 231 can also output video signals (Video OUT) to external video equipment, not shown, connected to the video output terminal 232.

The LCD driver 233 supplies an image for LCD display in frame from the video encoder 231 to the LCD 234 together with a clock for proving the display.

The LCD 234 is included in the display portion for receiving an output of the video encoder 231 and displaying an image and/or information relating to the digital camera 210.

The strobe light emitting portion 236 emits illumination light under the control of the system controller 219 when the intensity of an object is low and/or when an object is back-lighted.

The operating portion 237 includes a power-source ON/OFF unit, light-exposure starting unit (also called release unit or trigger unit), frame advancing unit, image-display ON/OFF unit and further a unit, which is one of the characteristics of the invention, for performing a layout selection operation and an image selection operation (which will be described later) to be manipulated by a user.

The power source portion 238 supplies power sources to components within the digital camera 210. The external power source input terminal 239 supplies power to the power source portion 238 when the external power source input terminal 239 is connected to an external power source, not shown.

The system controller 219 entirely controls the digital camera 210 including the above-described components. In order to shoot or record, the system controller 219 performs display processing in response to the instruction from the operating portion 237 and controls the ASIC 218, for example, to perform recording processing. On the other hand, the system controller 219 controls to read out and display image data recorded in the recording medium in the digital camera 210. Furthermore, the system controller 219 has a layout control program 219a, which is a characteristic of the invention. In the print setting mode, the system controller 219 outputs print control data corresponding to a layout selection operation and image selection operation to store the print control data in the ROM 217 and/or to store a layout image in the ROM 216.

The layout control program 219a controls the creation, recording, erasing of print control data and the storage of a layout image in accordance with the layout selection operation and image selection operation by a user. Multiple (for example, three) layout can be selected from multiple kinds of layout. In this case, after one layout is selected and an image to be arranged in the layout is selected, the layout and the image to be arranged are registered as “Print 1”. After a second layout is selected and an image to be arranged in the layout is selected, the layout and the image to be arranged are registered as “Print 2”. After a third layout is selected and an image to be arranged in the layout is selected, the layout and the image to be arranged are registered as “Print 3”.

An image file shot by the digital camera 210 has a tag-structure, and information such as the name of file, shooting date, and shooting conditions including the iris and shutter speed are written in the tag when the image is recorded.

The layout control program 219a stores the registered data in the header part of the image file. Alternatively, the layout control program 219a stores the registered data in a file set for storing this kind of management data in a recording medium or in a memory portion within the camera. The data to be registered in the image file includes (1) a registration number (one of Print 1, 2 and 3), (2) a layout selected from multiple layout samples and (3) a position corresponding to the image file in the selected layout (or positions of images in the layout when multiple images are located separately).

The operating member 237 includes a power source button, a frame-advance button, a display ON/OFF button, a release button for performing a shooting operation, a menu button 341 for displaying a menu relating to the setting of the digital camera 210 on the LCD 234 for image display, a cross button 342 for moving a selectable item within the displayed menu, and a check button (OK button) 343 for confirming a selected item.

Next, a printer operatively connected with the digital camera 210 will be described.

FIG. 24 shows a block diagram of the printer in the printing system according to the third embodiment of the invention.

In FIG. 24, the printer 240 includes a camera connecting portion 241, a USB port 242, a parallel port 243, an interface (I/F hereinafter) for connection ports 241 to 243, a card connecting portion 245, an I/F 246 for card connection, a DRAM 247 for storing card data, an ASIC 248 as an image processing IC, a DRAM 249 for storing print data, a print buffer 250, a print mechanism portion 251, a system controller 252 as a control unit, an operating portion 253, and a display portion 254. In this construction, a setting operation function portion includes a print setting display (that is the indication including a number of sheets to be printed, paper size, type of paper and layout form) and the indication of an input key corresponding to the display, which are manipulated through an input key of the operating portion 253 and/or a touch panel mounted to the display portion 254. The touch panel is an input apparatus mounted on the front surface of the display such as a liquid crystal panel, and the displayed button can be pressed on the display to input in a dialog manner with the screen.

The constructions of the components will be described.

The camera connecting portion 241 is a contact or connection cord terminal for electrically connecting to the printer connecting portion 226 of the digital camera 210.

The USB port 242 is used for the USB connection with a USB-compliant equipment, such as a personal computer.

The parallel port 243 is used for the parallel connection with an equipment, such as a personal computer, allowing the parallel transmission such as Centronics, which is a de facto standard as a connection interface for a printer.

The I/F 244 supplies image data received from the digital camera 210 or a personal computer through the camera connecting portion 241, USB port 242, or parallel port 243 to the DRAM 249 for print data storage under the control of the system controller 252 and supplies print control data to the system controller.

The recording medium 224 such as a Smart Media (R) and a Compact Flash (R) is inserted to and is electrically connected with the card connecting portion 245.

The I/F 246 supplies image data (line data) received from the recording medium 224 through the card connecting portion 245 to the DRAM 247 for card data storage under the control of the system controller 252 and supplies print control data to the system controller.

The ASIC 248 for image processing performs various kinds of image processing on image data stored in the DRAM 247 for card data storage under the control of the system controller 252, which will be described later, and performs processing for compression and decompression and processing for resizing and positioning.

The DRAM 249 for print data storage stores image data for printing read from the DRAM 247 for card data storage and/or image data for printing received from the digital camera 210 through the I/F 244.

The print buffer 250 stores and outputs, line by line, image data for printing read from the DRAM 249 for print data storage to the print mechanism portion 251.

The print mechanism portion 251 includes a head control portion, a head, a paper-carrying control portion and a paper carrying mechanism. The head control portion uses image data stored in the print buffer 250 to control the operation of the head, which will be described later, under the control of the system controller 252, which will be described later. The head heats each heat-producing element arranged in accordance with one line of pixels and thermally transfers from an ink ribbon, which will be described later, to paper under the control of the head control portion. The paper-carrying control portion controls the paper to be delivered in synchronous with the thermal transfer by the head and with the carrying of the ink ribbon. The paper carrying mechanism comprises a motor and a roller and carries the paper under the control of the paper-carrying control portion. Paper for printing can be refilled in the print mechanism portion 251 as required, and an ink cartridge accommodating an ink-ribbon for transferring image in some colors through the head can be exchangeably attached to the print mechanism portion 251.

The system controller 252 has a mechanism for controlling the entire printer 240 including the above-described circuits and recognizes operations including a number-of-sheets setting operation for setting a desired number of sheets to be printed. Furthermore the system controller 252 recognizes print control data and the set number of sheets to be printed corresponding to the operation recognized by the digital camera, the operation including a layout selection operation for selecting a desired print layout in the compliant digital camera side and an image selecting operation for selecting image data to be printed from image data stored in the applied recording medium. Then, the system controller 252 controls to print the image based on the recognition. In addition to the number of sheets to be printed, the system controller 252 can recognize the paper size, paper type and layout form set in the operating portion 253 in the same manner.

Alternatively, the system controller 252 has a function for controlling the entire printer 240 including the above-described circuits and recognizes operations including an operation for selecting data relating to one settings among data set in the compliant digital camera and stored in the recording medium as print control data and an operation for setting a desired number of sheets to be printed. The print control data represents multiple types of setting relating to combinations of print layout and respective images to be printed. Furthermore, the system controller recognizes the setting selected by the operation and the set number of sheets to be printed and controls to print an image based on the recognition.

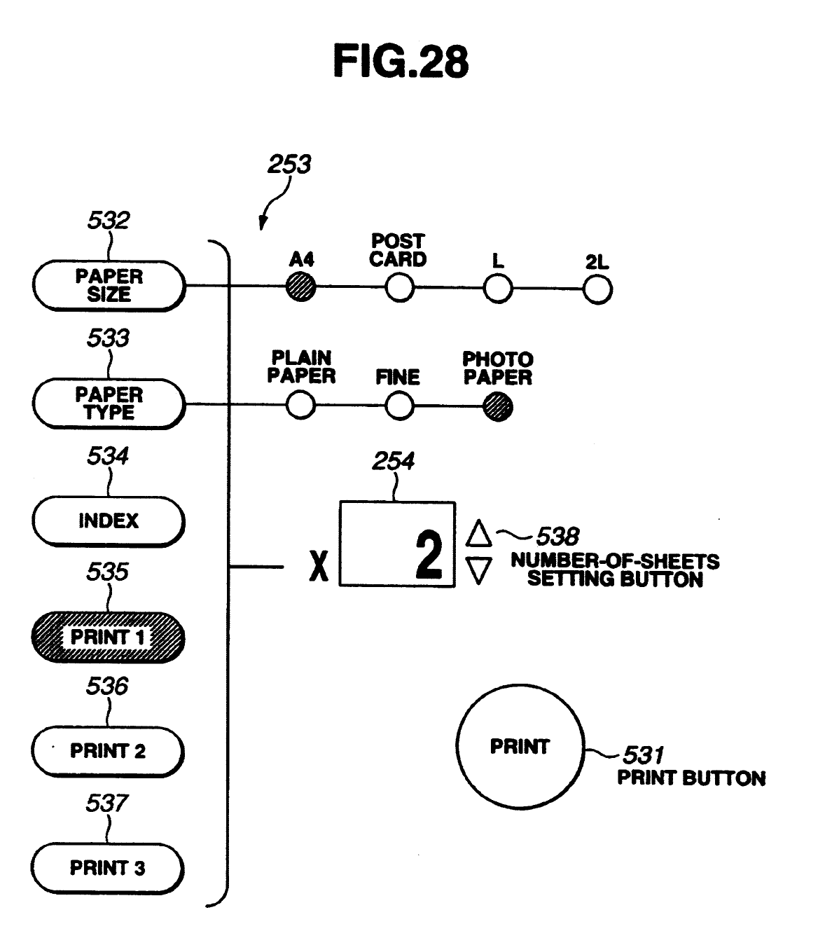

The operating portion 253 is used by a user to implement various operations of the printer 240. The operating portion 253 includes a number-of-sheets setting button 538 and a print button 531, which is a print start operating member for instructing the start of the print operation (see FIG. 28). Furthermore, the operating portion 253 has setting buttons for the paper size, paper type, index print and Prints 1, 2 and 3.

The display portion 254 is a liquid crystal display, for example, and displays the number of sheets to be printed set by using the number-of-sheets setting button 538 in a dot-matrix number form.

The printer 240 includes a power source portion, not shown, and the power source portion supplies power source to the components in the printer 240. The power source portion is further connected to an external power source input terminal so as to supply power to the power source portion when the power source portion is connected to an external power source.

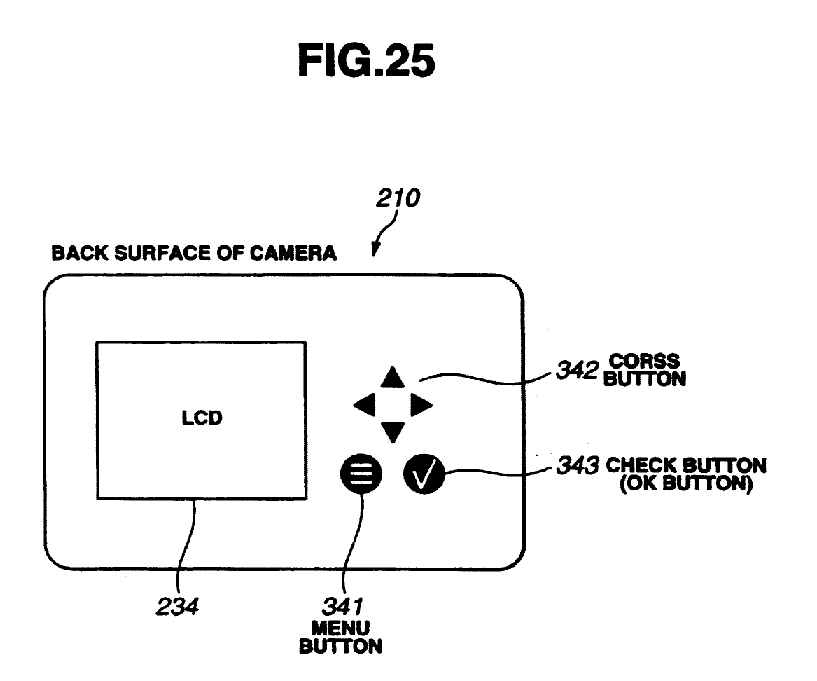

FIG. 25 shows a back view of the digital camera 210. A display surface of the LCD 234 is provided on the back of the camera, and at least the menu button 341, the cross button 342 and the check button (OK button) 343 are provided near the display surface. The menu button 341 is used for displaying a menu screen. The cross button 342 is used for moving a cursor, for selecting a desired item from the menu screen, vertically and horizontally on the menu screen. The check button 343 is used for confirming the selected item. The other power source button and/or release button are provided on the side of the camera.

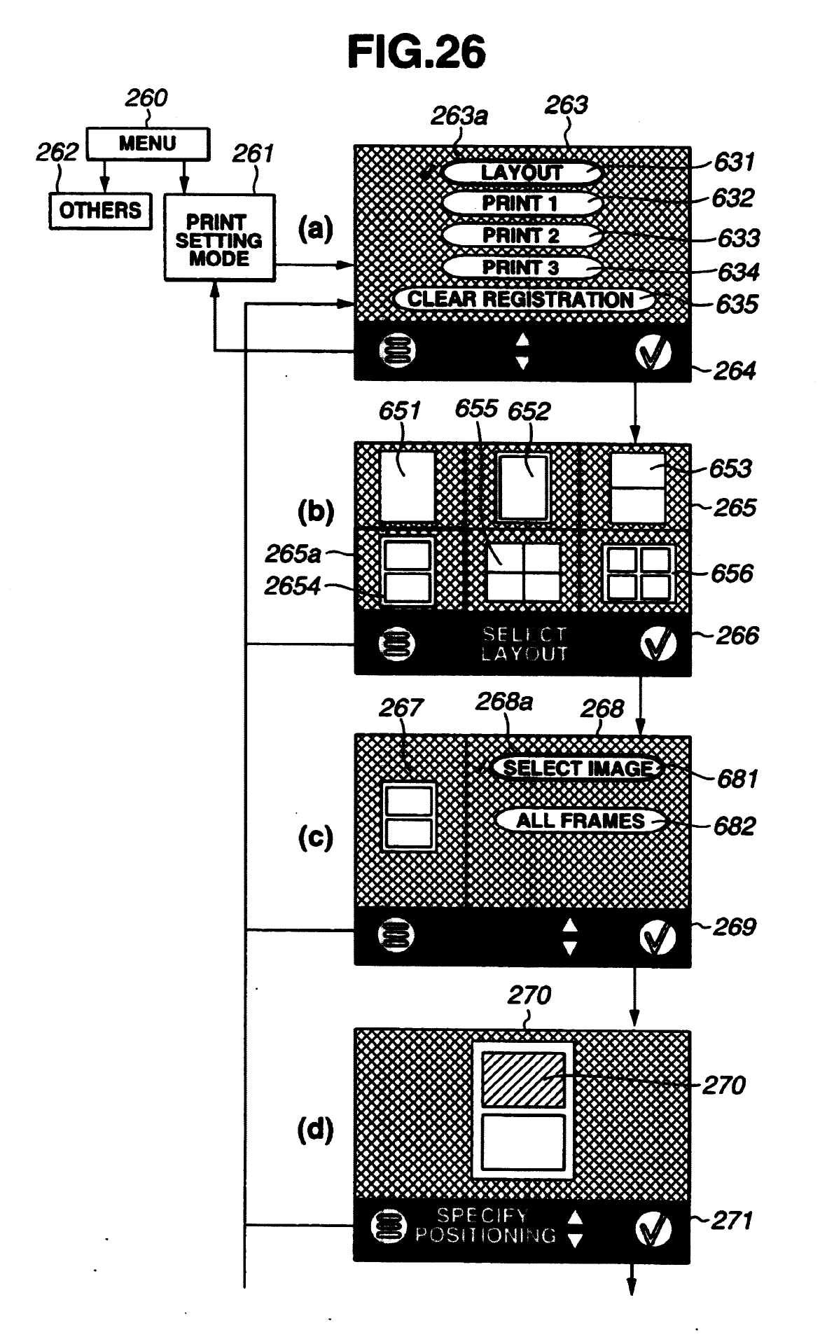

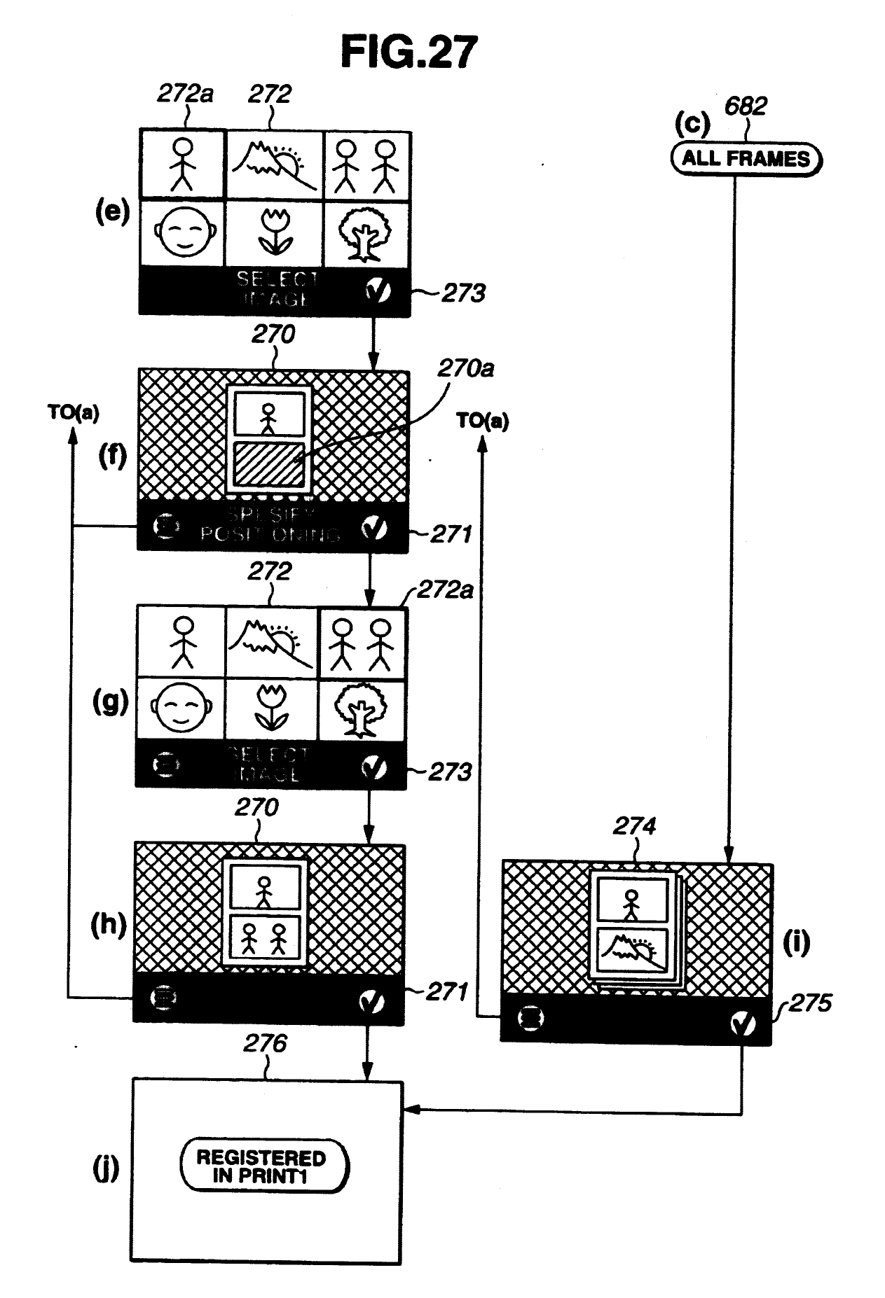

FIGS. 26 and 27 show flowcharts of setting operations in a print setting mode, which is a characteristic of the invention, from menu items displayed when the menu button 341 shown in FIG. 25 is pressed. FIGS. 26 and 27 are originally one diagram but are divided into two diagrams because of the limited space of paper.

The items on the menu 260 displayed on the menu screen includes a “print setting mode” item 261 according to the invention and the other various selectable items 262.

First of all, the “Print setting mode” item 261 is selected by using the cross button 342 from the multiple menu items and is confirmed by using the check button 343. Then, a list display 263 of print setting modes having multiple (five in the figure) choices as shown in (a) in FIG. 26, a frame indication 263a, which is a movable cursor for selecting one of the multiple choices, and a bar indication (displayed in black in the figure) 264 including a mark indication (for prompting a selecting operation) indicating a currently selectable operation button are displayed on the screen of the LCD 234.

The list display 263 of choices includes, for example, five choices such as “LAYOUT” 631, “PRINT 1” 632, “PRINT 2” 633, “PRINT 3” 634 and “CLEAR REGISTRATION” 635. On the screen shown in (a) in FIG. 26, when the menu button 341 is pressed, the display returns to the menu screen displaying the menu items 261 and 262.

Next, the frame indication 63a as a cursor is moved to “LAYOUT” 631 among multiple choices shown in (a) in FIG. 26 by using the cross button 342, and the choice is confirmed by using the check button 343. Then, a list display 265 of multiple (six in the figure) layouts as layout forms indicated by (b) in FIG. 26, a frame indication 265a as a movable cursor for selecting one of them, and a bar indication (displayed in black in the figure) 266 including indication “LAYOUT SELECTION” indicating the current state and mark indications as selectable operating button are displayed on the screen of the LCD 234.

In the layout list display 265, multiple (six in the figure) layout forms are displayed such as a One-Image-Without-Frame 651, a One-Image-With-Frame 652, a Two-Images-Without-Frame 653, a Two-Images-With-Frame 654, a Four-Images-Without-Frame 655, and a Four-Images-With-Frame 656, for example.

When the list display 265 indicted by (b) in FIG. 26 is displayed, and the frame indication 265a as a cursor is set at the Two-Images-With-Frame 654, for example, among he layout forms by using the cross button 342, and when the check button 343 is then pressed, the display shows that the layout form, Two-Images-With-Frame 654, is selected as indicated by (c) in FIG. 26. Then, an item for prompting to select one of “Select Image” and “All Frames” appears on the display. The display includes a screen divided into two. The left side is a screen 67 indicating the two-images layout form 654 while the right side is a screen 268 having the item “Select Image” 681 indicating that a specific one image can be selected for each frame of the two-image layout form and an item “All Frames” 682 allowing the display of multiple two-image layouts combining images of two frames of all shot frames. The reference numeral 268a indicates a frame indication as a cursor for selection. In (c) in FIG. 26, the bar indication 269 only includes mark indications (which are marks of the menu button 341, the up-down key of the cross button 342 and the check button 343). (c) in FIG. 26 shows a state where the frame indication 268a as a cursor is set at “Select Image” by operating-the cross button 342.

When the check button 343 is pressed under the condition shown in (c) in FIG. 26, a screen 270 and a bar indication (displayed in black in the Figure) 271 are displayed on the screen of the LCD 234 as shown in (d) in FIG. 26. The screen 270 includes a specific-color indication (shaded in the figure) 270a as a cursor for prompting the image selection on the upper frame (position) in the TWO-IMAGE-WITH FRAME 654. The bar indication 271 includes an indication, “SET LAYOUT” indicating the current screen state and mark indications (for prompting a selection operation) of selectable operation buttons.

When the check button 343 is pressed under the condition shown in (d) in FIG. 26, a screen for image selection shown in (e) in FIG. 27 is displayed for setting the image to be placed on the upper frame (position) indicated by the cursor.

A list display 272, a frame indication 272a and a bar indication (displayed in black in the figure) 273 are displayed on the screen shown in (e) in FIG. 27 of the LCD 234. The list display 272 includes multiple (six in the figure) images to be selected. The frame indication 272a is movable as a cursor for selecting an image on the list display 272. The bar indication 273 includes an indication “SELECT IMAGE” indicating the current screen state and mark indications of selectable operation buttons.

When the check button 343 is pressed under the condition where the image at the upper left corner is selected in the frame indication 272a as shown in (e) in FIG. 27, the screen shown in (f) in FIG. 27 is displayed.

A screen 270 and a bar indication (displayed in black in the Figure) 271 are displayed on the screen shown in (f) in FIG. 27 of the LCD 234. The screen 270 includes an indication of the selected image on the upper frame (position) in the TWO-IMAGE-WITH FRAME 654 and a specific-color indication (shaded in the figure) 270a as a cursor for prompting the image selection to the lower frame (position). The bar indication 271 includes an indication, “SET LAYOUT”, indicating the current screen state and mark indications (for prompting a selection operation) of selectable operation buttons.

When the check button 343 is pressed under the condition shown in (f) in FIG. 27, a screen for image selection shown in (g) in FIG. 27 is displayed for setting the image to be placed on the lower frame (position) indicated by the cursor.

The screen shown in (g) in FIG. 27 is the same as the screen shown in (e) in FIG. 27. A list display 272, a frame indication 272a and a bar indication (displayed in black in the figure) 273 are displayed on the screen shown in (g) in FIG. 27 of the LCD 234. The list display 272 includes multiple (six in the figure) images to be selected. The frame indication 272a is movable as a cursor for selecting an image on the list display 72. The bar indication 273 includes an indication “SELECT IMAGE” indicating the current screen state and mark indications of selectable operation buttons.

When the check button 343 is pressed under the condition where the image at the upper right corner is selected in the frame indication 272a as shown in (g) in FIG. 27, the screen shown in (h) in FIG. 27 is displayed.

A screen 270 and a bar indication (displayed in black in the Figure) 271 are displayed on the screen shown in (h) in FIG. 27 of the LCD 234. The screen 270 includes a display of the selected image on the upper frame (position) and display of the selected image on the lower frame (position) in the TWO-IMAGE-WITH FRAME 654. The bar indication 271 includes mark indications (for prompting a selection operation) of selectable operation buttons.

When the check button 343 is pressed on the preview screen on which images are arranged as shown in (h) in FIG. 27, the layout for two-image with a frame like the screen 270 in (h) in FIG. 27 and the arranged images are registered as “Print 1”. At the same time, a message, “Registered in (Print 1)” is displayed on the screen as shown in (j) in FIG. 27.

Alternatively, when the menu button 341 is pressed on the preview screen on which images are arranged as shown in (h) in FIG. 27, the preview screen in (h) in FIG. 27) is cancelled, and the display returns to the selecting operation screen (as shown in (a) in FIG. 26) in the print setting mode.

On the other hand, when the “ALL FRAMES” 682 is selected by using the cross button 342 on the screen 268 as shown in (c) in FIG. 26 in this flow, and when the check button 343 is then pressed, the screen shown in (i) in FIG. 27 is displayed.

Multiple pairs of two of all shot images arranged vertically in a shooting order, for example, are formed for the TWO-IMAGE-WITH-FRAME layout 654 are displayed on the screen shown in (i) in FIG. 27. A screen 274 and a bar indication (displayed in black in the figure) 275 are displayed on the screen of the LCD 234. The screen 274 includes overlapping multiple pairs of layout images. The bar indication 275 includes mark indications (for prompting a selecting operation) of selectable operation buttons.

When the check button 343 is pressed on the preview screen on which images are arranged as shown in (i) in FIG. 27, the overlapping multiple pairs of layout images for two-image with a frame as shown in (i) in FIG. 27 are registered as “Print 1”. At the same time, a message, “Registered in (Print 1)” is displayed on the screen as shown in (j) in FIG. 27.

Alternatively, when the menu button 341 is pressed on the preview screen on which overlapping multiple pairs of layout images are arranged as shown in (i) in FIG. 27, the preview screen in (i) in FIG. 27 is cancelled, and the display returns to the selecting operation screen (as shown in (a) in FIG. 26) in the print setting mode.

In the flow shown in (a) in FIG. 26 to (i) in FIG. 27, every time the check button 343 is pressed in accordance with the mark indication (for prompting an operation for selecting the check button) shown on the bar indication (displayed in black in the figure) on each of the step screens, the display moves to the next step screen sequentially. In the flow shown in (a) in FIG. 26 to (i) in FIG. 27, every time the menu button 341 is pressed in accordance with the mark indication (for prompting an operation for selecting the menu button) shown on the bar indication (displayed in black in the figure) on each of the screens shown in (b) in FIG. 26 to (d) in FIG. 26, (f) in FIG. 27, (h) in FIG. 27 and (i) in FIG. 27, the display returns to the selecting operation screen in the print setting mode as shown in (a) in FIG. 26. Thus, a consistent operation result can be obtained in accordance with the operation button.

After the display of the message “Registered in (Print 1)” as shown in (j) in FIG. 27, the display returns to the selecting operation screen in the print setting mode in (a) in FIG. 26 after a certain period of time. Then, the subsequent “Print 2” and “Print 3” can be registered sequentially.

Alternatively, after the display of the message “Registered in (Print 1)” as shown in (j) in FIG. 27, and after a certain period of time, the display can return to the normal playback screen, such as (1) the display of one image last and (2) the divisional display of the screen divided into nine boxes showing nine images from the latest image. In this case, in order to register the next “Print 2”, the menu button 341 is pressed to display the menu screen. Then, the processing for the print setting mode shown in FIG. 26 and the subsequent processing must be performed sequentially. After a proper layout and the layout image are registered in each of all registration numbers of “Print 1”, “Print 2” and “Print 3” or at least one of the registration numbers, the print setting mode can be selected and be confirmed from the menu screen. Thus, the screen in (a) in FIG. 26 is displayed. Then, once one of the “Print 1”, “Print 2”1 and “Print 3” is selected and is confirmed, the registration information (that is, the layout image” is displayed as shown in (h) in FIG. 27 if the layout and the layout image have been registered. If nothing has been registered, a message, “Nothing has been registered” may be displayed. When “CLEAR REGISTRATION” is selected and is confirmed on the screen in (a) in FIG. 26, the data registered in all of the registration numbers including “Print 1”, “Print 2” and “Print 3” are cleared (initialized).

In this embodiment, the registration into the “Print 1”, “Print 2” and “Print 3” are performed on the screen in (a) in FIG. 26. However, the registration into “Print 1”, “Print 2” and “print 3” may be performed separately. When the “CLEAR REGISTRATION” is selected and is determined on the screen in (a) shown in FIG. 26, the information registered in “Print 1”, “Print 2” and “Print 3” is all erased (initialized). However, the information registered in each of “Print 1”, “Print 2” and “Print 3” may be erased separately.

Next, a case will be described where an image shot in this way and the layout image registered in at least one of “Print 1”, “Print 2” and “Print 3” are printed.

According to one aspect of this embodiment, the print setting mode is selected from the menu screen on the LCD 234, which is a display portion in the digital camera 210 side, and one of “Print 1”, “Print 2”, “Print 3” and so on is selected and is confirmed from print setting mode screen. Then, the layout image registered for the selected one can be previewed (for checking before printing). Here, the selection state in the printer side must be synchronized also. In other words, when “Print 2” is selected in the camera, “Print 2” is automatically selected in the printer side. In this aspect, the preview can be displayed in response to an operation on the digital camera 210 side itself. When the print button 531 (see FIG. 28) is pressed in the printer 240 side while the preview is being displayed, the registered layout image is started to print.

According to a second aspect of this embodiment, one, for example, the “Print 1” button, of the “Print 1”, “Print 2” and “Print 3” buttons provided in the printer 240, which can exchange signals with the digital camera is pressed, the LCD 234, which is a display portion of the digital camera 210, can display the preview of an image in the print layout corresponding to “Print 1” under the control of the system controller 219 in response to the receipt of a signal indicating the selection corresponding to “Print 1” is performed in the digital camera 210 side. In other words, in response to the operation in the printer 240 side, the preview can be displayed on the display portion of the camera 210. When the print button 531 (see FIG. 28) in the printer 40 side is pressed while the preview is being displayed, the printing using the registered layout image is started.

FIG. 28 is a plan view showing operation buttons 531 to 538 in the operating portion 53 of the printer 240, an LED for displaying a selection result and an LCD display portion 254.

The operation surface shown in FIG. 28 has a print button 531, a paper size selection button 532, a paper type selection button 533, an index (list) print button 534, a print button 535, a print button 536, a print button 537, an up-down button 538, an LCD display portion 254, four LED's for paper size display, and three LED's for paper type display. The print button 535 is used for printing the registration information of “Print 1”. The print button 536 is used for printing the registration information of “Print 2”. The print button 537 is used for printing the registration information of “Print 3”. The up-down button 538 is used for setting a number of sheets to be printed. The LCD display portion 254 displays a number of sheets to be printed in accordance with the up-down manipulation on the number-of-sheet setting button 538. Each of the four LED's for paper size display are provided for each size for sequentially setting and displaying one of multiple (four in the figure) different paper sizes (such as A4, Post Card, L and 2L) every time the paper size selection button 532 is pressed. Each of the three LED's for paper type display are provided for each size for sequentially setting and displaying one of multiple (three in the figure) different paper types (such as Plain Paper, Fine and Photo Paper) every time the paper type selection button 533 is pressed.

Four buttons including the index (list) print button 534, Print buttons 535, 536 and 537 for “Print 1”, “Print 2” and “Print 3” and excluding the paper size selection button 532 and the paper type selection button 533 from the paper size selection button 532, the paper type selection button 533, the index (list) print button 534, and the print buttons 535, 536 and 537 for “Print 1”, “Print 2” and “Print 3” have LED's, respectively, for displaying that the buttons are manipulated (pressed) therein.

The shaded part in FIG. 28 indicates a default setting state (that is, initial state on startup). In the default setting (lighting), the print registration is “Print 1”, the paper size is “A4” and the paper type is “Photo Paper”. The LCD display portion 54 for displaying a number of sheets to be printed displays “1” by default, but “2” is set by a user as the number of sheets to be printed in the display example in FIG. 28.

The digital camera 210 is connected to the printer 240. Then, when the print button 531 is pressed under the condition shown in FIG. 28, two copies of the layout image (such as two image layout with a frame in (h) in FIG. 27) registered as “Print 1” can be printed on photo paper in A4 size.

When the index (list) print button 534 is pressed under the condition shown in FIG. 28, the initially set (lighting) print button 535 to 537 of “Print 1” to “Print 3” can be switched to the index (list) print button 534. Then, the index (list) print button 534 is set (lighted-up), and the thumbnail index images are created, and the index printing is forcibly performed in response to the manipulation on the print button 531.

According to the image printing system of the third embodiment, the digital camera and the printer are operatively connected, and the selection of an image to be printed and the setting of the print layout can be performed in the digital camera side while the setting of the number of sheets to be printed is performed in the printer side. That is, the settings are divided between the digital camera side and the printer side. Thus, after images of various scenes were shot by a digital camera during travels or the like, the shot images to be printed and the print layout can be determined and be registered by manipulating the digital camera in a car on the return trip, for example. Then, at hone, the digital camera is connected to the printer, and the number of sheets to be printed for the registered print layout images is determined. Then, the print button is simply pressed. In this way, multiple shot images can be categorized and be organized (laid out) through the operations on the digital camera, and a highly useful printing system can be provided.

As described above, according to the third embodiment of the invention, an image printing system with better operability and excellent usability can be provided for performing a printing operation, a charging operation and so on when the digital camera and the image printer are connected.

In this embodiment, the recording medium 224 is removable, but the same effects can be obtained even when the recording medium 224 is built in the camera. Furthermore, the power source portion 238 may be a removable and chargeable battery or a chargeable battery built in the camera or may be connected to an external power source.

Next, (1) the construction of the image printing system, established by operatively coupling a digital camera and a printer as described above, (2) the construction of the digital camera and (3) construction of the printer compliant with the system will be functionally described.

(1) First of all, the construction of the image printing system, established by operatively connecting a digital camera and a printer as described above, will be described functionally.

(1-1) The image printing system in which a digital camera and printer including a control unit for controlling operations are operatively connected includes the digital camera including a selecting operation function portion for receiving, under the control of the control unit, operations including a layout selecting operation for selecting a desired print layout and an image selecting operation for selecting an image to be printed from images stored in an applied information recording carrier, and a print control data storing function portion for storing print control data corresponding to the operation received by the selecting operation function portion in the information recording carrier under the control of the control unit and the printer including a setting operation function portion for, under the control of the control unit, receiving operations including a number-of-sheets-to-be-printed setting operation for setting a desired number of sheets to be printed and a recognition function portion for recognizing the number of sheets to be printed set by the setting operation function portion and print control data created by the digital camera side and for printing an image based on the recognition under the control of the control unit.

In the system in which the digital camera and the printer are operatively connected, the setting operations are divided such that the selection of an image to be printed and the setting of a print layout can be performed in the camera side while the setting of the number of sheets to be printed can be performed in the printer side. The digital camera and the printer may be “operatively connected” in a radio or wired manner, by mutually transferring a recording medium or the like. The radio manner may be infrared ray communication or Bluetooth. The wired manner is communication through wires. The transfer of a medium refers to a case where a recording medium, such as a memory card, storing image data shot by the digital camera and laid out and control data is removed from the digital camera side and is inserted to the printer side so as to transfer the image data and control data to the printer.

The selecting operation function portion is a print setting indication and an input key or the like corresponding to the indication on a liquid crystal display portion 234 on the back of the digital camera. The term, “receiving” means that the control unit 219 recognizes a layout selecting operation and image selecting operation performed on the operating portion 237 by a user.

The information recording carrier refers to an internal memory (such as the ROM 217) and/or applied recording medium (such as a memory card).

The print control data is data corresponding operation information of a layout selecting operation and image selecting operation by a user and refers to data indicating the layout data to be used for actual printing, and the place and image data to be pasted in the layout.

The print control data storing function portion in the digital camera refers to a function portion for sending print control data to the internal memory and/or recording medium in the digital camera as data indicating control information under the control of the control unit (system controller 219). More specifically, the print control data storing function portion may be a circuit such as a drive controller 222, a driver (such as a card slot) and a wire (bus) also having other functions.

The setting operation function portion may be print sheet(s) setting indications and the input key indications corresponding to these indications in accordance with the input keys in the operating portion 253 in the printer and the type of the touch panel.

(2) Next, the construction of the above-described digital camera will be described functionally.

(2-1) The digital camera includes a selecting operation function portion for, under the control of the control unit, receiving operations including a layout selecting operation for selecting a desired print layout and an image selecting operation for selecting an image to be printed from images stored in an applied information recording carrier, and a print control data storing function portion for, under the control of the control unit, storing print control data corresponding to the operation received by the selecting operation function portion in a predetermined information recording carrier in a form identifiable in a printer side compliant with the digital camera.

(2-2) The selecting operation function portion may include a display portion for displaying the layout selecting operation and an operation key for performing a layout selecting operation corresponding to the display on the display portion.

This is the construction of the digital camera compliant with the above-described printer system.

(2-3) The print control data storing function portion may store the print control data in a memory portion as an information recording carrier built in the digital camera.

(2-4) Alternatively, the print control data storing function portion may store the print control data in a recording medium as an information recording carrier removably applied to the digital camera.

(2-5) Under the control of the control unit, the display portion may display an indication indicating a mode for performing the layout selecting operation and indications indicating other items within one display screen at the same time.

(2-6) Alternatively, when an operation for selecting the mode corresponding to the indication indicating the mode for performing the layout selecting operation on the selecting operation function portion, the display portion may, under the control of the control portion, then display a layout menu indication indicating a list of candidates of multiple kinds of print layout within the display screen.

(2-7) When an operation for selecting one print layout based on the layout menu indication is performed on the selecting operation function portion, the display portion may display, under the control of the control unit, an indication indicating the mode for operating an image selecting operation for selecting an image to be displayed in accordance with the print layout within the display screen.

(2-8) The display portion may display, under the control of the control unit, an indication pattern (such as “All Frames”) for indicating the selection of all images held by the digital camera and an indication pattern (such as “Select Image”) indicating the selection of a specific image from the all images as an indication indicating the mode for performing the image selecting operation within one display screen.

(2-9) Alternatively, the display portion may display, under the control of the control unit, an indication pattern for indicating the selection of all images held by the digital camera, an indication pattern [the right side of the screen in (c) in FIG. 26] indicating the selection of a specific image from the all images, and an indication pattern [the left side of the screen in (c) in FIG. 26] indicating one print layout selected based on the layout menu indication within one display screen at the same time.

(2-10) When an operation for selecting all of the images corresponding to an indication pattern indicating the selection of all images held by the digital camera is performed on the selecting operation function portion, the display portion may, under the control of the control portion, then display an indication indicating a state where all of the images are aligned sequentially at positions to be assigned on print sheets in accordance with one print layout selected based on the layout menu indication within the display screen.

More specifically, the indication refers to the indication (in (i) in FIG. 26) for the step following the selection of “All Frames” on the screen in (c) in FIG. 26).

(2-11) Alternatively, when an operation for selecting a specific image corresponding to an indication pattern indicating the selection of the specific image from all images held by the digital camera is performed on the selecting operation function portion, the display portion may display, under the control of the control unit, an indication indicating at which position of an image to be assigned on each print sheet in accordance with the print layout selected based on the layout menu indication one of the specific image is displayed within the display screen.

More specifically, the indication refers to the indication (in (d) in FIG. 26) for the step following the selection of “Select Image” on the screen in (c) in FIG. 26).

(2-12) When an operation for the mapping based on the indication indicating at which one of the positions in an arrangement of an image assigned in accordance with the selected print sheet one of the specific image is displayed is performed on the selecting operation function portion, the display portion then displays, under the control of the control unit, an image menu indication indicating a list of multiple images, which are candidate images to be arranged at one position in the display, is displayed within the display screen. [Note: Only one candidate image is applicable if the image can correspond to multiple sheets].

More specifically, the indication refers to the indication [in (e) in FIG. 26] for the step following the display of the arrangement in the print layout on the screen in (d) in FIG. 26).

(2-13) When the settings required for a layout selecting operation and image selecting operation in the selecting operation function portion completes, the control means may control the print control data storing function portion to store the completed settings in an information recording carrier and may control the display portion to display a guidance indication for typically representing the stored settings.

More specifically, the indication refers to the message, ‘Registered in “Print 1”’ as shown in (j) in FIG. 26.

(2-14) The display portion may display one indication, which is sequentially selected from prepared multiple kinds of the guidance indication every time the setting completes, within the display screen as the current indication under the control of the control unit.

More specifically, the indication refers to the indication, such as ‘Registered in “Print 1”’ in the beginning and ‘Registered in “Print 2”’ and ‘Registered in “Print 3”’ every time the storage setting ends, indicating the registration in one of multiple registering areas such as “Print 1”, “Print 2” and “Print 3”.

(2-15) The print control data storing function portion may store, under the control of the control unit, the already set information in a memory portion as a recording carrier built in the digital camera.

More specifically, this represents an aspect in which the registration information of “Print 1” shown in (j) in FIG. 26 is stored in the internal memory (such as the ROM 217 in the digital camera).

(2-16) Alternatively, the print control data storing function portion may store, under the control of the control unit, the already set information in a recording medium as an information recording carrier removably applied to the digital camera. More specifically, this represents an aspect in which the registration information of “Print 1” shown in (j) in FIG. 26 is stored in the recording medium 224 such as a memory card.

(3) Next, the construction of the above-described printer will be described functionally.

(3-1) The printer includes a setting operation function portion for receiving, under the control thereof, operations including a number-of-sheet-to-be-printed setting operation for setting a desired number of sheets to be printed, and a recognition function portion for recognizing print control data corresponding to the operation when operations including a layout selecting operation for selecting a desired print layout in a digital camera compliant therewith, and an image selecting operation for selecting an image to be printed from images stored in an applied information recording carrier are received by a selecting operation function portion of the digital camera and a number of sheets to be printed set from the setting operation function portion and for printing an image based on the recognition under the control of the control unit.

This represents the construction of the printer compliant with the image printer system described in the section (1-1).

An example of the setting operation function portion may be print setting indications (such as indications for a number of sheets to be printed, a paper size, a paper type and a layout form) and the input key indications corresponding to these indications in accordance with the input keys in the operating portion 253 and the type of the touch panel mounted on the display portion 254.

(3-2) The setting operation function portion may further receive operations including an operation for setting a print size under the control of the control unit.

(3-3) The setting operation function portion may further receive operations including an operation for setting Index Print under the control of the control unit.

The “Index Print” can be set through print setting indications (such as indications for a number of sheets to be printed, a paper size, a paper type and a layout form) and the input key indications corresponding to these indications in accordance with the input keys in the operating portion 253 and the type of the touch panel mounted on the display portion 254. The term, “Index Print” refers to the printing of a list of all images, which have been shot by the digital camera and been recorded, in a thumbnail (reduced image) form.

(3-4) The setting operation function portion may further receive operations including an operation for setting a type of print paper under the control of the control unit.

The “Paper Type” can be set through print setting indications and the input key indications corresponding to these indications in accordance with the input keys in the operating portion 253 and the type of the touch panel mounted on the display portion 254.

Next, (4) the construction of the printing system in which a digital camera and a printer are operatively connected as described above, (5) the construction of the digital camera compliant with the system and (6) the construction of the printer compliant with the system will be described functionally.

(4) First of all, the construction of the image printing system in which a digital camera and a printer are operatively connected as described above will be described functionally and more specifically.

(4-1) In an image printing system in which a digital camera and printer having respective control unit for controlling operations are operatively connected, the digital camera include a selecting operation function portion for receiving, under the control of the control unit, operations including a layout selecting operation for selecting desired print layout and an image selecting operation for selecting an image to be printed from images stored in an applied information recording carrier, and a print control data storing function portion for storing print control data corresponding to the operation received by the selecting operation function portion in the information recording carrier under the control of the control unit, the selecting operation function portion including a display portion for providing a display for the layout selection operation and an operation key to be used for a layout selecting operation corresponding to the display by the display portion. When the setting by a layout selecting operation and image selecting operation by the selecting operation function portion completes, the control unit controls to store the already set information in an information recording carrier by the print control data storing function portion, and the display portion displays, under the control of the control unit, one indication, which is sequentially selected from prepared multiple kinds of guidance indication every time a required setting completes, as an indication typically representing the current set information within the display screen. The printer includes a setting operation function portion for receiving, under the control of the control unit, operations including an operation for selecting one of multiple settings stored in an information recording carrier as print control data corresponding to a guidance indication typically representing a setting set in the digital camera side and a number-of-sheet-to-be-printed setting operation for setting a desired number of sheets to be printed and a recognition function portion for recognizing a number of sheets to be printed set by an operation by the setting operation function and one setting and for printing an image based on the recognition under the control of the control unit.

The system in which the setting operations are divided such that the selection of an image to be printed and the setting of a print layout can be performed in the camera side while the setting of the number of sheets to be printed can be performed in the printer side is the basic type of the system described in Section (1-1), the digital camera and the printer are operatively connected. The basic system is further specifically limited to the system in which multiple combinations of images to be printed and layouts are set in the digital camera side like Print 1, Print 2 and Print 3 (which are synonymous with Registration 1 Registration 2 and Registration 3) and the combination (that is, the registration pattern) to be used for printing and the number of sheets to be printed are selected in the printer side from the multiple settings.

The digital camera and the printer may be “operatively connected” in a radio or wired manner, by mutually transferring a recording medium or the like, as described above. The selecting operation function portion, print control data storing function portion and information recording carrier are applied as described above.

For example, the display portion may be a liquid crystal display portion on the back surface (and the display portion displays print layouts and other indications for setting). The operation key may be an input key corresponding to the indications.

For example, the description, “the display portion displays, one indication, which is sequentially selected from prepared multiple kinds of guidance indication every time a required setting completes, as an indication typically representing the current set information within the display screen” may refer to a case where one of “Print 1”, “Print 2”, “Print 3” and so on is displayed according to one embodiment.

For example, the setting operation function portion may be print setting indications (such as indications for a number of sheets to be printed, a paper size, a paper type and a layout form) and the input key indications corresponding to these indications in accordance with the input keys in the operating portion 253 and the type of the touch panel.

(5) Next, the construction of the above-described digital camera will be described functionally.

(5-1) The digital camera includes a selection operation function portion for receiving, under the control of the control unit, operations including a layout selection operation for selecting a desired print layout in order to print an image by a printer compliant therewith and an image selecting operation for selecting an image to be printed from images stored in an applied information recording carrier, and a print control data storing function portion for storing, under the control of the control unit, print control data corresponding to the operation, which is received by the selecting operation function portion, in an information recording carrier. The selecting operation function portion includes a display portion for providing a display for the print layout selecting operation and an operation key used for performing a layout selecting operation corresponding to the display on the display portion. When the setting required by the layout selecting operation and image selecting operation in the selecting operation function portion completes, the control unit controls the print control data storing function portion to store the already set information in an information recording carrier. The display portion displays, under the control of the control unit, one indication, which is sequentially and automatically selected every time the setting completes among prepared multiple kinds of guidance indication, on the display screen as an indication typically indicating the set information.

This is a digital camera compliant with the image printing system described in Section (4-1). The selecting operation function portion, information recording carrier and print control data storing function portion are applied as described above.

For example, the display portion may be a liquid crystal display portion on the back surface (and the display portion displays print layouts and other indications for setting). The operation key may be an input key corresponding to the indications.

The description, “the setting required by the layout selecting operation and image selecting operation” refers to a series of settings for determining a layout and an image to be displayed in the layout. More specifically, the setting refers to the series of settings as shown in (a) to (i) in FIG. 26.

(5-2) In response to the selection of one of the multiple kinds of guidance indication on the display portion by the selecting operation function portion under the control of the control unit, and based on setting data stored in an information recording carrier by the print control data storing function portion, the display portion can provide the preview of the image in a print layout corresponding to the selected guidance indication.

In this aspect, when, in the digital camera side, one print setting mode is selected on the menu screen and one of “Print 1”, “Print 2” and “Print 3” and so on is selected on the print setting mode screen, the preview of the respectively registered layout image can be displayed (in order to check before printing). In other words, the preview can be displayed in response to an operation in the digital camera side itself. When the print button 531 is pressed while the preview is being displayed, the registered layout image is started to print.

(5-3) Alternatively, in response to the receipt of a signal indicating the selection of one of the multiple kinds of guidance indication from a printer side, which can exchange signals with the digital camera, and based on setting data stored in an information recording carrier by the print control data storing function portion, the display portion may provide, under the control of the control unit, an applicable image in a print layout corresponding to the selected guidance indication.

In this aspect, the digital camera operatively connects to the printer, and the preview can be displayed in response to an operation in the printer side. This function is applicable to the type that the digital camera and the printer are docked.

The description, “a printer side, which can exchange signals with the digital camera” assumes that the digital camera and the printer are docked, for example. It also includes the case where the digital camera and the printer are connected through a wire (cable).

(6) Next, the construction of the above-described printer will be described functionally.

(6-1) The printer includes a setting operation function portion for receiving, under the control of the control unit, operations including an operation for selecting data relating to one setting of data, which is set in the digital camera compliant therewith as print control data indicating multiple kinds of setting data relating to combinations between print layouts and corresponding images to be printed and be stored in an information recording carrier, and an operation for setting a desired number of sheets to be printed, and a recognition function portion for recognizing the setting selected by an operation by the setting operation function portion and the set number of sheets to be printed and for printing an image based on the recognition under the control of the control unit thereof.

This is a printer compliant with the printing system described in Section (4-1).

The description, “operations including an operation for selecting data relating to one setting of data, which is set in the digital camera . . . and is stored in an information recording carrier” refers to a manipulation of one button of buttons “print 1”, “Print 2” and “Print 3” provided in the printer side. Here, any method can be adopted for supplying data set and stored in the digital camera side to the printer side. Therefore, data may be transferred offline by changing the removable recording medium. Alternatively, the camera and the printer may be docked at an electric contact so as to transfer data online.

The setting operation function portion may be print setting indications (such as indications for a number of sheets to be printed, a paper size, a paper type and a layout form) and the input key indications corresponding to these indications in accordance with the input keys in the operating portion 253 and the type of the touch panel.

(6-2) One indication, which is sequentially selected from multiple kinds of guidance indication prepared in the digital camera side every time required setting completes, can be identified on the display within a display screen of the digital camera as an indication typically indicating the currently set information, and the print control data may include data relating to the association between the indication and the set information typically indicated by the indication. The setting operation function portion may further include a print form selecting function portion having operating portion, which is provided by corresponding to the multiple kinds of guidance indication, for selecting one of the combinations of the print layouts and corresponding images to be printed based on an operation thereon. When the print control data is supplied, the recognition function portion may recognize the combination of a print layout corresponding to an operated one of the operating portions of the print form selecting function portion and a corresponding images to be printed and the set number of sheets to be printed and prints the image based on the recognition under the control of the control unit thereof.

This aspect is applicable to the printer having buttons for selecting a layout and image in accordance with “Print 1”, “Print 2” and “Print 3”.

In this aspect, any method can be adopted for supplying data set and stored in the digital camera side to the printer side. Therefore, data may be transferred offline by changing the removable recording medium. Alternatively, the camera and the printer may be docked at an electric contact so as to transfer data online.

(6-3) In the print form selecting function portion, a specific one of the operating portions of the print form selecting function portion may be selected by default.

The example of this aspect is applicable to the printer in which “Print 1” is selected by default from “Print 1”, “Print 2” and “Print 3”, for example. Here, the term, “default” refers to an initial setting in software and/or hardware and especially refers to an initial setting in an item, which can be set by a user.

(6-4) In the print form selecting function portion, the specific one of the operating portions of the print form selecting function portion may be in a predetermined active state by default, and the other operating portions are in a predetermined inactive state.

The example of this aspect is applicable to a printer in which, by default, “Print 1” is selected and the light is on. The predetermined active state refers to a state where the light is on or blinks while the predetermined inactive state refers to a state where the light is off or on.

(6-5) Under the control of the control unit of the printer side, the print form selecting function portion may create a signal indicating the selection of one of the multiple kinds of guidance indication and supply the signal to the digital camera side. In response to the receipt of the supply of the signal, the digital camera side can provide, under the control of the control unit thereof, the preview of an applicable image in a print layout corresponding to the selected guidance indication based on setting data stored in an information recording carrier by the print control data storing function portion.

In this aspect, the digital camera side is caused to provide the preview display in response to an operation performed on a guidance indication such as “Print 1”, “Print 2” and “Print 3” of the printer side itself. This function assumes the case where the digital camera and the printer are docked.

As described above, according to the third embodiment of the invention, an image printing system can be provided in which a digital camera and a printer are operatively connected, and in which the division of the responsibility for processing relating to operation functions of steps for selecting an image to be printed for selecting a print layout and so on is optimized between the digital camera side and the printer side.

What is claimed is:

1. An image printing system, comprising an electronic camera applying a secondary battery as a power source and an image printer, which can be operatively connected to the electronic camera,
wherein the electronic camera includes a camera controller for entirely controlling functions of the digital camera, first connecting means removably connectable to the image printer without using a connection cable, decompressing means for decompressing image data recorded in an applied recording medium to an image data for printing compliant with the image data, and data transfer means for transferring an output of the decompressing means to the outside through the first connecting means,
wherein the image printer includes a printer controller for entirely controlling functions of the image printer, second connecting means suitable for data exchanges by connecting to the first connecting means in the digital camera side, power supply means for feeding power to the digital camera and for charging the secondary battery, and a print start switch for generating an instruction signal for instructing the start of a printing operation,
wherein the print start switch is turned on in the image printer side when the first connecting means and the second connecting means are connected to each other so that the camera controller and the printer controller in connection with each other can transfer the image data for printing from the data transfer means in the digital camera side to the image printer side through the first connecting means and the second connecting means, cause the image printer side to perform the printing operation on the transferred image data, and cause the power supply means in the image printer side to start a charging operation for charging the secondary battery in the digital camera side after the completion of the printing operation.

2. An image printing system according to claim 1,
wherein the digital camera further includes a power source operating member for switching the open and closed states of the power source,
wherein the camera controller controls to start the image printing operation and the charging operation independently from the state switched by the power source operating member.

3. An image printing system according to claim 1,
wherein the image printer further includes timer means for measuring a predetermined time period,
wherein the printer controller controls the timer means to start a time-measuring operation when the first connecting means and the second connecting means are connected to each other and starts the charging operation in a state that an instruction signal is not input from the print start switch and when a lapse time represented by the time-measuring operation by the timer means excesses a predetermined set time.

4. An image printing system according to claim 1,
wherein the digital camera further includes display means,
wherein, when the first connecting means and the second connecting means are connected to each other, the camera controller controls the display means to display an image being outputted while the image printer is performing a printing operation and controls the display means to stop a display operation while a charging operation is being performed.

5. An image printing system according to claim 1,
wherein the camera controller and the printer controller in connection with each other control the image printer to shut off the power supply when an image printing operation is completed and the charging operation has been completed in the digital camera.

6. An image printing system, comprising an electronic camera and an image printer, which can be operatively connected to the electronic camera,
wherein the image printer includes a printer controller for entirely controlling functions of the image printer, second connecting means for operatively connecting to the electronic camera, and a printing mechanism for printing an image based on the data transferred from the electronic camera operatively connected thereto through the second connecting means,
wherein the electronic camera includes a camera controller for entirely controlling functions of the electronic camera, an image memory provided for storing compressed shot image data and printing history information relating to a fact that image printing processing was performed in the past as attribute information of the image data, first connecting means for establishing the operative connection between the image printer and the electronic camera by operatively connecting to the second connecting means of the image printer, transfer means for transferring image data recorded in the image memory to the image printer through the first connecting means and update means for updating the printing history information,
wherein, when the first connecting means and the second connecting means are operatively connected, and when a printing operation is started in the image printer, the camera controller and the printer controller in connection with each other cause to sequentially print image data having been not printed until the start and to update the corresponding printing history information when the printing of the image data completes.

7. An image printing system according to claim 6,
wherein the electronic camera includes image display means for displaying an image based on image data recorded in the image memory under the control of the camera controller and a predetermined symbol related to the image under the control of the camera controller and the camera controller and the printer controller in connection with each other control the image display means to display a guide message for prompting an operation for starting printing and conditions set for the printing.

8. An image printing system according to claim 6,
wherein the electronic camera has image display means for displaying an image based on the image data recorded in the image memory and a predetermined symbol representing predetermined information relating to the image under the control of the camera controller, and image data corresponding to the image supplied to and displayed by the image display means includes information corresponding to the printing history information.

9. An image printing system according to claim 8,
wherein information indicating whether the image data as information corresponding to the print history information was printed in the past or not is supplied to the image display means under the control of the camera controller, and the image display means provides a display indicating whether the supplied information was printed in the past or not.

10. An image printing system according to claim 8,
wherein information represented by a numeral or symbol indicating at least one of the number of times of printing the image data in the past and whether the printing is instructed again or not as information corresponding to the printing history information is supplied to the image display means, and the image display means displays a numeral or symbol representing at least one of the number of times of printing the image data in the past and whether the printing is instructed again or not based on the supplied information.

11. An image printing system according to claim 8,
wherein the camera controller handles the printing history information as information to be included in a header part in a data file of the image data.

12. An image printing system according to claim 8,
wherein the camera controller functions for recording respective printing history information relating to all image data recorded in the image memory as a single file.

13. An image printing system according to claim 6,
wherein the electronic camera further includes manual operating means for rewriting the printing history information to instruct reprinting, and the image data instructed to re-print by the manual operating means is printed in the same manner as the other image data not printed before the instruction under the control of the camera controller.

14. An image printing system according to claim 8, wherein the printing history information includes instruction information for re-printing.

15. An image printing system in which a digital camera and printer including control means for controlling operations are operatively connected, the image printing system comprising:
the digital camera including a selecting operation function portion for receiving, under the control of the control means, operations including a layout selecting operation for selecting a desired print layout and an image selecting operation for selecting an image to be printed from images stored in an applied information recording carrier, and a print control data storing function portion for storing print control data corresponding to the operation received by the selecting operation function portion in the information recording carrier under the control of the control means; and
the printer including a setting operation function portion for, under the control of the control means, receiving operations including a number-of-sheets-to-be-printed setting operation for setting a desired number of sheets to be printed and a recognition function portion for recognizing the number of sheets to be printed set by the setting operation function portion and print control data created by the digital camera side and for printing an image based on the recognition under the control of the control means.

16. A digital camera, comprising:
a selecting operation function portion for, under the control of control means, receiving operations including a layout selecting operation for selecting a desired print layout and an image selecting operation for selecting an image to be printed from images stored in an applied information recording carrier; and
a print control data storing function portion for, under the control of the control means, storing print control data corresponding to the operation received by the selecting operation function portion in a predetermined information recording carrier in a form identifiable in a printer side compliant with the digital camera.

17. A digital camera according to claim 16,
wherein the selecting operation function portion includes a display portion for displaying the layout selecting operation and an operation key for performing a layout selecting operation corresponding to the display on the display portion.

18. A digital camera according to claim 16,
wherein the print control data storing function portion stores the print control data in a memory portion as an information recording carrier built in the digital camera.

19. A digital camera according to claim 16,
wherein the print control data storing function portion stores the print control data in a recording medium as an information recording carrier removably applied to the digital camera.

20. A digital camera according to claim 17,
wherein, under the control of the control means, the display portion displays an indication indicating a mode for performing the layout selecting operation and indications indicating other items within one display screen at the same time.

21. A digital camera according to claim 17,
wherein, when an operation for selecting the mode corresponding to the indication indicating the mode for performing the layout selecting operation on the selecting operation function portion, the display portion then, under the control of the control portion, displays a layout menu indication indicating a list of candidates of multiple kinds of print layout within the display screen.

22. A digital camera according to claim 21,
wherein, when an operation for selecting one print layout based on the layout menu indication is performed on the selecting operation function portion, the display portion displays, under the control of the control means, an indication indicating the mode for operating an image selecting operation for selecting an image to be displayed in accordance with the print layout within the display screen.

23. A digital camera according to claim 22,
wherein the display portion displays, under the control of the control means, an indication pattern for indicating the selection of all images held by the digital camera and an indication pattern indicating the selection of a specific image from the all images as an indication indicating the mode for performing the image selecting operation within one display screen.

24. A digital camera according to claim 22,
wherein the display portion displays, under the control of the control means, an indication pattern for indicating the selection of all images held by the digital camera, an indication pattern indicating the selection of a specific image from the all images, and an indication pattern indicating one print layout selected based on the layout menu indication within one display screen at the same time.

25. A digital camera according to claim 23,
wherein, when an operation for selecting all of the images corresponding to an indication pattern indicating the selection of all images held by the digital camera is performed on the selecting operation function portion, the display portion then, under the control of the control portion, displays an indication indicating a state where all of the images are aligned sequentially at positions to be assigned on print sheets in accordance with one print layout selected based on the layout menu indication within the display screen.

26. A digital camera according to claim 23,
wherein, when an operation for selecting a specific image corresponding to an indication pattern indicating the selection of the specific image from all images held by the digital camera is performed on the selecting operation function portion, the display portion displays, under the control of the control means, an indication indicating at which position of an image to be assigned on each print sheet in accordance with the print layout selected based on the layout menu indication one of the specific image is displayed within the display screen.

27. A digital camera according to claim 26,
wherein, when an operation for the mapping based on the indication indicating at which one of the positions in an arrangement of an image assigned in accordance with the selected print sheet one of the specific image is displayed is performed on the selecting operation function portion, the display portion then, under the control of the control means, displays an image menu indication indicating a list of multiple images, which are candidate images to be arranged at one position in the display, is displayed within the display screen.

28. A digital camera according to claim 17,
wherein, when the settings required for a layout selecting operation and image selecting operation in the selecting operation function portion completes, the control means controls the print control data storing function portion to store the completed settings in an information recording carrier and controls the display portion to display a guidance indication for typically representing the stored settings.

29. A digital camera according to claim 28,
wherein the display portion displays one indication, which is sequentially selected from prepared multiple kinds of the guidance indication every time the setting completes, within the display screen as the current indication under the control of the control means.

30. A digital camera according to claim 28, wherein the print control data storing function portion stores, under the control of the control means, the already set information in a memory portion as a recording carrier built in the digital camera.

31. A digital camera according to claim 28,
wherein the print control data storing function portion stores, under the control of the control means, the already set information in a recording medium as an information recording carrier removably applied to the digital camera.

32. A printer, comprising:
a setting operation function portion for receiving, under the control thereof, operations including a number-of-sheet-to-be-printed setting operation for setting a desired number of sheets to be printed; and
a recognition function portion for recognizing print control data corresponding to the operation when operations including a layout selecting operation for selecting a desired print layout in a digital camera compliant therewith, and an image selecting operation for selecting an image to be printed from images stored in an applied information recording carrier are received by a selecting operation function portion of the digital camera and a number of sheets to be printed set from the setting operation function portion and for printing an image based on the recognition under the control of the control means.

33. A printer according to claim 32,
wherein the setting operation function portion further receives operations including an operation for setting a print size under the control of the control means.

34. A printer according to claim 32,
wherein the setting operation function portion further receives operations including an operation for setting Index Print under the control of the control means.

35. A printer according to claim 32,
wherein the setting operation function portion further receives operations including an operation for setting a type of print paper under the control of the control means.

36. An image printing system in which a digital camera and printer having respective control means for controlling operations are operatively connected, the system comprising:
the digital camera including a selecting operation function portion for receiving, under the control of the control means, operations including a layout selecting operation for selecting desired print layout and an image selecting operation for selecting an image to be printed from images stored in an applied information recording carrier, and a print control data storing function portion for storing print control data corresponding to the operation received by the selecting operation function portion in the information recording carrier under the control of the control means, the selecting operation function portion including a display portion for providing a display for the layout selection operation and an operation key to be used for a layout selecting operation corresponding to the display by the display portion,
wherein, when the setting by a layout selecting operation and image selecting operation by the selecting operation function portion completes, the control means controls to store the already set information in an information recording carrier by the print control data storing function portion, and the display portion displays, under the control of the control means, one indication, which is sequentially selected from prepared multiple kinds of guidance indication every time a required setting completes, as an indication typically representing the current set information within the display screen; and
the printer including a setting operation function portion for receiving, under the control of the control means, operations including an operation for selecting one of multiple settings stored in an information recording carrier as print control data corresponding to a guidance indication typically representing a setting set in the digital camera side and a number-of-sheet-to-be-printed setting operation for setting a desired number of sheets to be printed and a recognition function portion for recognizing a number of sheets to be printed set by an operation by the setting operation function portion and the one setting and for printing an image based on the recognition under the control of the control means.

37. A digital camera, comprising:
a selection operation function portion for receiving, under the control of the control means, operations including a layout selection operation for selecting a desired print layout in order to print an image by a printer compliant therewith and an image selecting operation for selecting an image to be printed from images stored in an applied information recording carrier; and
a print control data storing function portion for storing, under the control of the control means, print control data corresponding to the operation, which is received by the selecting operation function portion, in an information recording carrier,
wherein the selecting operation function portion includes a display portion for providing a display for the print layout selecting operation and an operation key used for performing a layout selecting operation corresponding to the display on the display portion, wherein, when the setting required by the layout selecting operation and image selecting operation in the selecting operation function portion completes, the control means controls the print control data storing function portion to store the already set information in an information recording carrier, wherein the display portion displays, under the control of the control means, one indication, which is sequentially and automatically selected every time the setting completes among prepared multiple kinds of guidance indication, on the display screen as an indication typically indicating the current set information.

38. A digital camera according to claim 37,
wherein, in response to the selection of one of the multiple kinds of guidance indication on the display portion by the selecting operation function portion under the control of the control means, and based on setting data stored in an information recording carrier by the print control data storing function portion, the display portion can provide the preview of the image in a print layout corresponding to the selected guidance indication.

39. A digital camera according to claim 37,
wherein, in response to the receipt of a signal indicating the selection of one of the multiple kinds of guidance indication from a printer side, which can exchange signals with the digital camera, and based on setting data stored in an information recording carrier by the print control data storing function portion, the display portion can provide, under the control of the control means, the preview of the image in a print layout corresponding to the selected guidance indication.

40. A printer, comprising:
a setting operation function portion for receiving, under the control of the control means, operations including an operation for selecting data relating to one setting of data, which is set in the digital camera compliant therewith as print control data indicating multiple kinds of setting data relating to combinations between print layouts and corresponding images to be printed and be stored in an information recording carrier, and an operation for setting a desired number of sheets to be printed; and
a recognition function portion for recognizing the setting selected by an operation by the setting operation function portion and the set number of sheets to be printed and for printing an image based on the recognition under the control of the control means thereof.

41. A printer according to claim 40,
wherein one indication, which is sequentially selected from multiple kinds of guidance indication prepared in the digital camera side every time required setting completes, can be identified on the display within a display screen of the digital camera as an indication typically indicating the currently set information, and the print control data includes data relating to the association between the indication and the set information typically indicated by the indication,
wherein the setting operation function portion further includes a print form selecting function portion having operating portion, which is provided by corresponding to the multiple kinds of guidance indication, for selecting one of combinations of the print layouts and corresponding images to be printed based on an operation thereon; and
wherein, when the print control data is supplied, the recognition function portion recognizes the combination of a print layout corresponding to an operated one of the operating portions of the print form selecting function portion and a corresponding image to be printed and the set number of sheets to be printed and prints the image based on the recognition under the control of the control means thereof.

42. A printer according to claim 41,
wherein a specific one of the operating portions of the print form selecting function portion is selected by default.

43. A printer according to claim 42,
wherein the specific one of the operating portions of the print form selecting function portion is in a predetermined active state by default, and the other operating portions are in a predetermined inactive state.

44. A printer according to claim 41,
wherein, under the control of the control means of the printer side, the print form selecting function portion creates a signal indicating the selection of one of the multiple kinds of guidance indication and supplies the signal to the digital camera side, wherein, in response to the receipt of the supply of the signal, the digital camera side can provide, under the control of the control means thereof, the preview of an applicable image in a print layout corresponding to the selected guidance indication based on setting data stored in an information recording carrier by the print control data storing function portion.
